(19) United States
(12) Patent Application Publication
(10) Pub. No.: US 2025/0319908 A1
(43) Pub. Date: Oct. 16, 2025

(54) GRID FRAMEWORK STRUCTURE

(71) Applicant: Ocado Innovation Limited, Hatfield (GB)

(72) Inventors: Ian PARKS, St Albans (GB); Nicholas MCLARNEY, Glasgow (GB)

(21) Appl. No.: 19/203,164

(22) Filed: May 8, 2025

Related U.S. Application Data
(63) Continuation of application No. PCT/EP2023/081533, filed on Nov. 10, 2023.

(30) Foreign Application Priority Data
Nov. 11, 2022 (GB) 2216903.1
Jan. 13, 2023 (GB) 2300562.2

(51) Int. Cl. B61B 5/00; B65G 1/04

(52) U.S. Cl. CPC B61B 5/00; B65G 1/0464

(57) ABSTRACT

A grid framework structure for supporting one or more robotic load handling devices operative on the grid framework structure, the grid framework structure comprising: a supporting framework structure comprising a plurality of prefabricated frames comprising a plurality of modular storage cells, each of the plurality of prefabricated frames lying in a vertical plane and comprising a plurality of vertical members braced by a bracing member; a track system comprising a plurality of tracks arranged in a grid pattern comprising a plurality of grid cells extending across a plurality of modular storage cells; wherein the track system further comprises a track support structure comprising a plurality of track supports arranged in a grid pattern corresponding to the grid pattern of the track system, the track support structure sub-divided into a plurality of modular sub-frames.

### CROSS-REFERENCE TO RELATED APPLICATIONS

This Application is a continuation of PCT International Patent Application No. PCT/EP2023/081533, filed on Nov. 10, 2023, which claims priority to UK Patent Application No. GB2216903.1, filed Nov. 11, 2022, and UK Patent Application No. GB2300562.2, filed on Jan. 13, 2023, the entire contents of each of which are hereby incorporated by reference.

### TECHNICAL FIELD

The present invention relates to the field of remotely operated load handling devices on tracks located on a grid framework structure for handling storage containers or bins stacked in the grid framework structure, more specifically to a grid framework structure for supporting remotely operated load handling devices.

### BACKGROUND

Storage and retrieval systems 1 comprising a three-dimensional storage grid framework structure, within which storage containers/bins/totes are stacked on top of each other, are well known. PCT Publication No. WO2015/185628A (Ocado) describes a known storage and fulfilment or distribution system in which stacks of bins or containers are arranged within a grid framework structure. The bins or containers are accessed by load handling devices remotely operative on tracks located on the top of the grid framework structure. A system of this type is illustrated schematically in FIGS. 1 to 3 of the accompanying drawings.

As shown in FIGS. 1 and 2, stackable containers, known as storage bins or containers 10, are stacked on top of one another to form stacks 12. The stacks 12 are arranged in a grid framework structure 14 in a warehousing or manufacturing environment. The grid framework structure is made up of a plurality of storage columns or grid columns. FIG. 1 is a schematic perspective view of the grid framework structure 14, and FIG. 2 is a top-down view showing a stack 12 of bins 10 arranged within the grid framework structure 14. Each bin 10 typically holds a plurality of product items (not shown), and the product items within a bin 10 may be identical, or may be of different product types depending on the application.

In detail, the grid framework structure 14 comprises a plurality of vertical uprights or upright members or upright columns 16 that support horizontal grid members 18, 20. A first set of parallel horizontal grid members 18 is arranged perpendicularly to a second set of parallel horizontal grid members 20 to form a track system or grid structure or grid 15 comprising a plurality of grid cells 17. Each grid cell in the grid framework structure has at least one grid column for storage of a stack of containers. For the avoidance of doubt, the term “grid framework structure” is used to mean a three-dimensional structure within which the storage containers are stored, and the terms “track system”, “grid structure” and “grid” are used interchangeably to mean the two-dimensional structure in a substantially horizontal plane upon which the load handling devices operate. The grid cell has an opening to allow a load handling device to lift a container or storage bin through the grid cell. In the track system, the first set of parallel horizontal grid members 18 intersect the second set of parallel horizontal grid members at nodes. The track system is supported by the upright members 16 at each of the nodes or at the point where the grid members intersect such that the upright members are interconnected at their tops ends by the intersecting grid members. The grid members 16, 18, 20 are typically manufactured from metal and typically welded or bolted together or a combination of both. The storage bins or containers 10 are stacked between the upright members 16 of the grid framework structure 14, so that the upright members 16 guard against horizontal movement of the stacks 12 of bins 10, and guide vertical movement of the storage bins 10.

The top level of the grid framework structure 14 includes rails or tracks 22 arranged in a grid pattern across the top of the stacks 12 to define a track system. Referring additionally to FIG. 3, the rails 22 support a plurality of load handling devices 30. The track system comprises a first set 22a of parallel rails 22 to guide movement of the robotic load handling devices 30 in a first direction (for example, an X-direction) across the top of the grid framework structure 14, and a second set 22b of parallel rails 22, arranged perpendicular to the first set 22a, to guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12. For the purpose of definition of the present invention, the term “robotic” load handling device and load handling device are used interchangeably in the description to mean the same device.

The track or rail can be a separate component to the grid member (sometime referred to as a ‘track support’) or alternatively, the track is integrated into the grid member as a single body, i.e. forms part of the grid member. For example, each of the first and second sets of horizontal grid members 18, 20 of the track system can function as a track support structure and the first and second sets of tracks of the track system can be mounted to the track support structure for guiding the load handling devices in two dimensions on the track system.

A known load handling device otherwise known as a bot 30 shown in FIGS. 4 and 5 comprising a vehicle body 32 is described in PCT Patent Publication No. WO2015/019055 (Ocado), hereby incorporated by reference, where each load handling device 30 only covers a single grid space or grid cell of the grid framework structure 14. Here, the load handling device 30 comprises a wheel assembly comprising a first set of wheels 34 consisting of a pair of wheels on the front of the vehicle body 32 and a pair of wheels 34 on the back of the vehicle body 32 for engaging with the first set of rails or tracks to guide movement of the device in a first direction, and a second set of wheels 36 consisting of a pair of wheels 36 on each side of the vehicle body 32 for engaging with the second set of rails or tracks to guide movement of the device in a second direction. Each of the sets of wheels are driven to enable movement of the vehicle in X and Y directions respectively along the rails. One or both sets of wheels can be moved vertically to lift each set of wheels clear of the respective rails, thereby allowing the vehicle to move in the desired direction, e.g. X or Y direction on the track system.

The load handling device 30 is equipped with a lifting device or crane mechanism to lift a storage container from above. The crane mechanism comprises a winch tether or cable 38 wound on a spool or reel (not shown) and a grabber device 39 in the form of a lifting frame. The lifting device comprises a set of lifting tethers 38 extending in a vertical direction and connected nearby or at the four corners of the grabber device 39, otherwise known as the grabber device (one tether near each of the four corners of the grabber device) for releasable connection to a storage container 10. The grabber device 39 is configured to releasably grip the top of a storage container 10 to lift it from a stack of containers in a storage system of the type shown in FIGS. 1 and 2.

The wheels 34, 36 are arranged around the periphery of a cavity or recess, known as a container-receiving recess or container receiving space 40, in the lower part. The recess is sized to accommodate the container 10 when it is lifted by the crane mechanism, as shown in FIGS. 5A-5B. When in the recess, the container is lifted clear of the rails beneath, so that the vehicle can move laterally to a different location. On reaching the target location, for example another stack, an access point in the storage system or a conveyor belt, the bin or container can be lowered from the container receiving portion and released from the grabber device. The container receiving space 40 may comprise a cavity or recess arranged within the vehicle body, e.g. as described in WO 2015/019055 (Ocado Innovation Limited). Alternatively, the vehicle body of the load handling device may comprise a cantilever as taught in WO2019/238702 (Autostore Technology AS) in which case the container receiving space 40 is located below a cantilever of the load handing device. In this case, the grabber device is hoisted by a cantilever such that the grabber device is able to engage and lift a container from a stack into a container receiving space 40 below the cantilever.

To ensure stability of the grid framework structure, prior art storage systems are largely dependent on various supports and bracing arranged within or at least partly along the periphery of the grid framework structure. However, the use of various supports and bracing (anti-movement braces) to stabilize the grid framework structure from internal and external forces is disadvantageous for a number of reasons. The grid framework structure occupies space or area which could be utilized to store containers, in that it prevents optimum usage of available space or area for the storage of containers. The need of a supporting structure may limit the available options for positioning of the grid framework structure since any auxiliary grid supporting structure often requires connection to a surrounding structure such as the inner walls of a building. The requirement of a supporting structure to stabilize the grid framework structure is generally not cost efficient and occupies useful storage space.

WO2019/101367 (Autostore Technology AS) teaches a free-standing storage grid requiring a less extensive auxiliary grid supporting structure by integrating a grid supporting structure in the storage grid structure. The grid supporting structure is made up of four storage columns interconnected by multiple vertically inclined support struts. The storage column profiles have a cross-section comprising a hollow center section and four corner sections, each corner section comprising two perpendicular bin guiding plates for accommodating a corner of a storage bin. The support struts have a width which allows them to fit in between two parallel guiding plates so as to not compromise the ability of the storage columns to accommodate a stack of containers or storage bins.

To erect the grid framework structure in the art, a plurality of vertical uprights are individually positioned one piece at a time in a grid-like pattern on the ground. The assembling of individual vertical uprights together one piece at a time is sometimes referred to as “stick-built” structures. The “stick-built” approach of the assembling the grid framework structure requires numerous time-consuming adjustments to be made for reliable operation of the robotic load handling devices on the tracks. The height of the vertical uprights and thus the level of the grid mounted thereon is adjusted by one or more adjustable feet at the base or bottom end of each of the vertical uprights. A sub-group of the vertical uprights are braced together to provide structural stability to the grid framework structure. The vertical uprights are interconnected at their top ends by grid members so that the grid members adopt the same grid pattern as the vertical uprights, i.e. the vertical uprights support the grid members at the point or node where each of the grid members intersect in the grid pattern. For the purpose of explanation of the present invention, the points or junctions where the grid members intersect or are interconnected constitute the nodes of the track system and correspond to the area where the track system is supported by a vertical upright. The resultant grid framework structure can be considered as a free standing rectilinear assemblage of upright columns supporting the grid formed from intersecting horizontal grid members, i.e. a four wall shaped framework.

The arrangement of the vertical uprights provides multiple vertical storage columns for the storage of one or more containers in a stack. The vertical uprights help to guide the grabber device of the lifting mechanism as the grabber device engages with a container within the grid framework structure and is lifted towards the load handling device operative on the grid. The size of the grid framework structure and thus the ability to store containers containing different items or stock keeping units (SKUs) is largely dependent on the number of vertical uprights spanning over a given footprint of the grid framework structure. However, one of the biggest bottlenecks in the building of a fulfilment or distribution center is the erection of the grid framework structure. The time and cost to assemble the grid framework structure represents a huge proportion of the time and cost to build a fulfilment or distribution center. The biggest and the most time consuming operation involves erecting the vertical uprights individually and fixing the track system to the vertical uprights.

WO2019/157197 (Alert Innovation Inc.) attempts to address this problem by providing an automated fulfilment system comprising a plurality of storage modules, wherein each storage module of the plurality of storage modules comprises a pair of shelf modules comprising a number of defined storage locations for storing containers otherwise known as totes. The pair of shelf modules are spaced apart from each other so as to allow a mobile robot to pass between the pair of shelf modules and retrieve or deliver inventory to storage locations. However, the automated storage system taught in WO2019/157197 (Alert Innovation Inc.) does not provide a dense storage system as taught in WO2015/185628A (Ocado) since the shelf modules take up valuable storage space.

WO2020/074242 (Autostore Tech) teaches a plurality of mobile containers, each container having an automated storage and retrieval system comprising a grid framework structure for storing storage bins (wherein the bins may contain items). One of the mobile containers may be a so-called master container having storage columns and dedicated columns for receiving storage bins from an access station and delivering storage bins to an access station. The remaining mobile containers may be so-called supply containers comprising an automated storage and retrieval system without dedicated columns for receiving storage bins from the access station and delivering storage bins to the access station. Within the system, the master container may be connected to at least one supply container such that a bin handling vehicle can move from the storage grid structure of the master container to a storage grid structure of the supply container. The master container and/or supply container may be connected to a plurality of supply containers, which again can be connected to a plurality of supply containers and so on. A pivotable intermediate element is used to connect the respective rail system of automated storage and retrieval systems of adjacent mobile containers.

A grid framework structure is thus required that allows the grid framework structure to be erected quicker and/or cheaper than current grid framework structures in the art. Moreover, the grid framework structure should also maximize the available space or area for the storage of multiple containers.

### SUMMARY

The present applicant has mitigated the above problem by forming the grid framework structure from fewer structural components than is currently practiced as described above, yet still maintaining the same structural integrity as the existing grid framework structure for bearing the weight of one or more robotic load handling devices (which can weigh as much as 150 kg) operative on the grid framework structure. The present invention provides a grid framework structure assembled from a plurality of modular storage units, each of the plurality of modular storage units providing storage for a plurality of stacks of storage containers. Whilst WO2020/074242 (Autostore Tech) provides a mobile storage system that enables multiple automated storage and retrieval systems in mobile containers to be connected together in a side-by-side relationship to increase the storage capacity of the mobile storage system, no provisions are made to take into account the effects of thermal expansion of the grid framework structure in one or more of the mobile storage units when assembled together resulting in movement and/or distortion of the rail system. Increasing the storage capacity of the automated storage and retrieval system by extending the grid framework structure through assembling multiple modular storage units together runs the risk that thermal expansion of the grid framework structure within one of the mobile storage units may generate sufficient forces to have a knock-on effect on the grid framework structure of an adjacent modular storage unit. For example, forces generated as a result of thermal expansion within a grid framework structure of a mobile storage unit may be transferred to adjacent mobile storage units. The cumulative effect of such forces across multiple modular storage units may cause different areas of the grid framework structure to buckle or at least distort. At a granular level, thermal expansion of one or more tracks may also cause one or more vertical members interconnected by the tracks at their upper ends to distort. As the vertical uprights are arranged to provide storage columns in the grid framework structure, distortion in one or more of the vertical uprights may cause the grabber device and/or storage container to foul the vertical uprights as it is guided vertically by the vertical uprights. The term vertical member and vertical upright are used interchangeably in the description to mean the same feature.

Whilst WO2020/074242 (Autostore Tech) attempts to provide a grid framework structure that can be easily transported and erected in a remote location, the grid framework structure in each of the mobile containers still suffers from the problem of the need to assemble the grid framework by the “stick-built” approach discussed above and therefore, suffers from the problems associated with long build time and material costs.

In contrast to the “stick-built” approach of the assembling the grid framework structure requiring numerous time-consuming adjustments to be made to the level of the rail or track system for reliable operation of the robotic load handling devices on the tracks, the grid framework structure according to the present invention is erected from a plurality of prefabricated panels or frames, wherein each of the plurality of the prefabricated panels or frames is assembled from a sub-group of the vertical members braced together by one or more bracing members. For the purpose of definition, the term “prefabricated” in the context of the grid framework structure build is construed to cover pre-assembling or manufacturing sections of the grid framework structure prior to assembly of the grid framework structure on site so that the grid framework structure can be assembled at a different location to the manufacture of the prefabricated sections of the grid framework structure, wherein each of the prefabricated sections comprises a plurality of the parts or components of the grid framework structure. The different location can be a location remote from where the grid framework structure is assembled, i.e. in another building, or alternatively, assembled in the same location but in a different area of the same location, e.g. into a different area of the same building. In the context of the term “panels”, the prefabricated panels are formed from bracing together a sub-group of the vertical members in a single plane, e.g. in a single vertical plane. Preferably, the bracing member is a horizontal bracing member.

The prefabricated panels or frames are assembled together in a three-dimensional grid pattern to form a plurality of modular storage cells, where each of the modular storage cells is sized to store a plurality of stacks of storage containers, i.e. each of the modular storage cells adopts an open storage space for the storage of a plurality of stacks of storage containers. The prefabricated modular panels are load bearing in the sense that when assembled together to form the supporting framework structure, they provide a load bearing structure to support one or more load handling devices moving on the track system mounted to the supporting framework structure. Having each of the prefabricated modular panels extend in a single plane also facilitates the ability to flat pack the supporting framework structure for transport. The prefabrication of the modular panels permits quick assembly of the supporting framework structure at a site or within a building. This has the advantage that the supporting framework structure can be constructed in existing vacant buildings or warehouses.

To mitigate the effects of thermal expansion of the prefabricated frames in a single modular storage cell impacting an adjacent modular storage cell in the grid framework structure, the arrangement of the prefabricated frames in each of the modular storage cells in the grid framework structure can function as standalone modular units that are sufficiently spaced apart to not impact an adjacent modular storage cell in the assembly. Thus, forces generated as a result of thermal expansion effects in a single modular storage cell is prevented from impacting the geometry of an adjacent modular storage cell. As each of the individual modular storage cells is assembled from a plurality of prefabricated panels, the spacing between adjacent modular storage cells is such so as to allow components of the prefabricated panels to elastically deform in the spacing but not exceed the spacing to cause plastic deformation. One of the main consequences of the thermal expansion effects of the grid framework structure is the distortion of the tracks on which the robotic load handling device runs, as the distortion will prevent the robotic load handling device from properly moving on the grid framework structure since the wheels of the load handling device are constrained within the tracks of the track system.

To cater for the effects of thermal expansion of the assembly of modular storage cells, the present invention provides a grid framework structure for supporting one or more robotic load handling devices operative on the grid framework structure, the grid framework structure comprising: a supporting framework structure comprising a plurality of prefabricated frames arranged in a three-dimensional grid pattern comprising a plurality of modular storage cells for the storage of a plurality of stacks of containers such that adjacent modular storage cells share a common prefabricated frame, each of the plurality of prefabricated frames lying in a vertical plane and comprising a plurality of vertical members braced together by a bracing member; a track system for guiding movement of the one or more robotic load handling devices on the grid framework structure, the track system being mounted to the supporting framework structure and comprising a plurality of tracks arranged in a grid pattern comprising a plurality of grid cells extending across the plurality of modular storage cells such that each of the plurality of modular storage cells is configured to support a sub-group of two or more grid cells of the track system; wherein the track system further comprises a track support structure comprising a plurality of track supports arranged in a grid pattern corresponding to the grid pattern of the track system, the plurality of track supports being interconnected at the intersections of the plurality of track supports in the grid pattern, the track support structure is sub-divided into a plurality of modular sub-frames such that each of the plurality of modular sub-frames comprises the sub-group of two or more grid cells of the track system, wherein the interconnections of the plurality of track supports at the interface between the adjacent modular storage cells comprise one or more slip joints such that adjacent modular sub-frames are moveable relative to each other along a substantially horizontal plane via the one or more slip joints.

For the purpose of definition, the arrangement of the tracks and the track supports in a grid pattern include having a first set of parallel tracks and/or track supports extending in a first direction and a second set of parallel tracks and/or track supports extending in a second direction, the second direction being substantially perpendicular to the first direction. In comparison to the interconnections of the plurality of track supports at the interface between adjacent storage cell, the interconnections at the intersections of the plurality of track supports within a given modular sub-frame are fixedly connected together. For the purpose of definition of the present invention, the term “fixedly” is construed to mean that is there is little or no movement at the intersections of the plurality of track supports relative to each other in excess of 0.5 mm. In comparison to the stick build process to erecting the grid framework structure known in the art, the grid framework structure according to the present invention is formed from a plurality of prefabricated panels that are arranged in a grid pattern such that adjacent modular storage cells share a common prefabricated frame. The common prefabricated frame shared between adjacent modular storage cells enables a track system to extend across the plurality of modular storage cells for one or more robotic load handling devices operative on the grid framework structure to move across the plurality of modular storage cells. The plurality of prefabricated frames arranged in a three-dimensional grid pattern defines a supporting framework structure for supporting the track system. In addition to the need to assemble the prefabricated frames forming the supporting framework structure faster than the traditional stick build approach, there is also a need to assemble the track system faster. Traditionally, the track system is formed by laying individual track elements in both X and Y Cartesian directions in a horizontal plane and interconnecting the track elements to the upright members where the track elements intersect in the track system by a cap plate (see PCT/EP2021/055217 in the name of Ocado Innovation Limited and WO18146304 in the name of Autostore Tech AS). Laying the individual track elements separately is not only time consuming but cumbersome as the track elements would need to be individually interconnected to the vertical uprights.

The track system comprises a track support structure comprising a plurality of track supports arranged in a grid pattern corresponding to the grid pattern of the plurality of tracks. The plurality of track supports are interconnected at the intersections of the plurality of track supports in the grid pattern. To provide a track system that can be installed faster than the traditional method of laying individual track elements, the track support structure is sub-divided into a plurality of discrete modular sub-frames. Each of the plurality of modular sub-frames comprises the sub-group of the two or more grid cells of the track system, e.g. a sub-group of X by Y grid cells of the track system, where X and Y can be any number equal to 2 or greater. The interconnections at the intersections of the plurality of tracks supports within a given modular sub-frame are fixedly connected together. Thus, instead of building up the track system from individual track elements, the track system is assembled from modular sub-frames. As each modular sub-frame comprises a sub-group of two or more grid cells of the track system, assembling the modular sub-frames together to form the track system becomes much easier. Each of the modular sub-frames can be sized to occupy a single modular storage cell of the supporting framework structure such that each of the plurality of modular storage cells is configured to support two or more grid cells of the track system. This provides the advantage of prefabricating sections of the track system prior to assembly on the supporting framework structure. For example, sub-dividing the track support structure into a plurality of discrete modular sub-frames allows sections of the track system to be hoisted onto the supporting framework structure. The plurality of tracks can be integrated into the track support structure, in which case both the track and the track support can simply be mounted to the supporting framework structure in a single operation. Alternatively, the plurality of tracks can be separately mounted to the track support structure resulting in a double operation involving laying the track support structure to the supporting framework structure and subsequently mounting the tracks to the track support structure.

In contrast to the interconnections of the plurality of track supports at the intersections of the plurality of track supports being fixedly connected together (e.g. by a bolt), the interconnections at the interface between the adjacent modular storage cells are moveable via one or more slip or movement joints. The one or more slip or movement joints at the interface between adjacent modular storage cells allows for thermal expansion in the track system allowing adjacent modular sub-frames to be moveable relative to each other along a substantially horizontal plane. The one or more slip joints at the interface between adjacent modular storage cells allows for movement in the range 0.5 mm to 10 mm, preferably in the range 0.5 mm to 5 mm to accommodate for thermal expansion of the track supports. In other words, the one or more slip joints allows for greater movement between the interconnections of the track supports at the interface between adjacent modular storage cells than the interconnections of the plurality of track supports within a given modular sub-frame. Thus, movement in one modular storage cell as a result of thermal expansion does not greatly affect movement of an adjacent modular structure cell due to movement via the one or more slip joints between adjacent modular storage cells. Optionally, each of the one or more of the slip joints comprises a bracket (e.g. cradle bracket) that is configured to cradle one or more track supports between adjacent modular storage cells such that adjacent modular sub-frames are separable. Alternatively, each of the one or more slip joints can comprise a bridging member comprising a pin and slot arrangement, whereby the pin is moveable in the slot.

Considering that the track support structure is sub-divided into a plurality of modular sub-frames, optionally, the one or more slip joints comprises: a first set of slip joints at the interface between the adjacent modular storage cells in a first direction such that the adjacent modular sub-frames are moveable relative to each other along the substantially horizontal plane in the first direction and; a second set of slip joints at the interface between the adjacent modular storage cells in a second direction such that the adjacent modular sub-frames are moveable relative to each other along the substantially horizontal plane in the second direction, wherein the second direction is substantially perpendicular to the first direction.

Having a first and second sets of slip or movement joints allows movement of adjacent modular sub-frames of the track support structure at the interface between adjacent modular storage cells in the first direction and in the second direction.

To form a grid framework structure comprising a plurality of standalone modular storage cells or modular units, one or more vertical members of adjacent prefabricated frames are connected together by one or more fasteners at the interface between adjacent modular storage cells. To enable the connected vertical members to deflect and absorb the thermal expansion of the track support structure, preferably, adjacent vertical members at the interface or junction between adjacent modular storage cells are spaced apart such that adjacent modular sub-frames are spaced apart. As a consequence of the spacing between the vertical members at the junction between adjacent modular storage cells sharing a common prefabricated frame, the distal ends of one or more of the plurality of tracks mounted to the horizontal bracing member of the prefabricated frames are spaced apart. This is because the surface area of the track system extending across the plurality of modular storage cells has been slightly enlarged due to the spacing between the vertical members. As the vertical members are anchored to the floor, bending moments generated as a result of thermal expansion in one or more components of the track system are transferred to the vertical members. As the grid framework structure is formed from a plurality of prefabricated frames arranged in a grid pattern comprising the plurality of modular storage cells, the vertical members of adjacent modular storage cells are allowed to flex or elastically deform within the spacing between the adjacent modular storage cells rather than impacting the vertical members of an adjacent modular storage cell. Bending of the vertical members at the junction between adjacent modular storage cells is absorbed by the movement of the modular sub-frames via movement along their respective slip joints. To space adjacent vertical members at the junction between adjacent modular storage cells, optionally, one or more spacers are disposed between the adjacent vertical members at the interface between adjacent modular storage cells sharing the common prefabricated frame.

To control the deflection of the vertical members in orthogonal directions, e.g. in the X-direction and in the Y-direction, each of the one or more spacers comprises a first spacing member or portion and a second spacing member or portion, the first spacing member being configured to space adjacent vertical members connected in the first direction by a first spacing and the second spacing member being configured to space adjacent vertical members connected in the second direction by a second spacing. At least three adjacent vertical members are connected together at the interface between adjacent modular storage cells depending on the position of the adjacent vertical members in the supporting framework structure. At the edge of the supporting framework structure, three vertical members from three separate prefabricated frames are connected in the first direction and in the second direction, i.e. two vertical members are connected to the spacer in the first direction and one vertical member is connected to the spacer in the second direction. Similarly, four adjacent vertical members internally of the supporting framework structure from four separate prefabricated frames are connected to the spacer in the first direction and in the second direction. To prevent adjacent vertical members connected in the first direction and/or second direction fouling the storage containers when being lifted through a grid cell, optionally, the first spacing is different to the second spacing.

To control the shape of the deflections of the vertical members at the interface between adjacent modular storage cells, the one or more spacers comprises a plurality of spacers distributed along the longitudinal length of the adjacent vertical members at the interface between the adjacent modular storage cells sharing the common prefabricated frame. Optionally, the spacing between the vertical members between adjacent modular storage cells sharing the common prefabricated frame is in the range 5 mm to 120 mm, preferably between 10 mm to 120 mm.

To control the degree of deflection of the vertical members at the interface between adjacent modular storage cells, optionally, each of the one or more slip joints comprises a limit stop for limiting relative movement between adjacent modular sub-frames a predetermined distance along the substantially horizontal plane. The limit stop prevents excessive movement of the modular sub-frames of the track support structure at the interface between adjacent modular storage cells, which in turn prevents excessive movement or deflection of adjacent vertical members connected in the first direction and in the second direction.

To assemble the supporting framework structure from the plurality of prefabricated frames sharing a common prefabricated frame between adjacent modular storage cells, the plurality of prefabricated frames are arranged to form a plurality of modular units, each of the plurality of modular units comprising an interface portion that is arranged to interface with the interface portion of an adjacent modular unit to form a plurality of modular storage cells sharing a common prefabricated frame between adjacent modular storage cells.

Preferably, the plurality of prefabricated frames are arranged to form a first type modular unit and a second type modular unit, the second type modular unit having an interface portion that is configured to interface with the first type modular unit in either the first direction or the second direction to form at least a portion of the supporting framework structure comprising at least two modular storage cells sharing at least one common prefabricated frame at the interface between adjacent modular storage cells. To form the at least two modular storage cells sharing a single common prefabricated frame, optionally, the first type modular unit is a closed sided modular unit and the second type modular unit is an open sided modular unit having an open side along one side of the modular unit such that the open side of the second type modular unit is closed by sharing the common prefabricated frame with the first type modular unit. Optionally, the first type modular unit comprises four prefabricated frames arranged to form a closed sided structure and the second type modular unit comprises three prefabricated frames arranged to form a substantially U-shaped structure, the substantially U-shaped structure of the second type modular unit being closed by sharing the common prefabricated frame with any one of the closed sided structure of the first type modular unit. Each of the plurality of the modular units can be standalone structures that are able to independently move relative to each other. Movement of the track system as a result of the movement of one or more of the modular units in either the first direction or the second direction is relieved by the slip joints between adjacent modular units.

Optionally, the plurality of prefabricated frames are arranged to form a third type modular unit, said third type modular unit comprising at least two interface portions that are configured to interface with the first, the second and/or third type modular units in the first direction and in the second direction respectively to form at least four modular storage cells.

Optionally, the third type modular unit is an open sided modular unit along two sides of the modular unit such that the open sided modular unit along the two sides of the modular unit is closed by sharing two common prefabricated frames with the first and/or second type modular units between adjacent modular storage cells in the first direction and in the second direction.

Optionally, the third type modular unit comprises two prefabricated frames arranged to form a substantially L-shaped structure such that the third type modular unit shares two common prefabricated frames between adjacent modular storage cells in the first direction and in the second direction.

To interconnect adjacent modular sub-frames of the track support structure between adjacent modular storage cells by the one or more slip joints, the plurality of modular sub-frames of the track support structure comprises a first type modular sub-frame and a second type modular sub-frame, the first type modular sub-frame being a closed sided sub-frame and the second type modular sub-frame being an open sided sub-frame, the first type modular sub-frame being mounted to the first type modular unit and the second type modular sub-frame being mounted to the second type modular unit such that the open side sub-frame of the second type modular sub-frame is closed in the first direction or in the second direction by a side of the first type modular sub-frame at the interface between adjacent modular sub-frames comprising the one or more slip joints. As a result, movement between the first type modular sub-frame and the second type modular sub-frame via the one or more slip joints occurs in either the first direction or the second direction. Optionally, the plurality of modular sub-frames of the track support structure further comprises a third type modular sub-frame, the third type modular sub-frame being an open sided sub-frame along two sides of the sub-frame and being mounted to the third type modular unit such that the open sided sub-frame of the third type modular sub-frame along the two sides of the sub-frame is closed in the first direction and in the second direction by the first type modular sub-frame and/or second type modular sub-frame between adjacent modular storage cells comprising the one or more slip joints. As a result, movement between the third type modular sub-frames and the first type modular sub-frame and/or second type modular sub-frame at the interface between adjacent movement modular storage cells occurs in the first direction and in the second direction.

Traditionally, the containers or storage bins in a stack are guided through a respective grid cell by vertical uprights at each of the nodes or intersections of the track system. The vertical uprights are typically arranged such that the track system is supported by a vertical upright at each node or junction where the tracks intersect or are interconnected to form multiple storage columns for storing storage containers one or top of the other in vertical stacks. As a result, all four corners of the storage containers cooperate with the vertical uprights as the container is lifted or hoisted towards the load handling device operative on the track system so as to prevent the containers from swinging side to side.

The assembly of the prefabricated modular panels to form a three-dimensional grid framework structure generates one or more open storage spaces for accommodating multiple stacks of storage containers. The open storage space has a surface area so as to accommodate multiple grid cells of the track system. The removal of the vertical uprights has meant that the containers are lifted and raised through a grid cell of the track system in free space by a load handling device operative on the track system. To prevent the grabber device and any storage container attached thereto from swinging when being lifted through a grid cell of the track system, each of the plurality of modular storage cells comprises a plurality of tote guides extending substantially vertically between the track system and the floor, the plurality of tote guides being arranged in a pattern for accommodating a stack of storage containers between the plurality of tote guides and to guide the storage container through a respective grid cell of the track system.

Unlike the uprights of the prefabricated modular panels, which are largely load bearing, the plurality of tote guides are intended to guide the grabber device and/or storage container through a grid cell of the track system. Preferably, each tote guide of the plurality of tote guides comprises two perpendicular bin guiding plates extending between the track system and the floor for accommodating a corner of a storage container. The two perpendicular bin guiding plates are configured to accommodate a corner section of a grabber device and/or storage container. Thus, four tote guides would be necessary to accommodate the four corner sections of a standard storage container, which is generally rectilinear in shape.

As it is not necessary for each of the plurality of tote guides to be load bearing, lower cost manufacturing methods can be used to fabricate the tote guides. Optionally, the plurality of tote guides are formed from a sheet metal blank folded along parallel fold lines and extend longitudinally along the sheet metal blank to form two substantially perpendicular bin guiding plates defining two tote guides. Examples of folding a sheet metal blank into a tote guide include but is not limited to cold rolling.

Whilst it is not necessary to engage or accommodate all four corners of a storage container along the tote guides as the container is hoisted towards the track system by the lifting mechanism of the load handling device, in another embodiment of the present invention, the plurality of tote guides are arranged for guiding one or more containers in a stack along only a pair of diagonally opposed corners of the one or more containers. This gives the grabber device and/or the storage containers a level of lateral stability in the X and Y direction as the storage container is hoisted along diagonally opposed guides. By guiding the grabber device and/or the storage container attached thereto by only diagonally opposed tote guides, the number of tote guides necessary to guide the grabber device and/or the storage container attached thereto is reduced. In fact, the plurality of tote guides can be arranged at alternate nodes in the first direction (e.g. X direction) and in the second direction (e.g. Y direction), the second direction being substantially perpendicular to the first direction, such that the one or more containers are stacked between two guides at only the diagonally opposed corners of the storage containers.

Optionally, the plurality of vertical members of each of the prefabricated frames are braced by one or more bracing members. The one or more bracing members extending between the plurality of vertical members of a prefabricated frame provides a lightweight rigid framed panel comprising a triangulated system of straight interconnected structural bracing elements that are in axial tension or compression. Preferably, the bracing member of each of the plurality of prefabricated frames comprises one or more horizontal and/or diagonal bracing members. There are different arrangements of the bracing members to provide different triangulated systems of straight interconnected structural bracing elements that are in axial tension or compression. Optionally, the one or more bracing members are arranged between the plurality of vertical members of the prefabricated braced frame in a cross-brace or a K-brace or a V-brace or an eccentric brace arrangement. The term “prefabricated frame” and “prefabricated braced frame” are used interchangeably throughout the description to mean the same feature. Optionally, each of the prefabricated frames comprises an A-frame. Bracing the plurality of vertical members by a straight horizontal bracing member forms at least one drag strut or collector. A drag strut or collector is where the at least two vertical members are braced by the horizontal bracing member at the top or bottom of the two uprights and functions to collect and transfer diaphragm shear forces to the uprights. To improve the structural integrity of the supporting framework structure, each of the plurality of vertical members in a given prefabricated frame has a cross-sectional profile that is different to the cross-sectional profile of the one or more horizontal and/or diagonal bracing members. For example, the structural integrity of the prefabricated frames can be increased by strengthening the diagonal bracing members in comparison to the other frame members of the prefabricated frame, e.g. by increasing the wall thickness or shape of the cross-sectional profile of the diagonal bracing members. To further increase the structural integrity of the prefabricated frame, each of the one or more horizontal and/or diagonal bracing members can be reinforced by one or more inserts

In addition to the track support structure being modular, the plurality of tracks can also comprise a plurality of modular track sections, each modular track section of the plurality of modular track sections comprising substantially perpendicular track section elements so as to provide a track surface extending in the first direction and the second direction, the second direction being substantially perpendicular to the first direction. By having a track system whereby each track section of the plurality of track sections is formed as a unitary or single body, the track section provides a track surface or path extending in transverse directions, e.g. cross shaped. As a result, the number of track sections necessary to build the track system is reduced in comparison to prior art track systems-thereby simplifying the layout of the track sections on the track support structure. For example, a one to one relationship can exist between each of the plurality of track sections and a single node in the track system, in the sense that only a single track section is required at each of the nodes of the track system. A ‘node’ in the track system is the point where the plurality of tracks and/or the track supports intersect in the grid pattern. In prior art track systems, there is a two to one relationship between the number of track sections and a single node in the track system in the sense there is one track section extending in a first direction and a separate track section extending in the second direction. In one example of achieving a one to one relationship between each of the plurality of track sections and each node in the track system, preferably each track section of at least a portion of the plurality of modular track sections comprises: a first track section element extending in the first direction; and a second track section element intersecting the first track section element and extending in the second direction such that the track section is configured for mounting at one or more nodes of the track support structure. More preferably, each of the plurality of track sections is formed as a unitary body or a single piece body. In other words, each of the plurality of track sections can be cross shaped, having a first track section element extending in the first direction and a second track section element intersecting with the first track section element and extending in the second direction. The first and second track section elements can also be termed transverse portions or branches of the track section. Being formed as a single or unitary body allows the track sections to be mounted to each of the nodes of the track support structure where the track supports intersect. This removes the need to have separate track or rail elements that separately extend in the first and second direction as found in prior art solutions. In addition to simplifying the laying of the plurality of tracks to the track support structure, the cross shaped configuration of the modular track sections enables the modular track sections to bridge the interface between adjacent modular storage cells so as to provide a continuous track surface extending across adjacent modular storage cells.

However, the present invention is not limited to having a one to one relationship between a single track section and the number of nodes of the track system. For example, a single track section formed as a unitary body can be configured to extend across multiple nodes of the track system and yet provide a track surface extending in transverse directions.

Generally in the art, to ensure that the track system is level and to compensate for an uneven floor, the level of the track system mounted to the vertical uprights is adjusted by having an adjustable levelling foot at the base or lower end of the vertical uprights comprising a threaded shaft that can be extended or retracted relative to the base of the vertical upright. To compensate for the unevenness of the floor or ground, one or more of the prefabricated frames forming the supporting framework structure can be mounted on an adjustable levelling foot comprising a threaded shaft that can be extended or retracted relative to the base of the prefabricated frame.

The present invention provides a storage and retrieval system comprising: a grid framework structure according to the present invention; a plurality of stacks of containers arranged in storage columns located below the track system, wherein each storage column is located vertically below a grid cell; a plurality of load handling devices for lifting and moving containers stacked in the stacks, the plurality of load handling devices being remotely operated to move laterally on the track system above the storage columns to access the containers through the grid cells, each of said plurality of load handling devices comprising: a wheel assembly for guiding the load handling device on the track system; a container-receiving space located above the track system; and a lifting device arranged to lift a single container from a stack into the container-receiving space.

The present invention further provides a method of assembling a grid framework structure according to the present invention, comprising the steps of: assembling the plurality of prefabricated frames in a grid pattern to form a supporting framework structure comprising a plurality of modular storage cells such that adjacent modular storage cells share a common prefabricated frame; mounting the plurality of modular sub-frames to the supporting framework structure in a substantially vertical direction such that the interfaces between adjacent modular sub-frames are interconnected by the one or more slip joints.

The number of slip joints at the interface between adjacent modular storage cells depends on the position of the modular sub-frame in the track support structure which in turn depends on the number of sides of the modular sub-frame that interface with an adjacent modular sub-frame in the track support structure. For example, a modular sub-frame located in the center of the track support structure interfaces with four adjacent modular sub-frames, with each of the four sides of the modular sub-frame interfacing with a respective one of the four adjacent modular sub-frames. A modular sub-frame located at an edge of the track support structure interfaces with three adjacent modular sub-frames, so three of the four sides of the modular sub-frame interface with adjacent modular sub-frames, and the fourth side of the modular sub-frame forms part of the edge of the track support structure. A modular sub-frame located at a corner of the track support structure interfaces with two adjacent modular sub-frames, so two of the four sides of the modular sub-frame interface with adjacent modular sub-frames and the other two sides of the modular sub-frame form part of the edges of the track support structure. Thus, in a given modular sub-frame, one or more slip joints extends in orthogonal directions to cater for movement in the first direction (x-direction) and the second direction (y-direction). To accommodate the one or slip joints at the different sides of the modular sub-frame, each of the plurality of modular sub-frames would need to be mounted to the supporting framework structure in a substantially vertical direction.

Optionally, the steps of assembling the supporting framework structure further comprises the steps of: assembling four prefabricated frames to form a closed sided modular unit defining a first type modular unit; assembling a plurality of prefabricated frames to the first type modular unit; wherein the plurality of prefabricated frames comprises three prefabricated frames arranged in a substantially U-shaped structure defining a second type modular unit such that the second type modular unit shares the common prefabricated frame with the first type modular unit.

In the build of the grid framework structure, the first type modular unit can be defined as the origin of the build and the remaining modular units are built around the origin. The origin provides a stable structure for mounting the prefabricated frames to the origin (first type modular unit). The remaining modular units can be assembled onto the origin by separately assembling the prefabricated frames to the origin or optionally, the second type modular unit can be pre-assembled prior to being assembled onto the first type modular unit.

Optionally, the plurality of prefabricated frames further comprises two prefabricated frames arranged in a substantially L-shaped structure defining a third type modular unit such that the third type modular unit shares the common prefabricated frames with the second type modular unit.

Optionally, the method further comprising the step of pre-assembling the third type modular unit prior to being assembled onto the second type modular unit.

Further features of the present invention will be apparent from the detailed description with reference to the drawings.

### DESCRIPTION OF THE DRAWINGS

Further features and aspects of the present invention will be apparent from the following detailed description of an illustrative embodiment made with reference to the drawings, in which:

FIG. 1 is a schematic diagram of a grid framework structure according to a known system.

FIG. 2 is a schematic diagram of a top down view showing a stack of bins arranged within the supporting framework structure of FIG. 1.

FIG. 3 is a schematic diagram of a known storage system comprising a load handling device operating on the grid framework structure.

FIG. 4 is a schematic perspective view of the load handling device showing the lifting device gripping a container from above.

FIGS. 5A-5B are schematic perspective cut away views of the load handling device of FIG. 4, wherein FIG. 5A shows a container accommodated within the container receiving space of the load handling device and FIG. 5B shows the container receiving space of the load handling device.

FIG. 6 is a top plan view of a section of a known grid structure comprising four adjoined grid cells showing the intersections or nodes of the grid members being supported by a vertical upright, each of the grid cells constituting a storage column.

FIG. 7 is a perspective view showing four vertical uprights making up a storage space or storage column within a grid framework structure.

FIG. 8 is a perspective view showing the arrangement of the tracks and track supports interconnected at their nodes or intersections by a cap plate.

FIG. 9 is a perspective view of a track support or grid member.

FIG. 10 is a perspective view of a cap plate for interconnecting the vertical uprights to the grid members at the nodes.

FIG. 11 is a perspective cross sectional view of the interconnection of the vertical uprights to the grid members by the cap plate at a node.

FIG. 12 is a perspective view of a track or rail.

FIG. 13A is a perspective view of the grid framework structure according to an embodiment of the present invention.

FIG. 13B is a perspective view of an individual prefabricated frame used to assemble the supporting framework structure.

FIG. 13C is a perspective view of a vertical upright used to manufacture the prefabricated frame shown in FIG. 13B.

FIG. 13D is a perspective view of a diagonal bracing member used to manufacture the prefabricated frame shown in FIG. 13C.

FIG. 13E is a perspective view of a horizontal bracing member used to manufacture the prefabricated frame shown in FIG. 13D.

FIG. 14A is a schematic drawing illustrating the thermal expansion of adjoining prefabricated frames in the supporting framework structure.

FIG. 14B is a schematic drawing illustrating the thermal contraction of adjoining prefabricated frames in the supporting framework structure.

FIG. 15A is a schematic drawing illustrating the thermal expansion of spaced apart adjacent prefabricated frames in the supporting framework structure.

FIG. 15B is a schematic drawing illustrating the thermal contraction of spaced apart adjacent prefabricated frames in the supporting framework structure.

FIG. 15C is a perspective view of a section grid framework structure showing the spacing between adjacent modular storage units according to the present invention.

FIG. 15D is a perspective top plan view of the vertical uprights from four separate prefabricated panels connected in the first direction along the axis, X-X, and in the second direction along the axis, Y-Y.

FIG. 15E is a perspective view of an example of a spacer used to space adjacent vertical uprights connected in the first direction and in the second direction.

FIG. 16 is a perspective view of the supporting framework structure of the grid framework structure shown in FIG. 13A.

FIG. 17 is a schematic drawing illustrating a top plan view of the supporting framework structure in FIG. 16 showing the arrangement of a plurality of interfacing modular units.

FIG. 18 is a perspective view of a partially assembled first type modular unit of the supporting framework structure showing the assembly of prefabricated frames.

FIG. 19 is a perspective view of the assembled first type modular unit shown in FIG. 18 representing a single modular storage cell.

FIG. 20 is a perspective view showing the first type modular sub-frame of the track support structure being mounted to the first type modular unit shown in FIG. 19.

FIG. 21 is a perspective view of the assembled first type modular unit together with the mounted first type modular sub-frame.

FIG. 22 is a perspective view of the grid framework structure comprising two modular storage cells of the supporting framework structure and interfacing modular sub-frames of the track support structure.

FIG. 23 is a perspective view showing the joint between adjacent modular sub-frames of the track system by one or more slip or movement joints at the interface between adjacent modular storage cells.

FIG. 24A is a perspective view of an individual slip or movement joint for joining adjacent modular sub-frames of the track support structure at the interface between adjacent modular storage cells.

FIG. 24B is a perspective view of a section of the grid framework structure at the interface of a modular storage cell showing a slip joint mounted to the track support.

FIG. 24C is a perspective view of a slip joint member using the connected adjacent modular sub-frames at the interface between modular storage cells shown in FIG. 24B according to a second example of the present invention.

FIG. 24D is a perspective underside view of the intersection of the tracks supports at the interface between adjacent modular storage cells showing the mounting for the slip joint shown in FIG. 24C.

FIG. 24E is a perspective underside view of the intersection of the tracks supports at the interface between adjacent modular storage cells shown in FIG. 24D showing the slip joint shown in FIG. 24C.

FIG. 25 is a perspective view of the grid framework structure comprising three modular storage cells of the supporting framework structure.

FIG. 26 is a perspective view showing the assembly of the grid framework structure comprising four modular storage cells.

FIG. 27 is a perspective view showing the track support structure extending across the four modular storage cells of FIG. 26.

FIG. 28 is a top plan view of the grid framework structure shown in FIG. 27 showing the adjoining first, second and third type modular sub-frames at the interface between adjacent modular storage cells.

FIG. 29 is a perspective view illustrating the plurality of track sections mounted to the track support structure at the interface between adjacent modular storage cells.

FIG. 30 is a perspective view illustrating the assembly of the track sections to the track support structure.

FIG. 31 is a perspective view showing a section of an underlying track support structure at a node of intersecting track supports.

FIG. 32 is a perspective view of a top plan view of a track section according to an embodiment of the present invention.

FIG. 33 is a perspective view of the underside of the track section shown in FIG. 32 showing the plurality of tabs for connecting to the track support structure shown in FIG. 31.

FIG. 34 is an illustration of the arrangement of track sections in a track system according to the present invention.

FIG. 35 is an isometric view of the grid framework structure showing the plurality of tote guides arranged for guiding the storage containers along diagonally opposed corners of the storage containers.

FIG. 36 is a perspective view illustrating sets of tote guides formed from a sheet metal blank folded along parallel fold lines.

FIG. 37 is a perspective view illustrating a portion of the prefabricated frame sandwiched between the sets of tote guides.

FIG. 38 is a perspective view illustrating the pluralities of tote guides shown in FIG. 36 and cap plate for interfacing with the track system.

FIG. 39 is a perspective view illustrating the cooperation between the cap plate mounted to the pluralities of tote guides and the track system.

FIG. 40 is a perspective view illustrating the arrangement of a plurality of modular crash barriers mounted around the periphery of the track system of the grid framework structure shown in FIG. 27.

FIG. 41 is a perspective view illustrating the arrangement of external cladding around the outer periphery of the supporting framework structure.

FIG. 42A shows a perspective view of an AGV and lifting mechanism engaging with a prefabricated frame prior to being lifted; FIG. 42B shows a perspective view of an orientation of the prefabricated braced panel prior to being assembled on the supporting framework structure.

FIGS. 43A-43D are isometric views of the grid framework structure. FIG. 43A shows a mezzanine incorporated into the supporting framework structure; FIG. 43B shows the arrangement of the modular units of supporting framework structure surrounding the mezzanine and across the mezzanine; FIG. 43C shows an exploded view of the interface between a first region of the grid framework structure and mezzanine; and FIG. 43D shows a second region of the grid framework structure above the mezzanine and the pick stations below the mezzanine.

FIG. 44 is an expanded view of the bridging elements interfacing the track system between the first region of the grid framework structure and the second region of the grid framework structure.

FIG. 45 is a perspective view of a single bridging element shown in FIG. 44.

### DETAILED DESCRIPTION

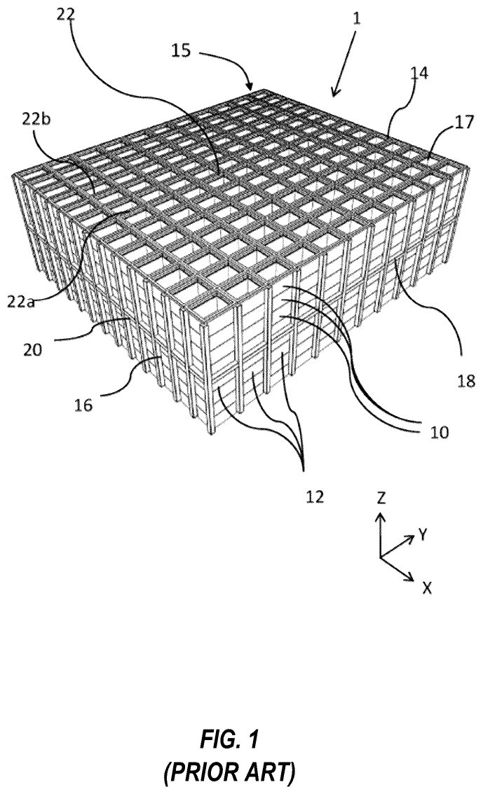

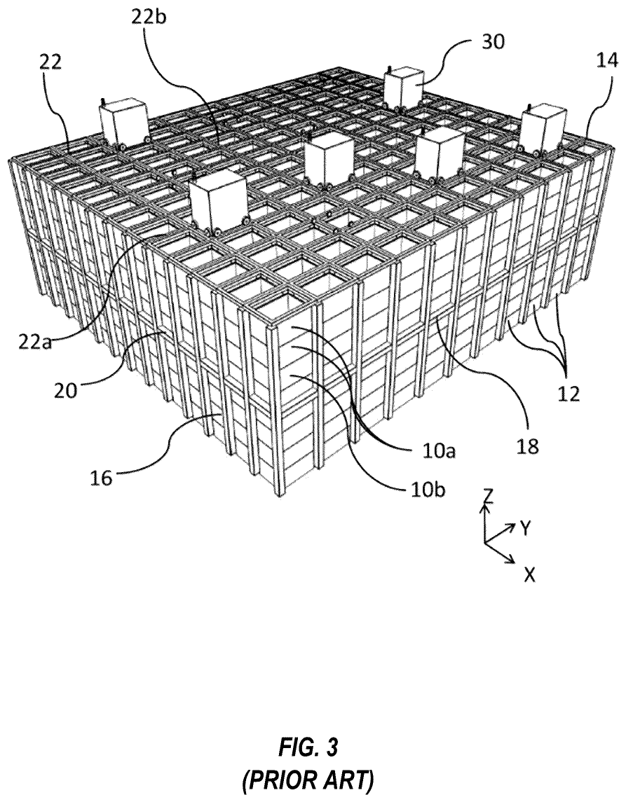

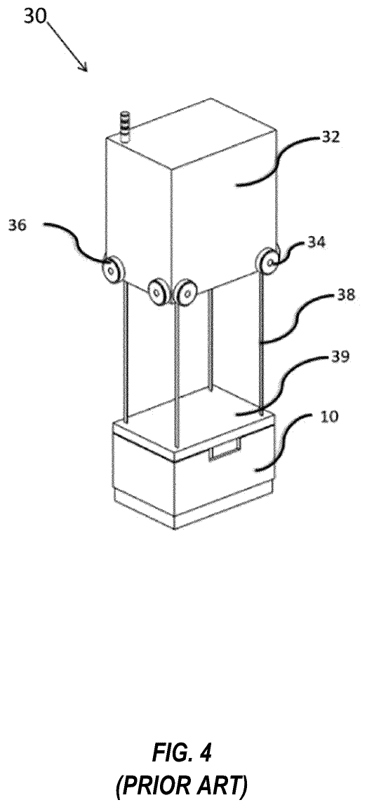

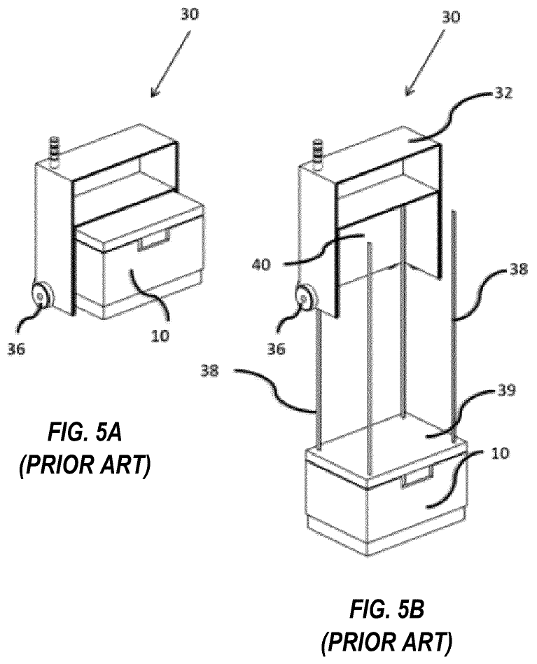

It is against the known features of the storage system such as the grid framework structure and the load handling device described above with reference to FIGS. 1 to 5, that the present invention has been devised.

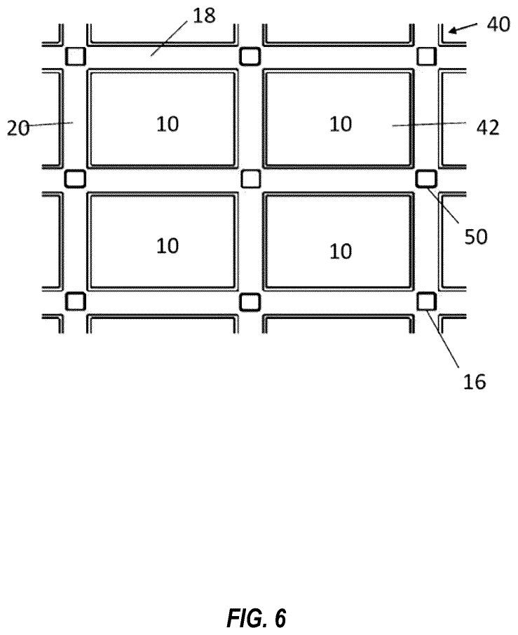

FIG. 6 shows a top view of a section or a portion of a traditional track system 15 comprising four adjoined grid cells 42 and FIG. 7 shows a perspective side view of a single grid cell 42 supported by four vertical uprights 16 to form a single storage column 44 for the storage of one or more containers 10 in a stack. The grid framework structure can be considered to be divided into a supporting framework structure comprising the plurality of vertical uprights and a track system. The track system is supported by the supporting framework structure and comprises a plurality of grid members arranged in a grid pattern comprising a plurality of grid cells.

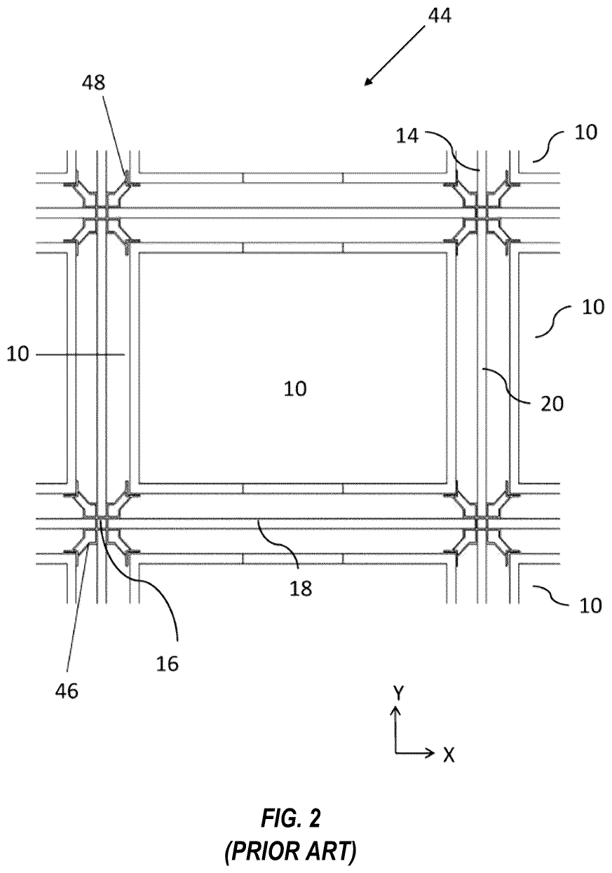

Each of the vertical uprights 16 are generally tubular. In transverse cross-section in the horizontal plane of the storage column 44 shown in FIG. 2, each of the vertical uprights 16 comprises a hollow center section 46 (typically a box section) with one or more tote guides 48 mounted to or formed at the corners of the hollow center section 46 that extends along the longitudinal length of the vertical upright 16 for guiding the movement of the containers along the storage column 44. The one or more tote guides 48 comprises two perpendicular container guiding plates. The two perpendicular container guiding plates are arranged to accommodate a corner of a container or a corner of a stack of containers. In other words, each of the corners of the hollow center section 46 defines two sides of a substantially triangular area which may accommodate a corner of a container or storage bin. The corners are evenly arranged around the hollow center section 46, such that multiple vertical uprights 16 may provide multiple adjacent storage columns, wherein each vertical upright 16 may be common to or shared by up to four separate storage columns. Also shown in FIG. 7 is that each of the vertical uprights 16 is mounted on an adjustable grid levelling mechanism 19 at the foot of the vertical uprights comprising a base and a threaded shaft that can be extended or retracted to compensate for an uneven floor.

The transverse cross-section in the horizontal plane of the storage column 44 in FIG. 2 shows that an individual storage column 44 is made up of four vertical uprights 16 arranged at the corners of the container or storage bin 10. A storage column 44 corresponds to a single grid cell. The cross section of the vertical upright 16 is constant over the whole length of the vertical upright. The periphery of a container or storage bin in the horizontal plane in FIG. 2 shows the container or storage bin having four corners and the arrangement of four vertical uprights 16 at the corners of the containers or storage bins within the storage column 44. A corner section of each of the four vertical uprights, one from each of the four vertical uprights, ensures that a container or storage bin stored in the storage column 44 is guided into a correct position relative to any container or storage bin stored within the storage column and the stacks of containers or storage bins in the surrounding storage columns. A load handling device operative (not shown) on the track system 15 is able to lift a container or storage bin as it is guided along the vertical uprights 16 through a grid cell 42. The vertical uprights 16 have a dual purpose; (a) to structurally support the track system 40, and (b) to guide the containers or storage bins 10 in the correct position through a respective grid cell 42.

Conventionally, during assembly of the grid framework structure, the individual vertical uprights 16 are erected first. The procedure for assembling the individual vertical uprights 16 is sometimes referred to as a ‘stick-built’ approach. The upper or top ends of the vertical uprights 16 are then interconnected by a plurality of grid members. A top plan view of a section of the track system 15 shown in FIG. 6 shows a series of horizontal intersecting beams or grid members 18, 20 arranged to form a plurality of rectangular frames constituting grid cells 42, more specifically a first a set of grid members 18 extending in a first direction X and a second set of grid members 20 extending in a second direction Y, the second set of grid members 20 running transversely to the first set of grid members 18 in a substantially horizontal plane, i.e. the track system is represented by Cartesian coordinates in the X and Y direction. The term “vertical upright(s)”, “upright member(s)”, “upright” and “upright column(s)” are used interchangeably in the description to mean the same thing. For the purpose of explanation of the present invention, the points or junctions where the grid members intersect or cross shown by the shaded squares in FIG. 6 can be defined as nodes or intersections 50. It is clearly apparent from the layout of at least a portion or section of a known track system 40 constituting four adjoining grid cells 42 shown in FIG. 6 that each intersection or node 50 of the track system 40 is supported by a vertical upright 16. From the section or at least a portion of the track system 40 shown in FIG. 6, the four adjoining grid cells are supported by nine vertical uprights 16, i.e. three sets of vertical uprights 16 supporting the track system at three rows, where each row comprises three nodes 50.

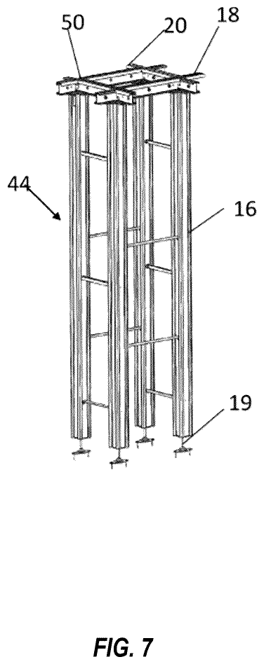

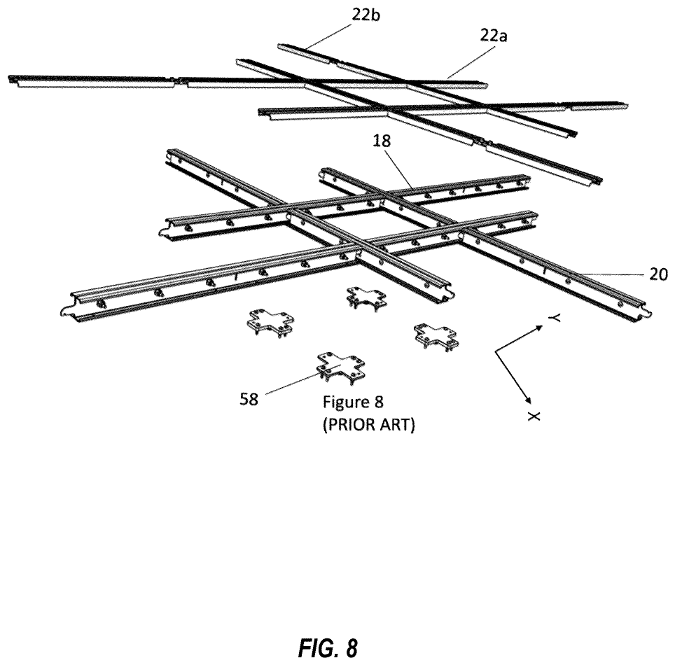

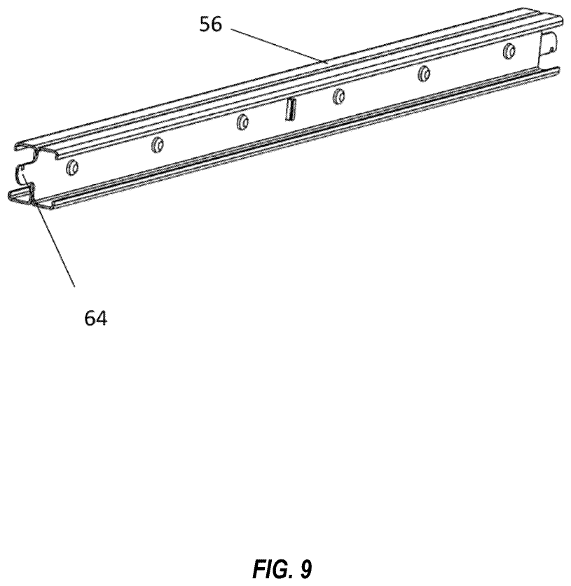

Each of the grid members can comprise a track support 18, 20 and/or a track or rail 22a, 22b (see track system in FIG. 8) whereby the track or rail 22a, 22b is mounted to the track support 18, 20. A load handling device is operative to move along the track or rail 22a, 22b of the present invention. Alternatively, the track 22a, 22b can be integrated into the track support 18, 20 as a single body, e.g. by extrusion. At least one grid member in a set, e.g. a single grid member, can be sub-divided or sectioned into discrete grid elements that can be joined or linked together to form a grid member 18, 20 extending in the first direction or in the second direction. Where the grid members comprise a track support, the track support can also be sub-divided into discrete track support elements that are linked or fixedly connected together to form the track support. The discrete track support elements making up a track support extending in the first axial direction and in the second axial direction are shown in FIG. 8. An individual track support element 56 used to make up a track support 18, 20 is shown in FIG. 9. The track support 18, 20 in transverse cross section can be a solid support of C-shaped or U-shaped or I-shaped cross section, or even double-C or double-U shaped support. In the particular embodiment of the present invention, the track support element 56 is a double back-to-back C section bolted together.

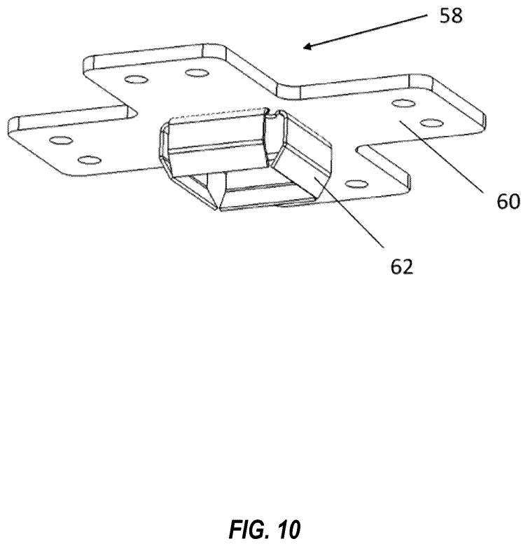

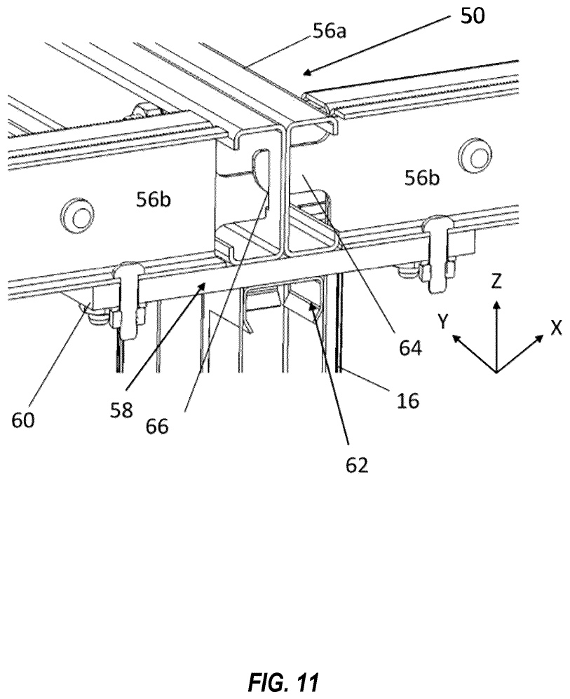

A connection plate or cap plate 58 as shown in FIG. 8 can be used to link or join or fixedly connect the individual track support elements 56 together in both the first and the second direction at the junction where multiple track support elements cross in the track system 15, i.e. the cap plate 58 is used to connect the track support elements 56 together to the vertical uprights 16. As a result, the vertical uprights 16 are interconnected at their upper ends at the junction where the multiple track support elements cross in the track system 15 by the cap plate 58, i.e. the cap plate is located at the node 50 of the track system 15. As shown in FIG. 10, the cap plate 58 is cross shaped having four connecting portions 60 for connecting to the ends or anywhere along the length of the track support elements 56 at their nodes or intersections 50. The interconnection of the track support elements to the vertical uprights at the nodes by the cap plate 58 is demonstrated in the cross-sectional profile of the node 50 shown in FIG. 11. The cap plate 58 comprises a spigot or protrusion 62 that is sized to sit in the hollow central section 46 of the vertical upright 16 in a tight fit for interconnecting the plurality of vertical uprights 16 to the track support elements as shown in FIG. 11. Also shown in FIG. 11 are the track support elements 56a, 56b extending in both perpendicular directions corresponding to the first direction (x-direction) and the second direction (y-direction). The connecting portions 60 are perpendicular to each other to connect to the track support elements 56a, 56b extending in the first direction and in the second direction respectively. The cap plate 58 is configured to be bolted to the ends of the track support elements 56a, 56b or along the length of the track support elements forming a rigid connection with the cap plate 58. Each of the track support elements 56a, 56b is arranged to interlock with each other at the nodes to form the track system 40 according to the present invention. To achieve this, distal or opposing ends of each of the track support elements 56a, 56b comprise locking features 64 (e.g., hooks or tongues) for interconnecting to corresponding openings 66 of adjacent track support elements. In the particular embodiment of the present invention, opposing or distal ends of one or more track support elements comprise at least one hook or tongue 64 that is receivable in openings or slot 66 midway along an adjacent track support element 56 at the junction where the track support elements cross in the track system 40. Referring back to FIG. 9 in combination with FIG. 11, the hooks 64 at the end of a track support element 56 are shown received in an opening 66 of an adjacent track support element extending across a vertical upright 16 at the junction where the track support elements 56 cross. Here, the hooks 64 are offered up to an opening 66 either side of a track support element 56b. The opening 66 is halfway along the length of the track support element 56 so that when assembled together, adjacent parallel track support elements 56 in the first direction and in the second direction are offset by at least one grid cell. This is demonstrated in FIG. 8.

To complete the track system 40 once the track support elements are interlocked together in a grid pattern comprising track supports 18 extending in the first direction and track supports 20 extending in the second direction, a track 22a, 22b is mounted to the track support elements 56. The track 22a, 22b is either snap-fitted and/or fitted over the track support 18, 20 in a slide fit arrangement (see FIG. 8). Like the track support, the track comprises a first set of tracks 22a extending in the first direction and a second set of tracks 22b extending in the second direction, the first direction being perpendicular to the second direction. A first set of tracks 22a is sub-divided into multiple track elements 68 in the first direction such that, when assembled, adjacent parallel track elements in the first direction are offset by at least once grid cell. Similarly, a second set of tracks 22b is sub-divided into multiple track elements 68 in the second direction such that, when assembled, adjacent track elements in the second direction are offset by at least one grid cell. This is demonstrated in FIG. 8. An example of a single track element 68 is shown in FIG. 12. As with the track support elements, multiple track elements in the first direction and the second direction are laid together to form a track in both directions. The fitting of the track element 68 to the track support 18, 20 comprises an inverted U-shaped cross-sectional profile that is shaped to cradle or overlap the top of the track support 18, 20. One or more lugs extending from each branch of the U shape profile engage with the ends of the track support 18, 20 in a snap fit arrangement. Equally plausible is that the track 22a, 22b can be integrated into the track supports 18, 20 rather than being separate components.

As can be appreciated from the above description, the process of assembling the grid framework structure involving erecting the vertical uprights, connecting the grid members and mounting the tracks is very time consuming since multiple separate components are necessary to assemble the grid framework structure. The process of erecting the grid framework structure can take several weeks and in a worst case scenario, the process can take several months. As the demand for e-commerce grows rapidly, particularly in the retail sector, there has been an increased demand for distribution centers, otherwise known as customer fulfilment centers (CFCs), in more locations rather than just a few locations that serve major cities in order to fulfil a growing demand from customers. The increased presence of distribution centers in more locations also has the effect of reducing the time to complete the last mile logistics for the movement of goods from the distribution center to its final destination. Such last mile logistics is also an important consideration in order to keep goods such as perishable grocery products fresh at their final destination. One of the major bottlenecks to providing distribution centers in more locations is the time and cost to erect the grid framework structure. Not only is the time and cost to erect the grid framework structure a cause of concern when setting up a distribution center, but also the grid framework structure should have the flexibility to be assembled in a number of existing locations including existing warehouses rather than bespoke warehouses purely to house the grid framework structure.

The present applicant has mitigated the above problem by forming the grid framework structure according to the present invention from fewer structural components than is currently practiced described above, while still maintaining the structural integrity of the existing grid framework structure for bearing the weight of one or more robotic load handling devices operative on the grid framework structure. In contrast to the existing grid framework structure as described above, the grid framework structure according to the present invention is erected from prefabricated modular structural components. The prefabricated modular structural components are load bearing in the sense that when assembled together to form the grid framework structure, the prefabricated modular structural components provide a three-dimensional load bearing structure to support one or more load handling devices moving on the track system. The use of prefabricated modular structural components to erect the grid framework structure according to the present invention allows the grid framework structure to be assembled at a much faster rate than the traditional ‘stick-built’ approach where individual vertical uprights are initially erected one by one on the floor, and then subsequently mounting the track supports to the upper end of the vertical uprights.

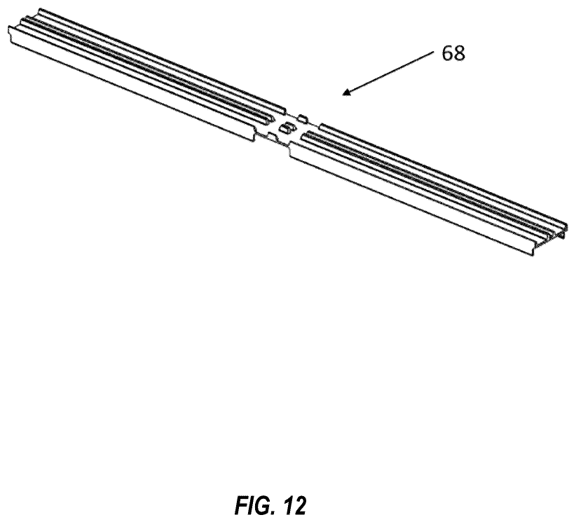

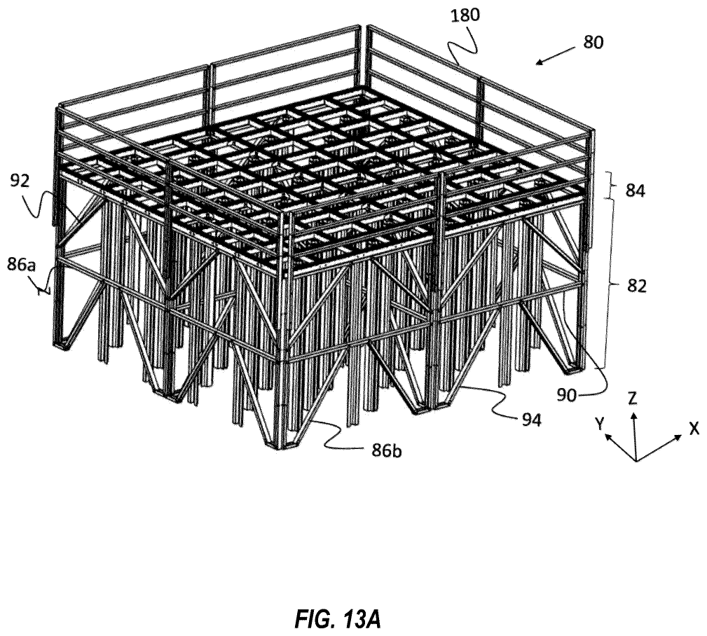

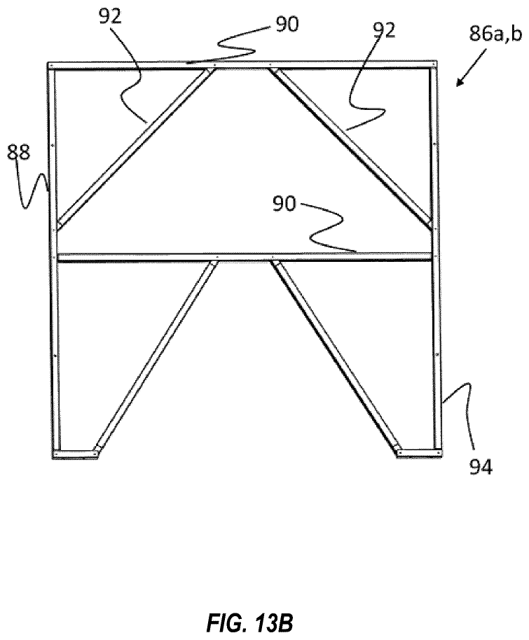

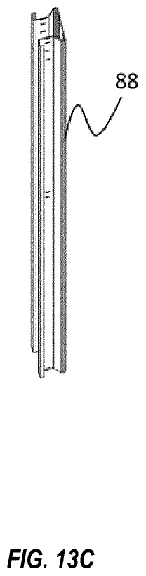

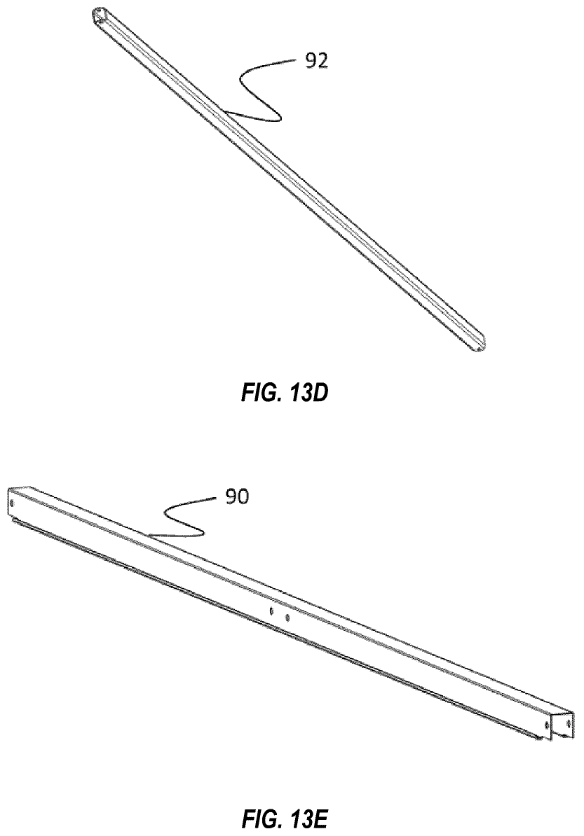

FIG. 13A is a grid framework structure 80 assembled from prefabricated modular structural components according to the present invention. The grid framework structure 80 can be divided into a supporting framework structure 82, and a track system 84 for guiding movement of one or more robotic load handling devices 30 on the supporting framework structure 82. When assembling the grid framework structure 80, the supporting framework structure 82 is first assembled and then the track system 84 is mounted to the supporting framework structure 82. The track system 84 is raised above the ground by the supporting framework structure 82 to create an open storage space for the storage of multiple stacks of storage containers. The supporting framework structure 82 or the track system 84 or both the supporting framework structure 82 and the track system 84 can be assembled from modular structural components. In the particular embodiment shown in FIG. 13A, both the supporting framework structure 82 and the track system 84 are assembled from prefabricated modular structural components to form a three-dimensional grid framework structure 80.

In the particular example of the present invention, the supporting framework structure 82 is formed from a plurality of prefabricated frames or panels 86a,b arranged in a grid pattern to define a three-dimensional supporting framework structure. Prefabrication of the frames 86a,b involves assembling and fixing separate components of the supporting framework structure 82 together prior to erecting the supporting framework structure 82 such that the components of each of the prefabricated frames 86a,b lie in a common plane. In other words, the prefabricated frames 86a,b can be envisaged to be planar. This allows ease of assembly of the supporting framework structure 82 since the use of prefabricated frames 86a,b greatly reduces the time and effort to assemble the supporting framework structure 82 rather than erecting a plurality of vertical uprights one by one in a “stick by stick” approach and then mounting the grid structure to the supporting framework structure as currently practiced in the art.

The prefabricated frames 86a,b forming the supporting framework structure according to the particular embodiment of the present invention shown in FIG. 13B are each configured as prefabricated braced frames or panels 86a,b comprising a plurality of uprights or vertical members 88 braced together by one or more bracing members 90, 92 extending between the plurality of uprights 88. In the particular embodiment of the present invention shown in FIG. 13B, the one or more bracing members 90, 92 comprises a horizontal bracing member 90 and a diagonal bracing member 92. The bracing allows a sub-group of uprights 88 to be assembled together prior to being assembled in the supporting framework structure 82. To enable the prefabricated braced frames 86a,b to be flat packed to facilitate transport, the plurality of uprights 88 of each of the prefabricated braced frames 86a,b extend in a common plane and are secured together by one or more bracing members 90, 92. The one or more bracing members connecting the plurality of uprights lie in the same plane as the plurality of the uprights such that each of the prefabricated braced frames is planar. Each upright 88 of the plurality of uprights can be a solid support beam of I-shape or H-shape or U shaped comprising opposing beam flanges or C shaped or L shaped to enable the uprights to be braced together by the one or more bracing members. The cross-sectional profile of each of the vertical members 88, horizontal bracing members 90 and the diagonal bracing members 92 in a given prefabricated frame 86a,b can be the same or different. In the particular embodiment of the present invention, the cross-sectional profile of each of the vertical uprights or vertical members 88, horizontal bracing members 90 and the diagonal bracing members 92 in a given prefabricated frame 86a,b are different. The difference in the cross-sectional profile of each of the vertical members 88, horizontal bracing members 90 and the diagonal bracing members 92 in a given prefabricated frame 86a,b helps to tailor the physical characteristics of the supporting framework structure. For example, the supporting framework structure should have sufficient ultimate tensile strength (UTS) to prevent breaking or failing under tension but yet have sufficient flexibility to enable the supporting framework structure to flex or deflect as a result of thermal expansion. By prefabricating the prefabricated frames from different shape cross-sectional profiles of the vertical members 88, horizontal bracing members 90 and the diagonal bracing members 92, the physical characteristics of the prefabricated frames 86a,b can be tailored to required physical characteristics.

FIGS. 13C-13E show the different cross-sectional profiles of the vertical members, horizontal and diagonal bracing members used to fabricated a prefabricated frame 86a,b according to the present invention. The diagonal bracing member 92 is shown in FIG. 13D having a box shaped cross-section profile and the horizontal bracing member is shown in FIG. 13E having a C-shaped cross-sectional profile. The cross section of the vertical upright is shaped to provide a resilient or deflecting portion and a connecting portion for connecting to the horizontal bracing member. Also shown in FIG. 13C are openings 89 for connecting the vertical members of adjacent prefabricated frames together in the supporting framework structure. However, to reduce costs and to improve the structural integrity of the prefabricated braced frame without jeopardizing the lightness of the prefabricated braced frame, the load bearing members of each of the prefabricated braced frames can have a single cross-sectional profile. For example, the load bearing members include the uprights 88 and the bracing members 90, 92, i.e. the entire prefabricated braced frame is formed from the same type of load bearing members having a C-shaped cross-section. To reduce cost of manufacture of the grid framework structure, each of the uprights 88 and/or the bracing members 90, 92 can be formed from a folded sheet metal blank having one or more fold lines. Examples of folding the sheet metal blank to form the upright 88 include but is not limited to cold rolling.

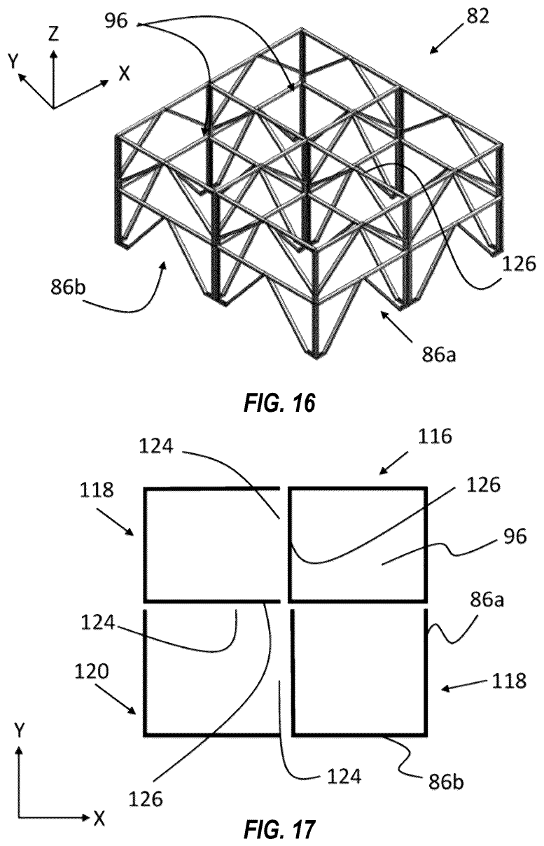

The plurality of uprights 88 of each of the prefabricated braced frames 86a,b making up the supporting framework structure 82 are braced by both horizontal 90 and diagonal bracing members 92. In the particular example shown in FIG. 13B, the plurality of horizontal bracing members 90 extend between the upper and middle regions of the plurality of uprights 88. The horizontal bracing members 90a,b function as a load bearing beam extending between the uprights 88, particularly mounted at their upper ends. The horizontal bracing members 90 include but are not limited to load bearing beams having cross-sectional shapes like L (angles), C (channels) or tubes. The horizontal bracing members 90 can be envisaged to represent the chords that connect the uprights 88 at their upper and/or middle regions. Bracing at least two of the uprights 88 at their upper and/or middle regions by at least one horizontal bracing member 90 forms at least one drag strut or collector commonly known in the art. A drag strut or collector is where the at least two vertical uprights are braced by a horizontal beam at the upper end of two uprights and functions to collect and transfer diaphragm shear forces to the uprights. In addition to at least one horizontal bracing member 90 extending between the plurality of uprights 88 of each of the prefabricated brace frames 86a,b, at least one diagonal bracing member 92 can be connected to the uprights to provide additional stability to the prefabricated braced frame. The bracing members 90, 92 extending between the plurality of uprights 88 are designed to work in tension and compression similar to a truss. The bracing between the plurality of uprights can be designed in different patterns including cross-bracing, K-bracing, V-bracing and/or eccentric bracing. Cross-bracing, also known as X-bracing, is made of two diagonal bracing members crossing each other. The bracing members in K bracing are arranged to form a K shape between the plurality of uprights. In the particular embodiment of the present invention shown in FIG. 13B, the pattern of the bracing members 90, 92 connecting the plurality of uprights 88 of each of the prefabricated braced frames 86a,b shown in FIG. 16 adopts a K bracing pattern providing an A frame. To provide an A shaped frame, each of the plurality of prefabricated frames 86a,b comprises two sets of diagonal bracing members 92; a first set of diagonal bracing members 92 in an upper portion of the prefabricated frame and a second set of diagonal bracing members 92 in a lower portion of the prefabricated frame. The set of diagonal bracing members 92 in the lower portion of the prefabricated frame extends from the horizontal bracing member towards the middle region of the prefabricated frame to the lowermost portion of the prefabricated frame to form legs 94 for mounting the prefabricated frame to the floor. The bracing members 90, 92 are fixedly connected to the uprights 88 by fasteners commonly known in the art. These include but are not limited to welding, bolts, rivets, or a combination thereof. Various lightweight materials can be used in the prefabrication of the frames. These include but are not limited to metal, plastic, or a fiber-reinforced composite material. As the grid framework structure is primarily used to store grocery items, the metal type used in the fabrication of the tote guide should be sufficiently corrosion resistant. Examples of metals include but is not limited to stainless steel or galvanized steel. The plurality of uprights and/or the bracing members can be formed by folding a sheet metal blank at one or more fold lines, e.g. metal stamping. To further increase the structural integrity of the prefabricated frames, one or more inserts can be used to reinforce the vertical members 88 and/or horizontal bracing members 90 and/or diagonal bracing members 92. For example, in the case of the C-shaped cross-sectional profile of the horizontal bracing member, an insert (not shown) can be placed inside the C-shaped profile such that the C-shaped profile forms an envelope around the insert.

The plurality of the prefabricated frames 86a,b are arranged in a three-dimensional grid pattern as shown in FIG. 16 in the sense that the prefabricated frames comprises a first set of parallel prefabricated frames 86a and a second set of parallel prefabricated frames 86b. The first set of parallel prefabricated frames 86a extend in a first direction and the second set of parallel prefabricated frames 86b extend in a second direction, the second direction being substantially perpendicular to the first direction such that the plurality of the prefabricated frames are arranged in a grid pattern comprising a plurality of modular storage cells or spaces 96. The first and second directions can represent X and Y axes of a Cartesian coordinate system. Each of the plurality of prefabricated frames 86a,b are sized such that each of the modular storage cells 96 is sized to store a plurality of stacks of storage containers commonly known as storage bins. Connection of adjacent prefabricated frames 86a, 86b in the supporting framework structure 82 involves connecting one of the plurality of uprights 88 of a prefabricated frame 86a extending in the first direction to one of the plurality of uprights 88 of an adjacent prefabricated frame 86b extending in the second direction as demonstrated in FIG. 18. Various fasteners or fixtures known in the art can be used to connect adjacent prefabricated frames together. These include but are not limited to bolts, riveting, welding or even the use of a suitable adhesive.

To guide one or more robotic load handling devices on the supporting framework structure 82, the track system 84 is mounted to the supporting framework structure 82 such that the track system 84 extends across the plurality of modular storage cells 96 created by the plurality of prefabricated frames 86a,b. The track system 84 comprises a plurality of tracks arranged in a grid pattern comprising a plurality of grid cells (see FIG. 27). More specifically, a first set of parallel tracks 122a extending in the first direction and a second set of parallel tracks 122b extending in the second direction, the second direction being substantially perpendicular to the first direction to adopt a grid like pattern (see FIGS. 27 and 29). As each of the plurality of modular storage cells 96 of the supporting framework structure 82 is sized to accommodate a plurality of stack of storage containers, each modular storage cell 96 of the supporting framework structure 82 is sized to accommodate a sub-group of two or more grid cells of the track system 84.

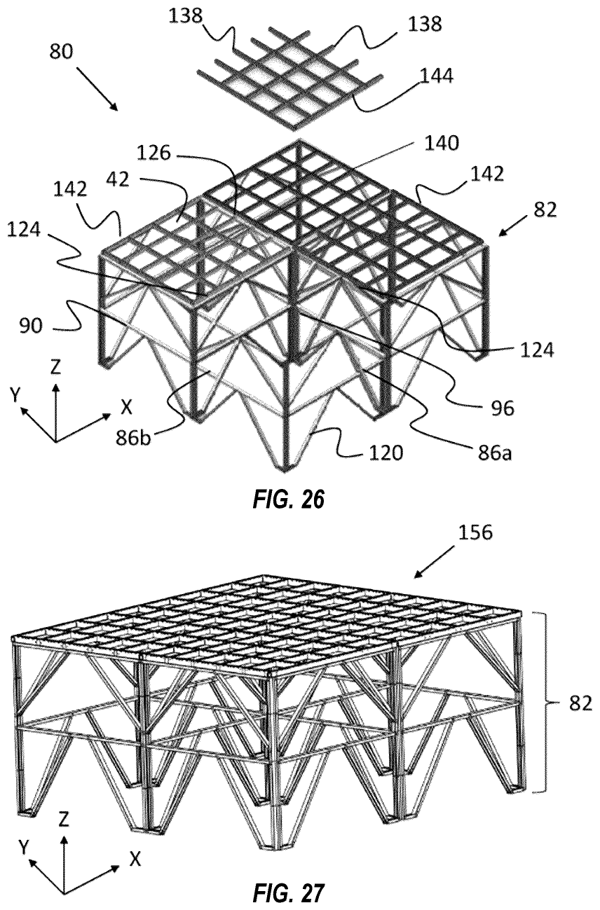

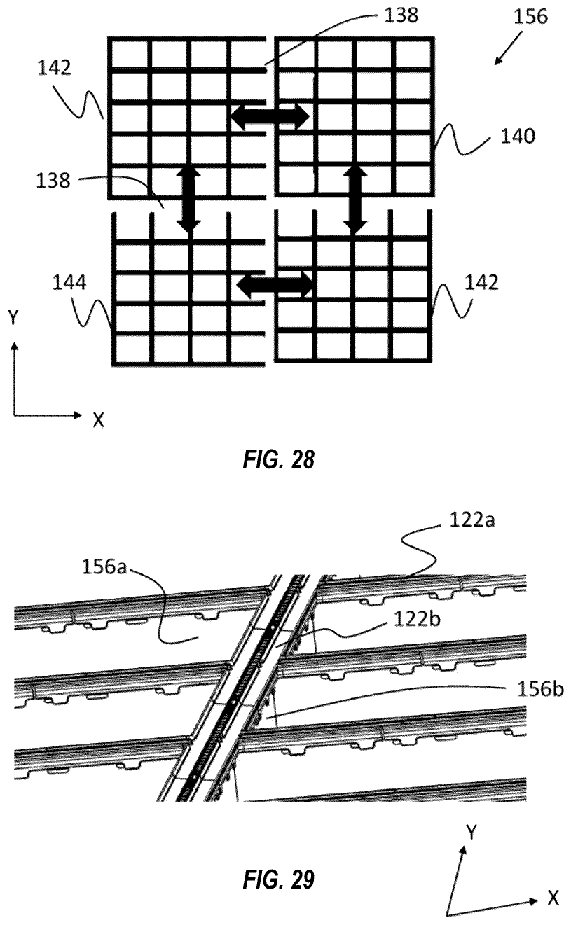

The plurality of modular storage cells 96 of the supporting framework structure 82 shown in FIG. 16 generates multiple storage spaces for the storage of a plurality of stacks of storage containers within each of the storage spaces of the supporting framework structure, i.e. an open storage space for the storage of a plurality of stacks of storage containers. In the particular embodiment of the present invention showing a top plan view of the grid framework structure in FIGS. 26 and 28, each of the plurality of the modular storage cells 96 of the supporting framework structure 82 is sized to accommodate twenty grid cells 42 of the track system 84, i.e. a grid pattern of 5 by 4 grid cells. Thus, each of the modular storage cells 96 of the supporting framework structure 82 provides a storage space for the storage of twenty stacks of storage containers. The size of each of the plurality of modular storage cells is not limited to accommodating twenty grid cells of the track system and can be a plurality of grid cells of the track system, i.e. each modular storage cell 96 can accommodate a grid pattern of X by Y grid cell, where X and Y can be any number 2 or greater. In other words, the ratio of the number of grid cells 42 of the track system 84 per modular storage cell 96 of the supporting framework structure 82 is X:1, where X is any integer greater than one, i.e. each of the plurality of modular storage cells 96 of the supporting framework structure 82 is sized to support a subset of the plurality of grid cells 42 of the track system 84, said subset comprising two or more grid cells 42 of the track system 84.

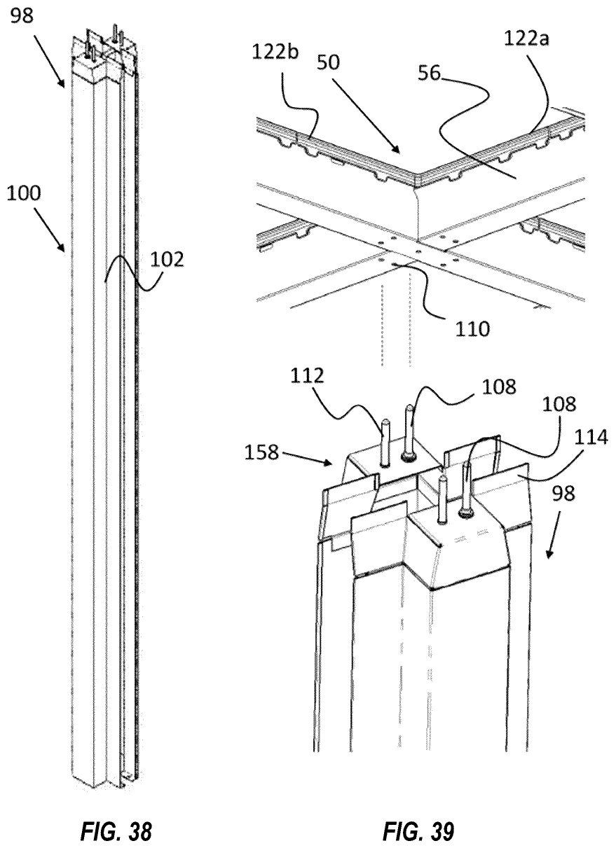

To guide one or more storage containers as it is lifted by a robotic load handling device operable on the track system 84 from one or more stacks of storage containers stored in the modular storage cells 96 of the supporting framework structure 82 through a respective grid cell 42 of the track system 84, the grid framework structure 80 further comprises a plurality of tote guides 98. To engage each corner of the storage container as it is guided towards a given grid cell 42, each tote guide 98 of the plurality of tote guides comprises two perpendicular bin guiding plates extending between the track system and the floor (see FIG. 38). The two perpendicular bin guiding plates are configured to accommodate a corner section of a grabber device and/or storage container. To guide a storage container through a grid cell as it is lifted by a robotic load handling device operable on the track, the totes guides extend between a node, where the plurality of tracks intersect in the track system, and the floor (see FIGS. 13A and 39).

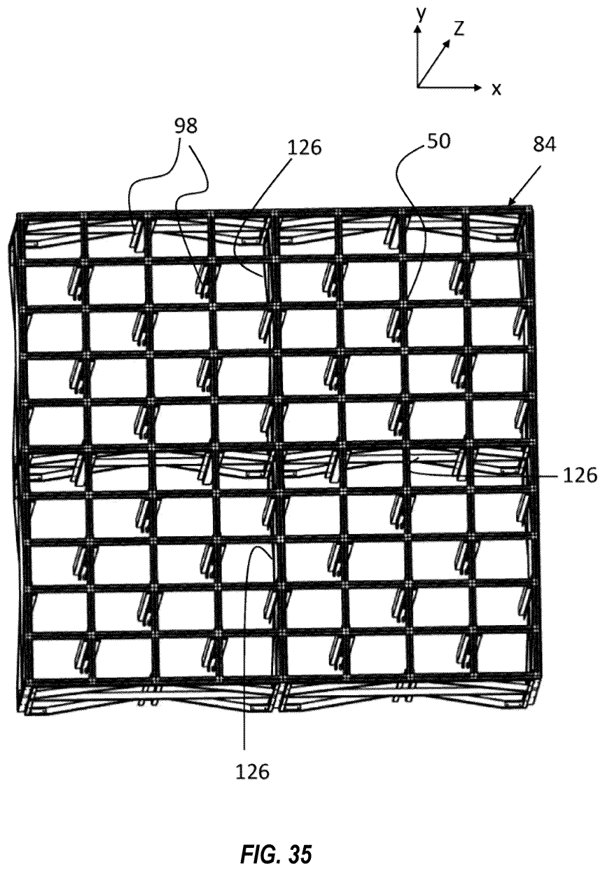

The plurality of tote guides 98 extend from one or more nodes where the plurality of tracks intersect in the track system to the floor such that the storage containers are guided along the tote guides and through a grid cell of the track system. The plurality of the tote guides are arranged in each of the modular storage cells of the supporting framework structure to form a plurality of storage columns for the storage of a plurality of stacks of storage containers within each of the plurality of the modular storage cells. Typically, the plurality of tote guides are arranged so that all four corners of a given storage container is guided through a grid cell, i.e. each storage column comprises four tote guides for engaging with the four corners of a given storage container in a stack as shown in FIG. 7. It may be not necessary to engage or accommodate all four corners of a storage container along the tote guides to provide lateral stability to the storage containers as they are hoisted towards the track system by the lifting mechanism of the load handling device. In the particular embodiment of the present invention shown in FIG. 35, the plurality of totes guides 98 are arranged to engage with only a pair of diagonally opposing corners of the grabber device and/or the containers, i.e. the grabber device and/or the containers are guided by engaging with the tote guides at their diagonally opposing corners. This gives the grabber device and the containers a level of lateral stability in the X and Y directions as the container is hoisted along diagonally opposed guides, each of the diagonally opposed guides accommodating diagonally opposed corners of the storage containers. Thus, in comparison to having tote guides at all of the nodes of the grid structure, in the particular embodiment of the present invention shown in FIG. 35, the plurality of tote guides 98 are arranged at alternate nodes in the first direction (e.g. X direction) and in the second direction (e.g. Y direction) such that the one or more containers are stacked between only two tote guides and are guided by the two tote guides, i.e. a first set of tote guides 98 arranged at alternate nodes in the first direction (e.g. X direction) and a second set of tote guides 98 arranged at alternate nodes in the second direction (e.g. Y direction) such that the one or more containers are stacked between only two tote guides and are guided by the two tote guides. By having tote guides at alternative nodes or intersections, half of the number of tote guides will be needed to guide the grabber device and/or storage container through a grid cell. Additionally, the grabber device and the storage container is only accommodated at two of its corners as it is hoisted towards a grid cell. The spatial arrangement of the tote guides 98 for guiding each of the storage containers towards the grid structure at only their diagonally opposed corners of the storage containers is shown in FIG. 35. The reduced number of tote guides necessary to guide the storage containers through a grid cell contributes to the reduction of the number of components necessary to erect the supporting framework structure according to the present invention.

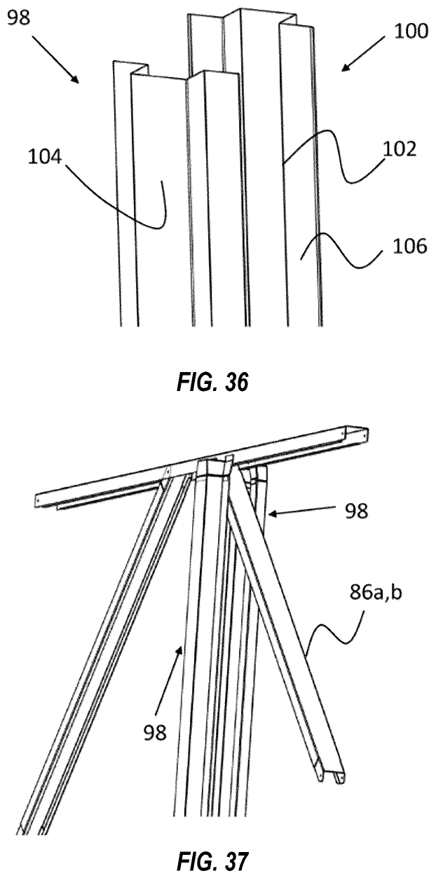

In comparison to the conventional stick built approach of the grid framework structure where the tote guides are incorporated into the vertical uprights which are largely load bearing for supporting the track system and one or more robotic load handling devices operable on the track system, the tote guides do not necessarily need to be load bearing. This is because the weight of the track system and one or more robotic load handling devices operable on the track system is supported by the prefabricated frames 86a,b arranged to form the supporting framework structure 82 discussed above. As a result, the tote guides 98 can be fabricated from lower cost materials and/or processes. In the particular embodiment of the present invention, each of the plurality of tote guides 98 is formed from a sheet metal blank 100 comprising parallel fold lines 102 extending along the longitudinal length of the sheet metal blank. The sheet metal blank is folded along the fold lines to form two substantially perpendicular bin guiding plates defining two tote guides. The folded sheet metal blank is shown in FIGS. 36 and 38 having a substantially rectangular cross-sectional center portion 104 and a flange or lip 106 projecting either side of the center portion 104 that cooperate with the walls of the center portion to define the two tote guides. Another way of describing the forming process of the tote guides is to form a substantially rectangular corrugation in the sheet metal blank. An example of a forming process in the manufacture of the tote guides from a folded sheet metal blank is cold rolling. Due to the length of the tote guides, one or more stiffeners can be incorporated onto the folded sheet metal blank to prevent excessive deflection of the perpendicular bin guiding plates when guiding a storage container as it is lifted towards a grid cell in the track system. The one or more stiffeners can comprise one or more ribs incorporated within the fabric of the sheet metal blank, more particularly, the perpendicular bin guiding plates. Other means to provide one or more stiffeners in the totes guides is to brace the substantially rectangular portion or rectangular corrugation 104 of the folded sheet metal blank.

Two separate folded sheet metal blanks 100 can be used to form four tote guides for guiding the corners of four adjacent storage containers. As shown in FIG. 36, two folded sheet metal blanks 100 are arranged directly opposite each other such that their respective rectangular cross-sectional center portions 104 face each other. Separately forming the tote guides 98 as a set of two tote guides also provides the benefit of accommodating a prefabricated frame that is shared between adjacent modular storage cells as shown in FIG. 37. In FIG. 37, a set of two tote guides 98 are shown either side of the prefabricated frame 86a,b such that the common prefabricated frame shared 86a,b between adjacent modular storage cells is sandwiched between the two sets of two tote guides. At the periphery of the supporting framework structure only two guides are necessary at each of the nodes where the track supports intersect.

Instead of the use of a cross shaped cap plate as discussed above in FIG. 10 to secure the tote guides 98 to the nodes of the track system, in accordance with an embodiment of the present invention as shown in FIG. 39, the tote guides 98 are secured to the track support 56 at the nodes of the track system 84 by a cap 158 mounted to the uppermost portion of the tote guide 98 and comprising one or more bolts and/or pins 108 as shown in FIG. 39. In the particular embodiment of the present invention shown in FIG. 39, the cap 158 comprises at least one locating pin 108 that is received within an opening 110 in the underside of the track support where the track support 56 intersect at the nodes in the track system 84. The cap 158 is optionally secured to the uppermost portion of the folded sheet metal blank of the tote guide by a snap fit or optionally welded to the uppermost portion of the folded sheet metal blank. Like the tote guides, the cap 158 can optionally be formed from a folded sheet metal blank along a plurality of fold lines. The lowermost portion of the tote guide 98 is secured to the floor by one or more anchoring bolts (not shown). The tote guides are secured within the modular storage cells by tensioning the tote guides between the floor and the track system. The cap can optionally comprise a tension bolt 112 for tensioning the tote guide between the track system and the floor. As shown in FIG. 39, the tension bolt is receivable within an opening 110 where the track support intersect at the nodes in the track system. A nut is used to tension the tote guide between the track system and the floor. The cap 158 additionally comprises guide members 114 that cooperate with the tote guides for preventing the grabber device or a storage container from fouling the area where the track supports intersect at the nodes in the track system as shown in FIG. 39. The guide members 114 is configured to cooperate with the track support 56 to provide a guide surface for guiding a tote through a grid cell of the track system.

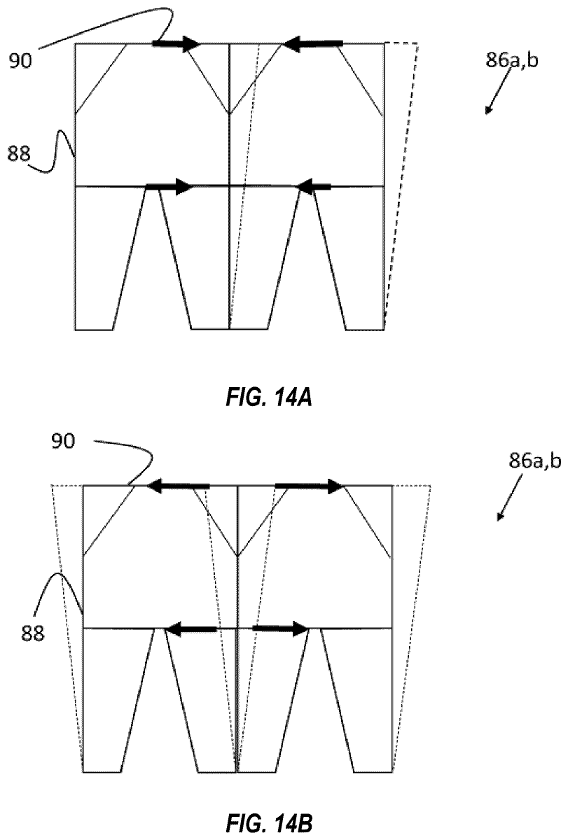

Whilst arranging the prefabricated frames in a three-dimensional grid pattern to form a supporting framework structure provides structural integrity to support a track system for one or more robotic load handling devices operable on the supporting framework structure, direct contact of adjacent prefabricated frames in the supporting framework structure does not take into account thermal expansion of the prefabricated frames. In this case, the uprights or vertical members 88 of adjacent prefabricated frames in the supporting framework structure are directly connected together, e.g. by one or more fasteners, at the interface between adjacent modular storage cells such that the uprights or vertical members butt up against each other. Where the prefabricated frames are firmly secured to the floor and are directly connected to each other in the supporting framework structure, forces as a result of thermal expansion in one or more structural components of one prefabricated frame is transferred to an adjacent or neighboring prefabricated frame in the supporting framework structure. Thermal expansion in each of the prefabricated panels is largely concentrated along the horizontal bracing members or drag struts between the vertical uprights. Expansion of the horizontal bracing members 90 results in forces being generated in a horizontal direction and can be demonstrated by the arrows in the drawings of a section of the supporting framework structure shown in FIGS. 14A-14B.

FIG. 14A is an example of expansion of the horizontal bracing members 90 shown by the arrows of adjacent prefabricated frames at elevated temperatures and FIG. 14B is an example of the effects of contraction of the horizontal bracing members 90 between the vertical uprights 88 as a result of lower temperatures. If the prefabricated frames are in direct contact, forces as a result of expansion and/or contraction of the horizontal bracing members 90 in one prefabricated frame are transferred to the vertical uprights 88 of a neighboring prefabricated frame. In both examples shown in FIGS. 14A-14B, the cumulative effect of the expansion and/or contraction of the horizontal bracing members 90 results in distortion of the prefabricated frames as shown by the dashed lines. As the track system is secured to the supporting framework structure, distortion of the prefabricated frames may result in distortion of at least a portion of the track system, in particular the dimensions of one or more grid cells of the track system. As the robotic load handling devices are operable on the track system, distortion of at least a portion of the track system may cause one or more robotic load handling devices operable on the track system to derail and in a worst case scenario topple on the track system.

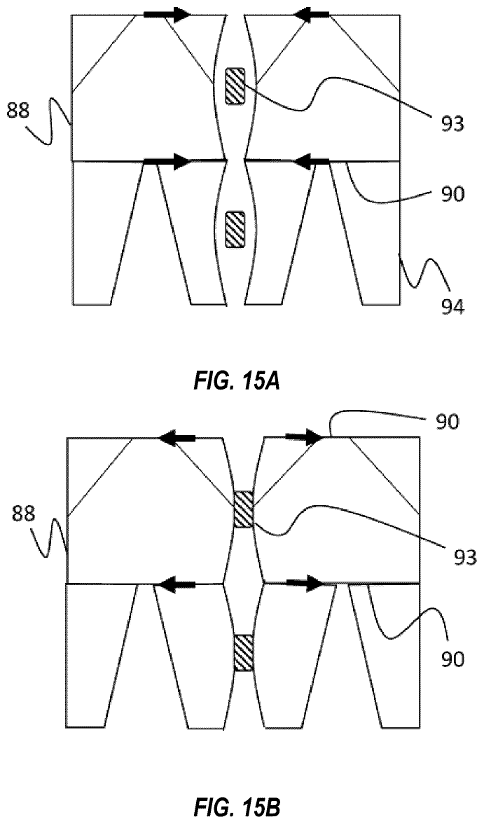

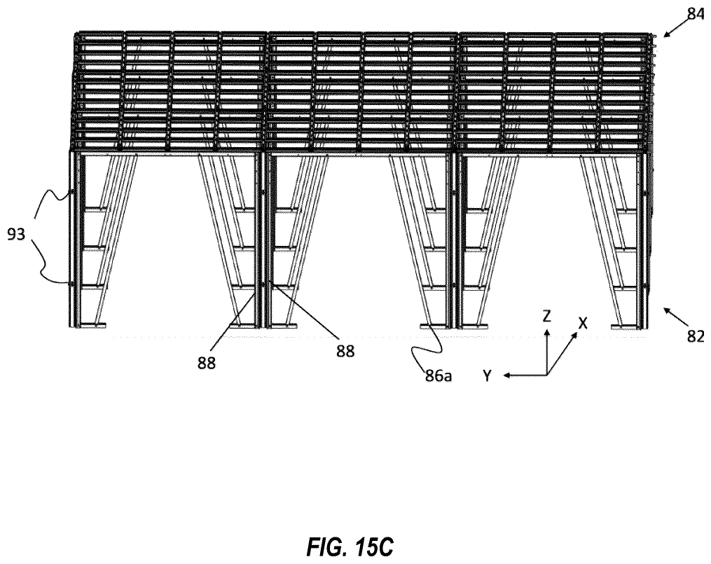

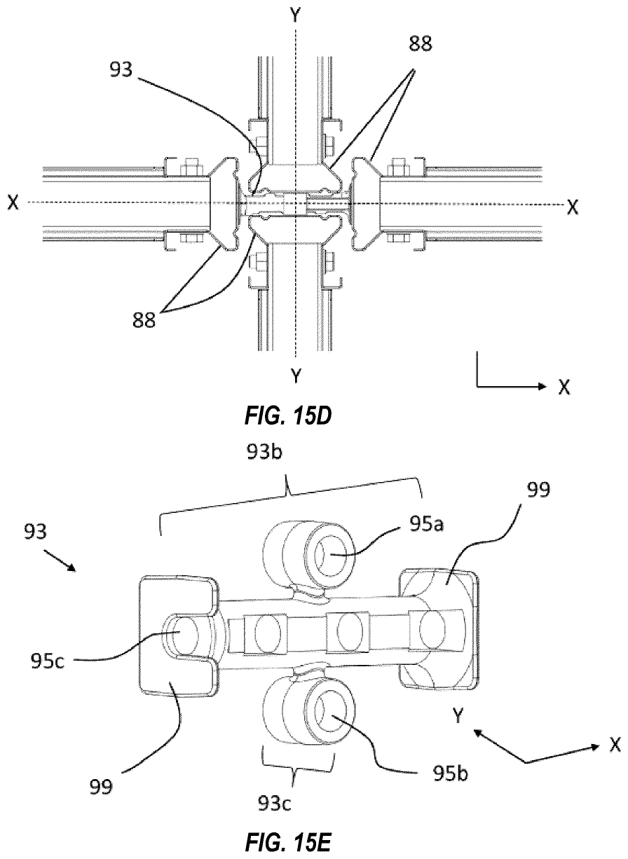

To mitigate the effects of thermal expansion in one prefabricated frame impacting a neighboring prefabricated frame in the supporting framework structure causing distortion to the geometry of the supporting framework structure, the vertical uprights 88 of adjacent prefabricated frames 86a,b connected in the first direction and/or the second direction are spaced apart. The spacing between the connecting vertical uprights of adjacent prefabricated frames is such as to intentionally cause elastic deformation of the vertical uprights of adjacent prefabricated frames as a result of thermal expansion mitigating the transfer of forces to neighboring prefabricated frames in the supporting framework structure. This can be demonstrated by the drawing shown in FIGS. 15A-15B, where FIG. 15A is example of expansion of the horizontal bracing members shown by the arrows of adjacent prefabricated frames at elevated temperatures and FIG. 15B is an example of the effects of contraction of the horizontal bracing members between the vertical uprights at lower temperatures. In comparison to FIG. 14A, the spacing between adjacent prefabricated frames, in particular between adjacent vertical uprights, allows the connecting vertical uprights of adjacent prefabricated frames to intentionally elastically deform in the space available between adjacent prefabricated frames as shown in FIG. 15A limiting the transfer of forces to neighboring prefabricated frames. This has the effect of diluting or absorbing the transfer of forces between neighboring prefabricated frames. In other words, forces as a result of thermal expansion of the horizontal bracing members 90 between the vertical uprights in one prefabricated frame are absorbed by the distortion of the vertical uprights rather than being transferred to neighboring prefabricated frames.

The pattern of distortion of the vertical uprights is dependent on the distribution of the spacing between adjacent horizontal bracing members of adjacent prefabricated frames. This is because forces between adjacent prefabricated frames as a result of thermal expansion are largely concentrated in the region of the horizontal bracing members of adjacent prefabricated frames. Thus, the spacing between adjacent horizontal bracing members between adjacent prefabricated frames reduces as the horizontal bracing members thermally expand as shown in FIG. 15A. In some cases, the distal ends of the horizontal bracing members of adjacent prefabricated frames butt up as a result of thermal expansion which is relieved by the distortion of the vertical uprights between the horizontal bracing members. Depending on the orientation of the prefabricated frames in the supporting framework structure, forces as a result of thermal expansion of the horizontal bracing members largely occur along the first, X, direction and/or the second, Y, direction. Since the vertical uprights of adjacent prefabricated frames are spatially distributed, distortion of the vertical uprights of adjacent prefabricated frames has the effect of distributing the thermal expansion forces amongst multiple prefabricated frames.

A similar effect of absorption of the thermal expansion of the horizontal bracing members between the vertical uprights by the distortion of the vertical uprights applies to the contraction of the horizontal bracings members in one or more prefabricated frames at lower temperatures (e.g. chilled or frozen temperatures) as shown in FIG. 15B. In this case, contraction of the horizontal bracing members 90 pulls on the connection points with the vertical uprights 88 causing the vertical uprights to elastically distort as shown in FIG. 15B. As the vertical uprights of adjacent prefabricated frames connected in the first direction and/or in the second direction are spaced apart, distortion of the vertical uprights is accommodated by the spacing between adjacent vertical uprights of adjacent prefabricated frames. The spacing between adjacent vertical uprights of adjacent prefabricated frames is sufficient to allow one or both adjacent vertical uprights to elastically deform rather than plastically deform. To elastically deform the vertical uprights of adjacent prefabricated frames, the spacing between adjacent vertical uprights of adjacent prefabricated frames can in the range between 5 mm to 120 mm, preferably, between 10 mm to 120 mm. In all cases, the spacing between adjacent vertical uprights of adjacent prefabricated frames is such that thermal expansion forces between neighboring prefabricated frames are much more diluted or absorbed rather than being transferred to neighboring prefabricated frames.

Various spacers 93 can be used to space adjacent prefabricated frames in the supporting framework structure, these include but not limited to the use of washers having different degrees of thickness to control the elastic deformation as shown in FIG. 15A-15B. The spacing between adjacent vertical uprights of adjacent prefabricated frames can be controlled by the width of the spacers 93 between the adjacent vertical uprights. The spacers 93 can be permanently installed between the adjacent vertical uprights or alternatively, used to space adjacent vertical uprights of adjacent prefabricated frames and then subsequently removed to leave a gap between the adjacent vertical uprights.

The distribution of a plurality of spacers 93 between the connected vertical uprights 88 at the interface between adjacent prefabricated frames in the supporting framework structure is shown in FIG. 15C. In the particular embodiment of the present invention, the spacer 93 shown in FIGS. 15D-15E comprises a first spacing member or portion 93b extending in the first direction along the axis X-X and a second spacing member or portion 93c extending in the second direction along the axis, Y-Y, the first spacing member 93b is shown longer than the second spacing member 93c. As the result of the different spacing lengths of a given spacer 93, the spacing of the vertical uprights 88 at the interface between adjacent prefabricated frames extending in the first direction is different to the spacing of the vertical uprights at the interface between adjacent prefabricated frames extending in the second direction. This is clearly shown by the connection of the vertical uprights 88 of four separate adjacent prefabricated frames in the supporting framework structure in FIG. 15D.

Of course, the number of connecting vertical uprights will be different depending on the position of the vertical uprights in the supporting framework structure. For example, there will be three connecting vertical uprights from three adjacent prefabricated frames at the edge of the supporting framework structure and two connecting vertical uprights at the corners of the supporting framework structure. The drawing shown in FIG. 15D is a top view of the vertical uprights connected within the interior of the supporting framework structure having four connecting vertical uprights. The first spacing member 93b spaces the connecting vertical uprights a space X in the first direction and the second spacing member spaces the connecting vertical uprights a space Y in the second direction.

In the particular embodiment of the present invention, the first spacing member spaces the connecting vertical uprights a distance in the region 50 mm to 120 mm in the first direction and the second spacing member spaces the connecting vertical uprights a distance in the region 10 mm to 30 mm in the second direction. The difference in spacing lengths is attributable to the arrangement of the connecting vertical uprights in the supporting framework structure and the prevention of any portion of the vertical uprights protruding into the grid cell of the track system. The shorter spacing member, i.e. second spacing member 93c, connects the vertical uprights closer together in the second direction in comparison to the vertical uprights connected in the first direction and therefore, mitigates any portion of the vertical uprights, particularly those connected in the second direction from protruding into a storage column or grid cell. The difference in spacing between the vertical uprights connected in the first direction and in the second direction can also control the deflection of the vertical uprights in the first direction and those connected in the second direction, wherein greater deflection of the connected vertical uprights can occur in the first direction than the vertical uprights connected in the second direction. However, the present invention is not limited to the spacing of the vertical uprights connected in the first direction being different to the vertical uprights connected in the second direction and can be of substantially equal lengths in both the first and second directions and largely depends on the cross-sectional profile of the vertical uprights.

To install the spacer 93 between the vertical uprights 88, the spacer 93 comprises one or more openings 95a, 95b, 95c extending in the first direction and in the second direction for receiving one or more bolts. In the particular embodiment of the present invention shown in FIG. 15E, the spacer 93 is formed as a single, unitary body having the first spacer member or portion 93b extending in the first direction and the second spacer member or portion 93c extending in the second direction. The spacer 93 can be formed by molding, casting or by additive manufacturing (3D printing) and formed from various rigid materials including but not limited to metal, plastics or ceramic. In the particular embodiment of the present invention, the spacer 93 is formed by casting and in the case, where the grid framework structure is used to store food products, the spacer is casted from a food safe material, e.g. stainless steel. The use of stainless steel to cast the spacer is to ensure that the spacer does not contaminate food products in storage. However, the problem with the use of stainless steel to cast the spacer is the cost to cast the spacer due to the intricate detail of the spacer and the need to ensure the consistency in the dimensional tolerance of the spacer in the first direction and in the second direction, and from one connection to another connection across the supporting framework structure. In the particular embodiment of the present invention, the spacer 93 is casted using a lost wax process or a similar process, e.g. water glass casting process. Forming the spacer as a single, unitary body improves the efficiency and thus, contributes to the lower cost of assembly of the grid framework structure according to the present invention.

Also shown in FIG. 15E are flanges 99 at the distal ends of the first spacer member extending in the first direction. The flanges 99 are shaped to butt up against the exterior surface of the vertical uprights 88 when positioned between adjacent vertical uprights (see FIG. 15D). An opening 95c extends through the first spacer member 93b and through the flanges 99. When installed between the vertical uprights, a bolt extends through a wall of the vertical uprights in the direction along the axis X-X as shown in FIG. 15D by being received within the opening in the spacer. Tightening the bolt compresses the vertical upright against the flange forming a secure connection between the vertical uprights and the spacer. The cross-sectional profile of the vertical upright connected to the spacer also allows deflection of the vertical upright relative to the spacer. In contrast to the first spacer member 93b, the second spacer member 93c comprises two openings 95a, 95b for receiving two bolts; a first opening 95a above the first spacer member and a second opening 95b below the first spacer member. The second spacer member butts up against the external face of the vertical uprights connected in the second direction and connected via the openings 89 in the vertical upright (see FIG. 13C).

The position of the spacers 93 between adjacent vertical uprights 88 of adjacent prefabricated frames may also control the degree of deformation of the vertical uprights 88. As expansion largely occurs along the horizontal bracing members, one or more spacers are positioned between the horizontal bracing members to effect distortion of the vertical uprights 88. As shown in FIG. 15C, a plurality of the spacers 93 are distributed at regular intervals in the longitudinal direction along the vertical uprights to provide a controlled deflection of the vertical uprights during movement of the prefabricated frames as a result of thermal expansion. In both options, it is essential that a space exists between adjacent vertical uprights of neighboring prefabricated frames so as allow elastic deformation of one or more of the vertical uprights without severely distorting the overall shape of the supporting framework structure.

To introduce spacing between adjacent vertical uprights of adjacent prefabricated frames in the supporting framework structure, in the particular embodiment of the present invention, the supporting framework structure is sub-divided into a plurality of modular units or blocks, where each of the plurality of modular units or blocks can function as a standalone unit that are spaced apart so as to enable the modular units to move independently of each other in the support framework structure. Each of the plurality of modular units represents a single modular storage cell when the modular units are assembled together. Sub-dividing the supporting framework structure into a plurality of modular units not only allows ease of build of the supporting framework structure but also provides the flexibility to space one or more adjacent vertical uprights of adjacent prefabricated frames to absorb the effects of thermal expansion discussed above. To space adjacent vertical uprights in the supporting framework structure, the plurality of prefabricated frames are arranged in a grid pattern comprising the plurality of modular storage cells so that adjacent modular storage cells share a common prefabricated frame 126. This can be demonstrated by the isometric view of the plurality of modular units to form four modular storage cells 96 shown in FIGS. 16 and 35 and a top plan view of the arrangement of the prefabricated frames forming separate modular units shown in FIG. 17.

As the geometrical shape of each of the modular storage cells in the supporting framework structure 82 is rectilinear, to provide a supporting framework structure where each of the modular units shares a common prefabricated frame 126 between adjacent modular storage cells, three types of modular units are used that are configured to interface with each other. The three types of modular units are shown in FIGS. 19 to 27, Each of the three types of modular units has a respective interface portion 124 enabling the modular unit to interface with an adjacent modular unit in either the first direction and/or the second direction in the supporting framework structure so that adjacent modular storage cells share a common prefabricated frame between them. To interface the three modular units together to form a plurality of modular storage cells that are closed sharing a common prefabricated frame between adjacent modular storage cells, one of the three modular units is a closed sided modular unit and the other two modular units are open sided modular units having an open side along at least one side of the modular unit. The at least one open side of the open sided modular unit is closed by interfacing with a side of an adjacent modular unit in the supporting framework structure. For the purpose of definition of the present invention, the three different types of modular units will be termed a first type modular unit 116, a second type modular unit 118 and a third type modular unit 120. The second and third type modular units 118, 120 are open sided modular units having at least one open side that is configured to interface with one or more sides of adjacent modular units in the supporting framework. As the sides of each modular unit is formed from prefabricated frames, adjacent modular units share a common prefabricated frame.

To assemble a supporting framework structure where the first, second and third type modular units 116, 118, 120 share a common prefabricated frame 126 between adjacent modular storage cells as shown in FIG. 17, the first type modular unit 116 comprises four prefabricated frames arranged in a rectilinear shaped structure forming a closed modular unit, the second type modular unit 118 comprises three prefabricated frames arranged in a substantially U shaped structure forming an open modular unit along one side of the modular unit and the third type modular unit 120 comprises two prefabricated frames arranged in a substantially L shaped structure forming an open sided modular unit along two sides of the modular unit. The assembly of the first, second and third type modular units 116, 118, 120 form at least four modular storage cells that are closed sharing a common prefabricated frame 126 between adjacent modular storage cells are shown in FIGS. 16 and 17. Also shown in FIG. 17, in exaggerated form, is that adjacent modular units 116, 118, 120 are deliberately spaced apart between the adjacent modular units such that each of the modular units behave as standalone modular units that can move independently relative to each other in the supporting framework structure to accommodate for thermal expansion in their respective modular units. The spacing between adjacent modular units accommodates for elastic deformation of adjacent vertical uprights 88 as a result of thermal expansion and is largely relieved by adjacent vertical uprights of adjacent prefabricated frames in the supporting framework structure. To provide enough spacing to elastically deform one of the adjacent vertical uprights, the spacing between the adjacent vertical uprights is in the range 50 mm to 120 mm in the first direction and 10 mm to 30 mm in the second direction. The modular units making up four modular storage cells shown in FIG. 17 is assembled from a single first type modular unit 116, two second type modular units 118 and a single third type modular unit 120. The first type modular unit 116 is shown interfaces with two second type modular units 118 in the X direction and in the Y direction respectively. The single third type modular unit 120 interfaces with the two second type modular units 118 in both the X direction and in the Y direction.

FIGS. 18 to 27 are schematic drawings illustrating the assembly process of the grid framework structure according to an example of the present invention so that adjacent modular storage cells share a common prefabricated frame. The prefabricated panels are typically presented as a flat pack that can be easily transported to a location of the build. The location can be a warehouse or an existing building. The build involves constructing the supporting framework structure in stages from the plurality of prefabricated frames as demonstrated in FIGS. 18 to 27. Assembly of the supporting framework structure begins with constructing the first modular unit 116 from four prefabricated panels 86a, 86b. For the purpose of explanation, the four prefabricated frames of the first modular unit 116 will be termed first 128a, second 128b, third 128c and fourth 128d prefabricated frames. One or more 90° angle brackets (or stands) 130 can be used to ensure that the first prefabricated frame 128a lies in a substantially vertical plane before securing the second prefabricated frame 128b to the first prefabricated frame 128a such that the second prefabricated frame 128b is substantially perpendicular to the first prefabricated frame (lies in a different vertical plane), i.e. the first prefabricated frame 128a extends in the X direction and the second prefabricated frame 128b extends in the Y direction. The 90° angle bracket functions as a stand to ensure that the first prefabricated frame 128a remains substantially vertical when the second prefabricated frame 128b is secured to the first prefabricated frame via their respective adjacent vertical uprights. The 90° angle bracket 130 shown in FIG. 18 is in the form of a right angled frame. Two 90° angle brackets 130 are secured to the vertical uprights of the first prefabricated frame 128a. Securing the first prefabricated frame to the second prefabricated frame involves securing their respective vertical uprights together by fasteners known in the art. Various fasteners can be used to secure the first prefabricated frame to the second prefabricated frame. These include but are not limited to various bolts, screws, rivets etc. Other securing methods include the use of adhesives or welding. A spacer 93 described above can be used to ensure that the first prefabricated frame 128a is spaced apart from the second prefabricated frame 128b in the first direction and in the second direction to accommodate thermal expansion of their respective horizontal bracing members. A plurality of spacers 93 can be spatially distributed between adjacent vertical uprights of adjacent prefabricated frames to control the deformation or distortion of at least one of the adjacent vertical uprights during thermal expansion. In the example shown in FIGS. 15A-15B, two spacers 93 are shown connected between the vertical uprights 88 so as to control the distortion or deflection of the vertical uprights of adjacent prefabricated frames. However, the present invention is not limited to two spacers between adjacent vertical uprights and can be a plurality of spacers between adjacent vertical uprights. Ideally, the spacers are positioned between the horizontal bracing members connecting the vertical uprights together in a given prefabricated frame such that distortion of the vertical uprights are concentrated in the region between the horizontal bracing members as shown in FIGS. 15A-15B.

In addition to securing or connecting the prefabricated frames to each other, each of the prefabricated frames is secured to the floor by one or more fasteners (not shown). To facilitate securing each of the plurality of prefabricated frames to the floor, each of the prefabricated frames is secured to the floor using one or more fasteners (e.g. anchoring bolts) via their respective legs 94 discussed above. The third 128c and fourth 128d prefabricated frames are subsequently secured to the first 128a and second 128b prefabricated frames to form a rectilinear or square shaped structure forming the first modular unit 128a as shown in FIG. 19. Also shown in FIG. 19 is that the legs 94 of adjacent prefabricated frames join to form a three-dimensional stable structure.

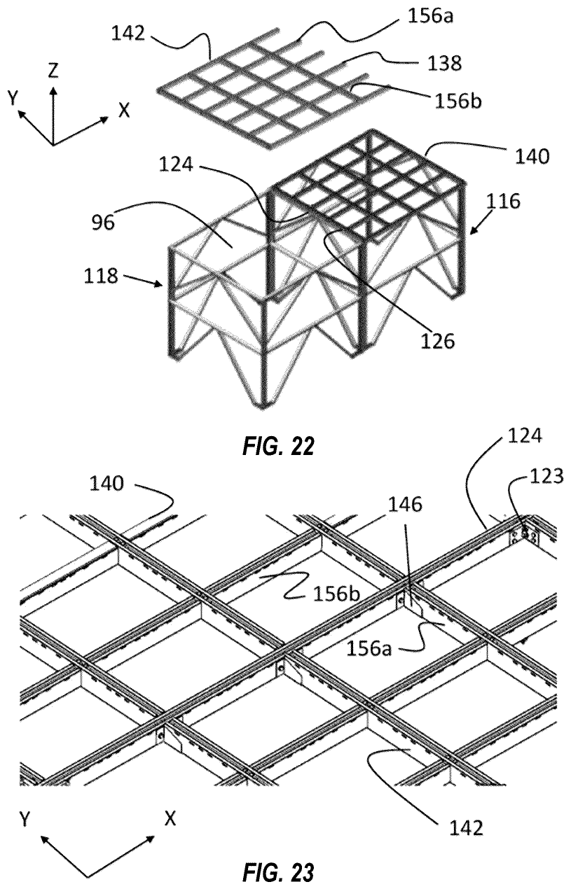

Each of the first, second, third and fourth prefabricated frames are anchored to the floor via their respective legs 94 by one or more fasteners, e.g. anchoring bolts to form a stable standalone structure. Once the first type modular unit 116 is secured to the ground, the second 118 and third 120 type modular units are subsequently assembled around the first type modular unit since the first type modular unit provides a stable structure to secure the prefabricated frames of the second 118 and third 120 type modular units to the first type modular unit 116. The first type modular unit 116 can function as the origin of the build and the other modular units, namely the second 118 and third 120 type modular units are subsequently assembled around the origin to extend the number of modular storage cells of the supporting framework structure in the X-direction and in the Y-direction. Thus, in building the grid framework structure according to an example of the present invention, the build of the supporting framework structure begins with assembling the origin before the other module units are assembled onto the origin. Like the first type modular unit, the second and third type modular units are assembled around the origin by separately fixing the prefabricated frames to the vertical uprights of the first type modular unit so as to extend the supporting framework structure in the X direction and the Y direction. For example and as shown in FIG. 22, the second type modular unit 118 is assembled onto the first type modular unit 116 by connecting three prefabricated frames in a substantially U shaped configuration to one side face of the first type modular unit 116 so as to form two modular storage cells sharing a common prefabricated frame 124 between the adjacent modular storage cells.

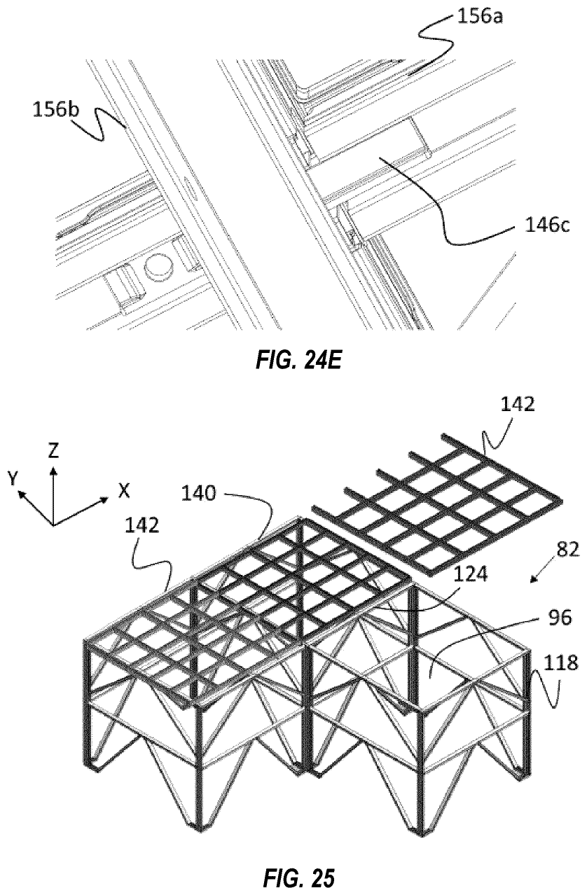

To create a supporting framework structure comprising three modular storage cells, a further second type modular unit 118 is assembled to another side face of the first type modular unit by connecting three prefabricated frames in a substantially U shaped configuration as shown in FIG. 25 to form a substantially L shaped supporting framework structure comprising three modular storage cells 96. To form a rectilinear shaped supporting framework structure 82 comprising four modular storage cells 96, the layout of the first and second type modular units is such that the resulting supporting framework structure is completed by connecting two prefabricated frames in an L shaped arrangement forming the third type modular unit 120 as shown in FIG. 26. In each of the builds, there is a set of parallel prefabricated frames 86a extending in a first direction (i.e. X direction) and a set of parallel prefabricated frames 86b extending in a second direction (i.e. Y direction) such that the first and second sets of prefabricated frames are arranged in a grid pattern comprising a plurality of modular storage cells 96. The interface 124 at each of the modular units is such that adjacent modular storage cells in the build share a common prefabricated frame 126 in the X-direction and in the Y-direction, i.e. the U shaped second type modular unit interfaces with a side of the first type modular unit and the L shaped third type modular unit interfaces with two sides of adjacent U shaped second type modular units in the build of the supporting framework structure. This process is repeated to expand the supporting framework structure with multiple modular storage units. By building the supporting framework structure from individual prefabricated frames starting from the first type ‘origin’ modular unit 116, the shape of the supporting framework structure 82, and thus the number of modular storage cells 96, can be made flexible and largely depends on the number of the second and third type modular units 118, 120 assembled onto the first type ‘origin’ modular unit 116. In all cases, the build begins with constructing the ‘origin’ to create a stable structure for mounting the second and third type modular units 118, 120. Once assembled, the modular units function as standalone units that can movement independently relative to each other due to the spacing between or of adjacent prefabricated frames. In all cases and to ensure there is room for deflection of the vertical uprights as a result of the effects of thermal expansion, assembly of the second and third type modular units 118, 120 to the first type modular unit 116 involves connecting their respective vertical uprights of adjacent prefabricated frames in the first direction and in the second direction using the spacers discussed above.

The supporting framework structure 82 is configured to support a track system 84 comprising a plurality of tracks 122a, 122b for guiding the movement of one or more robotic load handling device on the supporting framework structure. To support the plurality of tracks 122a, 122b for guiding the movement of one or more robotic load handling devices on the supporting framework structure, the track system 84 according to an embodiment of the present invention further comprises a track support structure 156 comprising track supports 156a, 156b extending in the first direction and in the second direction and the plurality of tracks 122a, 122b are configured to be mounted to the track support structure 156. In the particular embodiment of the present invention shown in FIGS. 29 to 34, the plurality of tracks 122a, 122b is sub-divided into a plurality of track sections 132, each track section 132 formed as single unitary body and comprising track elements or portions 134, 136 extending in the direction of the underlying track supports 156a, 156b so as to provide a track surface that extends in the first direction and in the second direction, i.e. each track section 132 having connecting portions or elements 134, 136 extending in transverse directions. For the purpose of explanation of the present invention, the connecting portions or track section elements 134, 136 can be termed ‘branches’ that extend in transverse directions from the nodes 50. Further detail of the assembly of the plurality of tracks to the track support structure is discussed below.

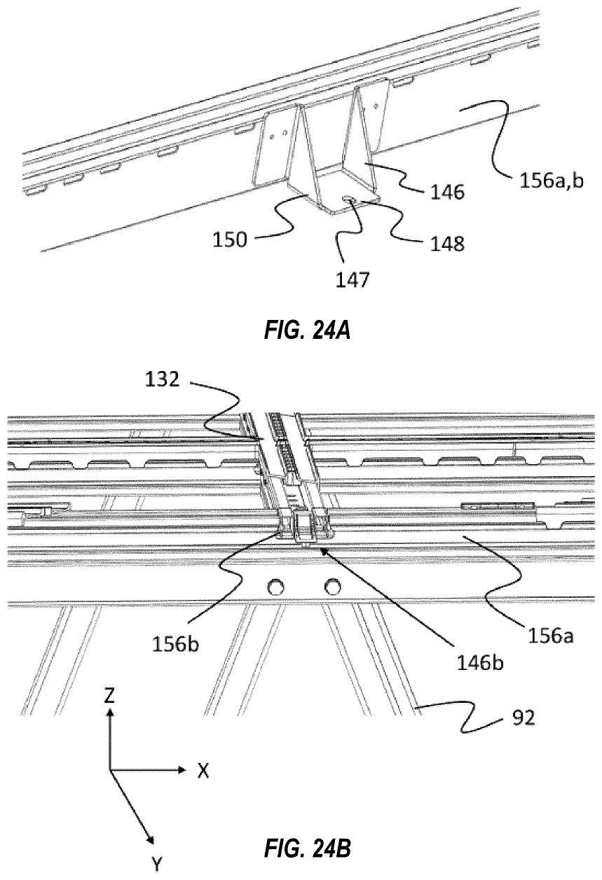

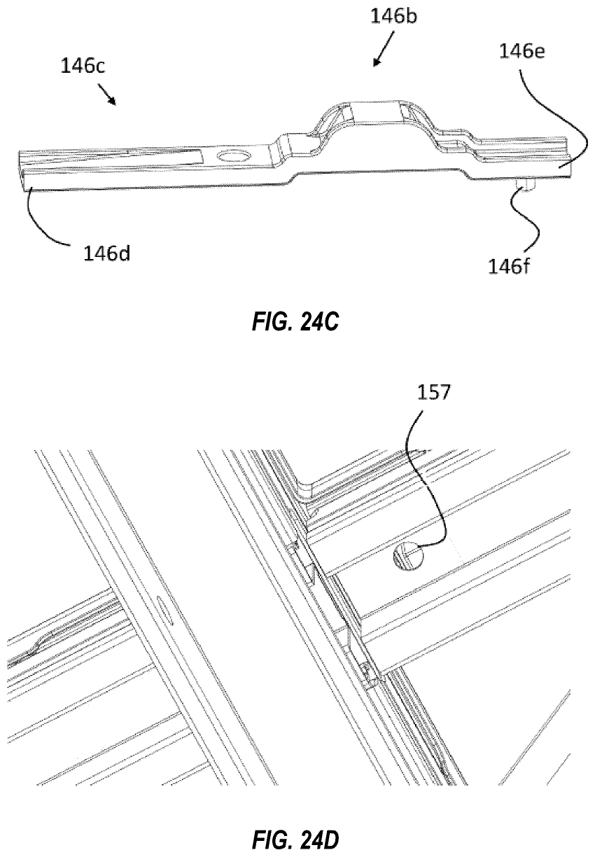

Various fasteners known in the art can be used to secure the track support structure 156 to the supporting framework structure 82. These include but are not limited to various screws, nuts and bolts, rivets etc. The track support structure 156 is secured to the horizontal bracing members 90 of one or more prefabricated frames 86a,b in the supporting framework structure. Without the provision to accommodate the movement of one or more of the modular units of the supporting framework structure as a result of thermal expansion, one or more regions of the track support structure 156 secured to the supporting framework structure may distort, which ultimately causes a distortion to the overall track system 84. In addition to distortion of the track system as a result of movement of one or more of the modular units relative to each other in the supporting framework structure, any one of the components of the track system itself may also thermally expand or contract relative to the supporting framework structure. For example, as the track support structure 156 is secured to the supporting framework structure 82, there could be a disparity in the thermal expansion between the supporting framework structure 82 and the track system 84. Moreover, the fixed interconnections of the plurality of track supports at the intersections of the track supports in the grid pattern limits movement of the track supports relative to each other, thereby amplifying distortion of the track support structure. For the purpose of definition of the present invention, the “fixed” interconnections at the intersections of the plurality of track supports is construed to mean no movement greater than 0.5 mm. Whilst provisions are made to mitigate thermal expansion of the prefabricated frames of the supporting framework structure by spacing adjacent prefabricated frames relative to each other as discussed above, further provisions would need to be made to accommodate thermal expansion in one or more areas of the track system 84. To accommodate the movement of one or more of the modular units 116, 118, 120 in the supporting framework structure 82, the track support structure 156 is also sub-divided into a plurality of discrete modular sub-frames, each of the plurality of modular sub-frames comprising at least a portion of the track support structure 156, i.e. sized to accommodate a sub-group of two or more grid cells of the track system. To enable individual modular sub-frames to move relative to each other along a substantially horizontal plane in the track system, the plurality of modular sub-frames are interconnected by one or more slip joints or movement joints 146 at the interface 124 between adjacent modular storage cells 96 (see FIGS. 24A-24E). Thus, adjacent modular sub-frames are moveable relative to each other along a substantially horizontal plane via the one or more of the slip joints in the X-direction (first direction) and in the Y-direction (second direction). The interconnections of the plurality of track supports at their intersections within a given modular sub-frame are fixedly connected together by one or more bolts but the interconnections of the track supports at the interface between adjacent modular storage cells comprise one or more movement joints to enable relative movement between adjacent modular sub-frames. Thus, during movement of the track support structure due to thermal expansion, movement occurs at the interface between adjacent modular sub-frames in comparison to the interconnections at the intersections of the track supports within the modular sub-frames which are rigidly connected together. For the purpose of definition of the present invention, movement between adjacent modular sub-frames is construed to mean movement in excess of 0.5 mm, i.e. in the region of 0.5 mm to 10 mm. The extent of movement of the modular sub-frames largely depends on the change in temperature of the track system. Typically, the prefabricated frames anchored to the floor by one or more anchor bolts such that the vertical members at the interface between adjacent modular storage cells are spaced apart. To cater for thermal expansion of the modular sub-frames, the one or more slip joints at the interface between adjacent modular sub-frames allows movement in the range 0.5 mm to 10 mm, preferably in the range 0.5 mm to 5 mm.

To allow different portions of the track support structure 156 to move independently relative to each other at the interface of adjacent modular storage cells of the supporting framework structure and since the track support structure 156 is directly secured to the supporting framework structure, the track support structure 156 is sub-divided in a similar pattern to the sub-divisions of the supporting framework structure 82. Like the modular units 116, 118, 120 of the supporting framework structure 82 discussed above, each of the plurality of modular sub-frames has an interface portion 138 that is configured to interface with an adjacent modular sub-frame in the track support structure such that adjacent modular sub-frames in the track support structure share a common side between adjacent modular sub-frames. As clearly shown in the schematic drawing of a top plan view of the track support structure in FIG. 28, the plurality of modular sub-frames comprises a first type modular sub-frame 140, a second type modular sub-frame 142 and a third type modular sub-frame 144 that adopt a similar interface pattern as the modular units 116, 118, 120 of the supporting framework structure 82, i.e. each of the first 140, second 142 and third 144 types modular sub-frames has a respective interface portion 138 that is configured to interface with each other. Each of the first 140, second 142 and third 144 type modular sub-frames are mounted and/or secured to their respective modular units 116, 118, 120 of the supporting framework structure 82, i.e. the first type modular sub-frame 140 is mounted to the first type modular unit 116, the second modular sub-frame 142 is mounted to the second type modular unit 118 and the third type modular sub-frame 144 is mounted to the third type modular unit 120. As adjacent vertical uprights of adjacent prefabricated frames are spaced apart, adjacent modular sub-frames mounted to their respective modular units are spaced apart. In contrast to the separation between the vertical uprights, adjacent modular sub-frames are separated by a distance in the region of 1 mm to 5 mm, preferably, 1 mm to 3 mm, more preferably 1.5 mm to 2 mm to allow for thermal expansion and to enable the wheels of the load handling device to travel across the interface between adjacent modular sub-frames without the wheels snagging the track supports.

For the first, second and third modular sub-frames 140, 142, 144 to interface with each other to form a rectilinear shaped track support structure 156, the first, second and third type modular sub-frames adopt a similar interface pattern as the modular units of the supporting framework structure, namely, the first type modular sub-frame 140 has a closed sided outer frame structure and the second 142 and third 144 type modular sub-frames has an open sided outer frame along at least one side of the modular sub-frame. Like the second 118 and third 120 type modular units of the supporting framework structure 82 discussed above, the second type modular sub-frame 142 is a three sided frame forming a substantially U shaped outer frame structure with one open side (see FIG. 22) and the third type modular frame 144 is a two sided frame forming a substantially L shaped outer frame structure with two open sides (see FIG. 26). The open sides of both the second and third type modular sub-frames 142, 144 expose the ends of the track supports.

The second type modular sub-frame 142 is configured to interface with the first type modular sub-frame 140 such that the second type modular sub-frame 142 shares a common side with the first type modular sub-frame 140, i.e. the open sided frame of the second type modular sub-frame 142 is closed by sharing a side with the first type modular sub-frame 140. The third type modular sub-frame 144 is configured to interface with the second type modular sub-frame 142 by sharing two sides of adjacent second type modular sub-frames 142 in the track system 84. The interface between adjacent modular sub-frames coincides with the interface between adjacent modular units in the supporting framework structure, i.e. between adjacent modular storage cells of the supporting framework structure. As with the first type modular unit 116, the first type modular sub-frame 140 functions as an “origin” to which the second and third type modular sub-frames 142, 144 interface.

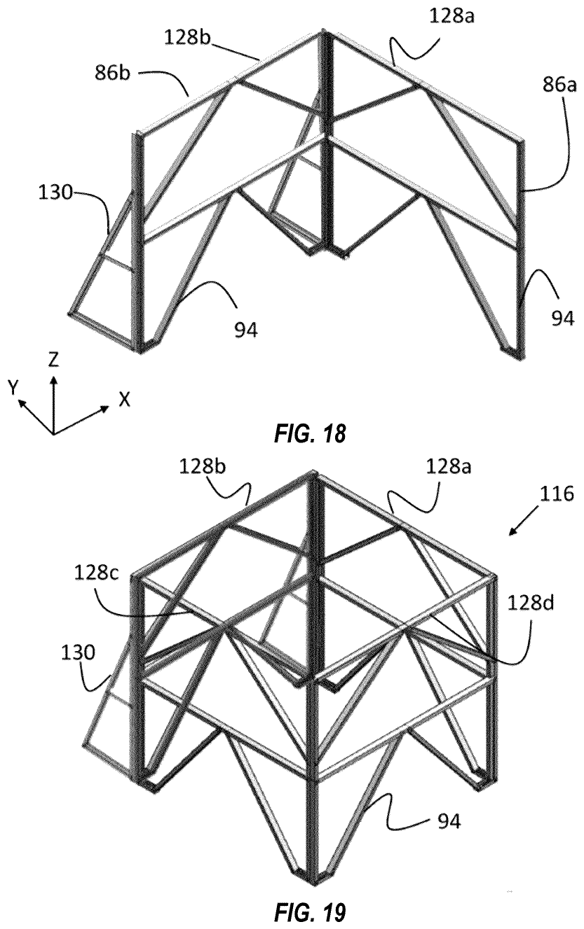

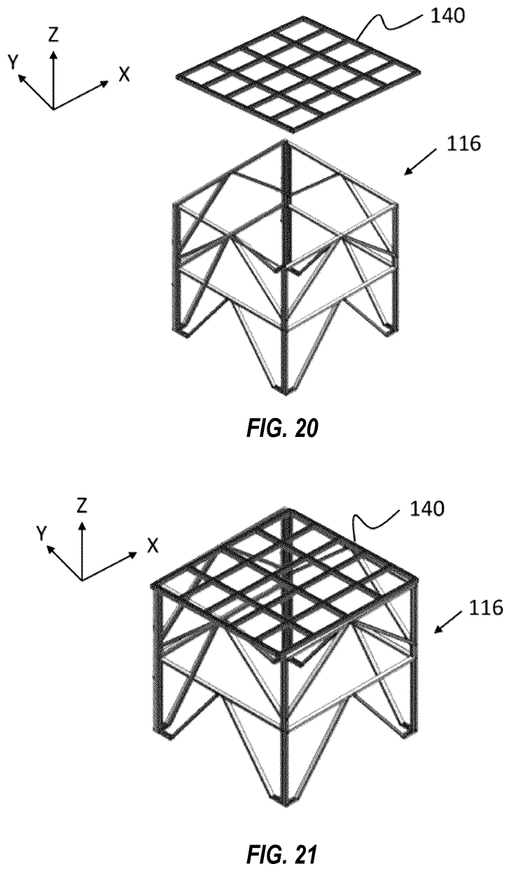

To accommodate the movement or slip joints 146 between adjacent modular sub-frames, one or more slip joints are mounted or fixed to the side shared between adjacent modular sub-frames. Assembly of the track support structure 156 begins with mounting the first type modular sub-frame 140 representative of the origin of the track support structure 156 to the first modular unit 116 as shown in FIGS. 20 and 21. The first type modular sub-frame 140 is subsequently secured to the first type modular unit 116. Securing the first type modular sub-frame 140 to the first type modular unit 116 involves securing the outer frame structure of the modular sub-frame to the horizontal bracing members 90 of the prefabricated frames. Various fasteners can be used to secure the first type modular sub-frame 140 to the first type modular unit 116. These include but are not limited to screws, nuts and bolts, etc. Other means to secure the first type modular sub-frame 140 to the first type modular unit 116 are permissible in the present invention, e.g. adhesive, welding etc. As the first type modular sub-frame 140 is a closed sided modular sub-frame, one or more slip or movement joints are mounted to one of the sides that is shared with an adjacent modular sub-frame.

Once the first type modular sub-frame 140 is mounted and secured to the first type modular unit 116, the second type modular sub-frame 142 is subsequently mounted and secured to the second type modular unit 142 as shown in FIG. 22. The same type of fasteners can be used to secure the second type modular sub-frame 142 to the second type modular unit 118, i.e. secured to the horizontal bracing members of the prefabricated frames. To enable the second type modular sub-frame 142 to interface with the first type modular sub-frame 140 when being mounted to the second type modular unit 118 so as to accommodate one or more slip joints 146 between the first and second type modular sub-frames 140, 142, the one or more slip joints are configured to cradle the exposed ends of the track supports extending from the open side of the second type modular sub-frame 142. In the particular embodiment shown in FIG. 23, the exposed ends of the track support 156a,b extending from the open side of the second type modular sub-frame 142 are shown being received in the one or more slip joints 146 mounted to the side of the first type modular sub-frame 140. The advantage of the one or more slip joints cradling the ends of the track supports from an adjacent modular sub-frame is the ease with which the track support structure can be assembled together incorporating one or more slip joints between adjacent modular sub-frames. Since the one or more slip joints are configured to cradle the exposed ends of the track supports from an adjacent modular sub-frame, the second type modular sub-frame 142 can simply be lowered in a substantially vertical direction onto the second type modular unit 118 as shown in FIG. 22 and can subsequently be secured to the second type modular unit 118. Not all of the exposed ends of the track supports of the second type modular sub-frame 142 would be needed to be cradled by the slip joints 146. Optionally, only a portion of the exposed ends of the track supports of the second type modular sub-frame would need to be cradled by one or more of the slip joints 146. In all cases, the slip joint or movement joint is configured to allow the modular sub-frames to be separately mounted to the supporting framework structure in a substantially vertical direction.

In the particular embodiment of the present invention shown in FIG. 23, the exposed track supports forming a central portion of the second type modular sub-frame 142 are supported by the slip joints 146. However, the track supports of the second type modular sub-frame 142 at the outer sides of the second type modular sub-frame interface with the first type modular sub-frame 140 by being secured to the first type modular sub-frame 140 by an angle bracket 123. The angle bracket 123 ensures that the outer sides of a given modular sub-frame is secured to an adjacent modular sub-frame in the track support structure 156 whilst the track supports forming the central portion of the modular sub-frame are supported to an adjacent modular sub-frame in the track support structure 156 by the one or more slip joints 146. To allow the track support ends secured to the angle bracket 123 to move in the first, X direction or second, Y direction, depending on the orientation of the connection with the angle bracket, the angle bracket is fastened to the track support end by a bolt or screw received in a slot or elongated opening in the angle bracket. The slot or elongated opening allows the bolt or screw securing the track support ends to move along the slot or elongated opening.

In the particular embodiment of the present invention shown in FIG. 24A, each slip joint 146 comprises a cradle bracket having a base wall 148 for supporting the end of the track supports and opposing sidewalls 150 for preventing excessive lateral movement of the individual track supports of the second type modular sub-frame 142 once mounted to the slip joint or cradle bracket 146. Movement of the ends of the track supports, and thus between adjacent modular sub-frames, occurs by the ends of the track supports sliding on the base wall 148 of their respective cradle bracket 146. The slip joint or cradle bracket 146 is orientated such that the end of the track supports are only moveable in one direction. This could be in the first, X, direction or the second, Y, direction. To prevent the ends of the track supports from disengaging from the slip joints 146, optionally, the ends of the track supports can be secured to a respective slip joint, more specifically the base wall 148 of the slip joint by a fastener. In the particular embodiment of the present invention shown in FIG. 24A, the base wall 148 of the slip joint 146 comprises a slot or elongated opening 147 for receiving a bolt. The slot 147 is orientated so as to allow the track support engaged with the slip joint to move in the first, X-direction or the second, Y direction. The elongated slot limits the movement of the modular sub-frames relative to each other in either the first direction and/or the second direction. To prevent excessive movement of the modular sub-frames in the first and second direction, movement in the first and second direction is limited to up to 10 mm, preferably 5 mm to accommodate thermal expansion of the track system.

In contrast to cradling the exposed ends of the track support to provide relative movement between adjacent modular sub-frames on the supporting framework structure, in an alternative embodiment of the present invention, the slip joint or movement joint 146b comprises an elongated element forming a bridging member 146c that bridges across the interface between adjacent modular sub-frames as shown in FIGS. 24B-24E. The bridging member 146c comprises a first end 146d that is configured to be fixedly connected to the track support of a modular sub-frame as shown in FIG. 24B and a second end 146e comprising a pin 146f that is receivable in an opening 157 in the track support of an adjacent modular sub-frame as shown in FIGS. 24D-24E. Like the cradle bracket, relative movement between adjacent modular sub-frames occurs by the movement of the pin 146f in the opening 157 in the track support 156a of the adjacent modular sub-frame in the X-direction or in the Y-direction. Like the first embodiment of the slip joint comprising the cradle bracket, movement of the pin 146f in the opening 157 is limited by the size of the opening in the track support 156a. The opening 157 is slightly enlarged in comparison to the pin 146f or is elongated to limit the movement of the pin in the opening in a range of up to 5 mm, preferably 3 mm, more preferably 1 mm to 2 mm to accommodate thermal expansion of the track system. The first end 146d of the bridging member is fixed to the track support such that the pin 146f at the second end 146e faces upwardly. This enables an adjacent modular sub-frame to be mounted to the supporting framework structure in a substantially vertical direction as the pin is received in an opening in the track support of the adjacent modular sub-frame as shown in FIGS. 24D-24E.

Alternatively or in addition to having the pin of the bridging member facing upwardly, the bridging member 146c can be connected across adjacent modular sub-frames subsequent to the modular sub-frames being mounted to their respective modular units of the supporting framework structure as shown in FIG. 24B. In this case, the pin at the second end of the bridging member faces downwardly to be received in a substantially vertical direction in an opening of the track support of an adjacent modular sub-frame. In both cases, mounting of the slip joint or movement joint to the modular sub-frames is in a substantially vertical direction. Like the cradle bracket, the bridging member can be formed from metal, e.g. stainless steel. However, the present invention is not limited to the movement or slip joints discussed above and can be any type of movement or slip joints that allows movement between adjacent modular sub-frames in the range 0.5 mm to 10 mm.

The spacing between adjacent slip joints 146 corresponds to the spacing between adjacent parallel track supports 156a, 156b. Movement between adjacent modular units, in this case, the first and second type modular units 116, 118, as a result of thermal expansion, is absorbed by movement of the exposed ends of the track supports along their respective slip joints 146. Depending on the size of the supporting framework structure and the number of modular storage cells occupied by the supporting framework structure, the process of mounting the modular sub-frame of the track support structure 156 to the first and second type modular units 116, 118 discussed above is repeated for the other modular sub-frames as shown in FIGS. 25 and 26.

FIG. 26 is an example illustrating the mounting of the third type modular sub-frame 144 to the third type modular unit 120 by interfacing along the two open sides of its L shaped open frame structure so as to complete the rectilinear structure of the track support structure 156 comprising four modular storage cells. As with the second type modular sub-frame 142, the third type modular sub-frame 144 is lowered onto the third type modular unit 120 such that the exposed ends of the track support at its respective open sides interface with the second type modular sub-frame 142 by being received in the slip joints or cradle brackets 146 mounted to the sides of the second type modular sub-frame 142 as shown in FIG. 26 or connected to the bridging member according to the second embodiment of the slip joint shown in FIGS. 24B-24E.

Movement between adjacent modular sub-frames is dependent on the number of interfaces between adjacent modular sub-frames. For the second type modular sub-frame 142, the interface is configured such that movement is permitted only along one direction, e.g. X or Y direction, depending on the orientation of the cradle bracket or the bridging member forming the slip joint 146 at the interface with the first type modular sub-frame 140. In the case of the third type modular sub-frame 144 where there are two interface portions, movement is permitted along two directions, e.g. the X and Y direction, due to interfacing along two sides with adjacent modular sub-frames. As a result, the track support structure comprises a first set of slip or movement joints to enable movement between adjacent modular sub-frames 140, 142, 144 in the X-direction and a second set of slip or movement joints enable movement between adjacent modular sub-frames 140, 142 144 in the Y-direction. The direction of movement between adjacent modular sub-frames in the X-direction and in the Y-direction is shown by the arrows in FIG. 28. By interfacing adjacent modular sub-frames along the X and Y direction, movement between adjacent modular sub-frames is permissible along both X and Y directions in a substantially horizontal plane. The modularity of the supporting framework structure and the track support structure having similar interface portions permits different shapes and sizes of the grid framework structure to be assembled.

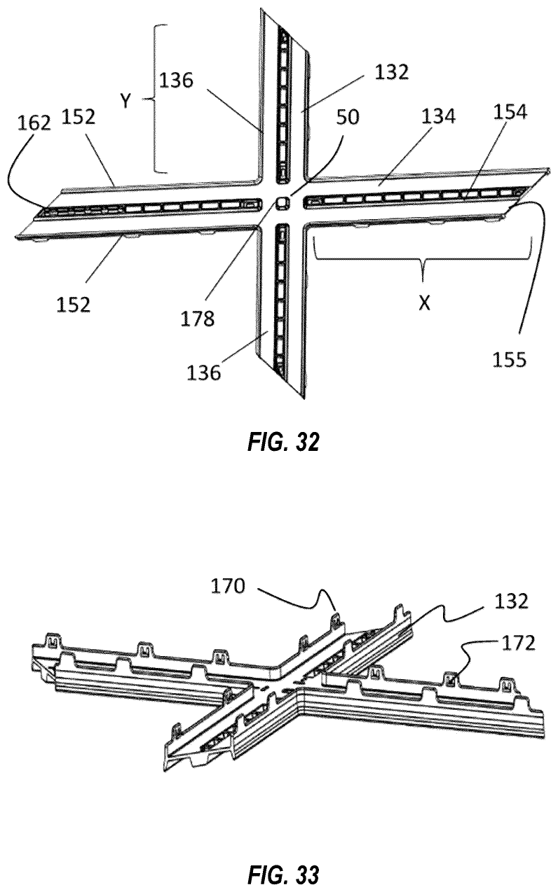

The track system is not complete without a plurality of tracks for guiding one or more robotic load handling devices on the track system. Each track of the plurality of tracks is profiled to provide either a single track surface so as to allow a single robotic load handling device to travel on the track or a double track so as to allow two load handling devices to pass each other on the same track. In the case where the plurality of tracks are profiled to provide a single track, the track comprises opposing lips (one lip on one side of the track and another lip at the other side of the track) along the length of the track to guide or constrain each wheel from lateral movement on the track. In the case where the profile of the plurality of tracks is a double track as exemplified in FIG. 32, the track comprises two pairs of lips 152 along the length of the track to allow the wheels of adjacent robotic load handling devices to pass each other in both directions on the same track. To provide two pairs of lips, the track typically comprises a central ridge or lip 154 and a lip 152 either side of the central ridge 154.

Like the track support structure 156 discussed above, the plurality of tracks comprises a first set of parallel tracks 122a extending in the first direction and a second set of parallel tracks 122b extending in the second direction, the second direction being substantially perpendicular to the first direction to adopt a similar grid like pattern of the track system. Since the plurality of tracks are mounted onto the track support structure 156, the grid pattern of the plurality of tracks corresponds to the grid pattern of the track support structure. Whilst the particular embodiment describes the plurality of tracks being mounted to the track support structure, the plurality of tracks can optionally be integrated into the track support structure, in which case, the plurality of tracks adopts a similar sub-division as the modular sub-frames of the track support structure 156 discussed above. In other words, each of the first, second and third type modular sub-frames 140, 142, 144 of the track support structure 156 includes a portion of the tracks integrated into their respective modular sub-frames.

As with the supporting framework structure and the track support structure, the plurality of tracks can be modularized in a plurality of track sections 132 so as to enable ease of assembly of the plurality of tracks on the track support structure. The cross shaped nature of each of the plurality of track sections allows a one to one relationship to exist between each track section 132 and each of the nodes 50 of the track system in the sense that only a single track section 132 occupies a single node of the track system rather than at least two track sections as found in prior art track systems described above and shown in FIG. 8. In other words, the intersections of the track section elements 134, 136 of a given track section 132 correspond with the nodes of the track system. Adjacent track sections in the track system are arranged such that their respective track section elements 134, 136 extend in a region between the nodes 50 of the track system, i.e. meet at a point 160 between the intersections of the tracks. More specifically, the distal ends 162 of the track section elements (branches) 134, 136 of adjacent track sections 132 meet in the region substantially half way or mid-point between neighboring nodes 50 of the track system. This also improves the speed by which each of the track sections can be assembled on the track support structure 156 as a single track section can be mounted to each node 50 of the track support structure 156 when assembling the plurality of tracks to the track support structure 156. For example, each adjacent track section can be mounted to the underlying track supports in different orientations, as the track sections are not restricted to one specific orientation on the track support structure. In other words, due to the symmetry, e.g. rotational symmetry, of the track section of the present invention, the track sections can be mounted on the track support structure in multiple different orientations without affecting their ability to connect to an adjacent track section on the track support structure. In the context of the present invention, the rotational symmetry is the ability to rotate the track section by an angle so that the rotated track section coincides with the un-rotated track section. In the case where the grid cells are square (equal length tracks in the X and Y direction), the rotational symmetry of the track section is such that the angle of rotational symmetry is 90°, which means that the track section can be rotated four times and still coincide with itself, i.e. order of symmetry of four. In the case where the grid cells are rectangular, the rotational symmetry of the track section is of order two. This has the advantage of reducing the number of differently shaped track sections necessary to assemble the track for a substantial portion of the grid structure, i.e. removes the “jigsaw” effect where a track section has a specific place in the track system, and thereby reduces the time to assemble the track on the track support structure. In addition, the tooling costs to manufacture the track sections would be greatly reduced since a smaller number of tooling designs would be necessary to mold the track section of the present invention in comparison to prior art tracks.

Multiple track sections 132 are mounted to the underlying track support structure to provide a continuous track surface between adjacent track sections for one or more robotic load handling devices to move on the grid framework structure 80. Modularization of the plurality of tracks into a plurality of cross shaped track sections also provides the ability to cover areas of the track support structure that are susceptible to unevenness. Areas that are susceptible to unevenness in the track system are at the nodes of the track system where the plurality of track supports intersect in the track support structure and/or between adjacent modular sub-frames. The areas of the track support structure between the nodes 50 are largely not susceptible to any differences in height variation of the interlocking track supports 156a, 156b in comparison to at the nodes as discussed above. Having the track section elements of adjacent track sections extend in the region between the nodes of the track system will largely not be influenced by any irregularities of the underlying track support structure between the nodes 50. As a result, the region of the track support structure between the nodes is largely flat and uninterrupted.

As the interface between adjacent modular sub-frames in the track support structure is configured with one or more slip joints to accommodate movement between the modular units in the supporting framework structure as a result of thermal expansion, the interface between adjacent modular sub-frames is also susceptible to being uneven. For example, separately mounting tracks to each of the modular sub-frames of the track support structure such that adjacent tracks in the track system butt up at the interface between adjacent modular sub-frames of the track support structure may generate a small step in the track system between the adjacent modular sub-frames. When a robotic load handling device approaches the junction/interface between adjacent modular sub-frames, the wheels of the robotic load handling device have a tendency to snag or strike the edge of the tracks as the wheels crosses the junction. Although the vertical displacement of the wheels is minute as the robotic load handling device travels across the interface, this up and down bumping impact to the wheels is one of the main source of noise and vibration of the travelling robotic load handling device. In a worst case scenario, the bumping of the wheels on the rails or tracks imparts wear and tear not only to the wheel or the tires of the robotic load handling devices but also to the tracks to the extent that damage occurs to either or both of the wheels and tracks. To mitigate the presence of a step in the track system, particularly at the interface between adjacent modular sub-frames of the track support structure, one or more track sections are mounted to the track support structure at the interface between adjacent modular sub-frames such that one or more portions of a given track section extends across the interface (see FIG. 29). Since the exposed ends of the track supports are arranged to be received in the cradle brackets of the slip joints mounted to an adjacent modular sub-frame at the interface, the cross shaped nature of each of the track sections permits the tracks sections to be mounted to the track support structure at the interface between adjacent modular sub-frames such that their respective track section elements extend across the interface. This has the effect of masking any imperfections or edges in the underlying track support structure and to transfer any meeting between adjacent track sections to the areas of the track system that are less susceptible to such height variations, i.e. between the nodes of the track system.

Whilst having cross shaped track sections help to mitigate the unevenness of the underlying track support structure, the distal ends of the track section elements 134, 136 of adjacent track sections 132 are also susceptible to unevenness, particularly, when they meet between the nodes. The distal ends of the track section elements 134, 136 may create a step at the junction between adjacent track sections 132 and if left unchecked cause a vertical displacement of the wheels of a travelling load handling device across the junction between connecting adjacent track sections 132. To mitigate this step, the distal ends 162 of the track elements are mitered or tapered as shown in FIGS. 32 and 33. The distal ends 162 of the track section elements comprises at least one tapered edge changing the conventional 90° angle cut to a substantial 45° angle cut edge. Thus, before the wheels of the load handling device rolls over the edge of a first track section element completely, part of the wheels already has touched the mitered end of a second track section element. This provides a gradual transition of adjoining track sections and prevents the wheels from sinking into any gap between the distal ends of adjacent track sections.

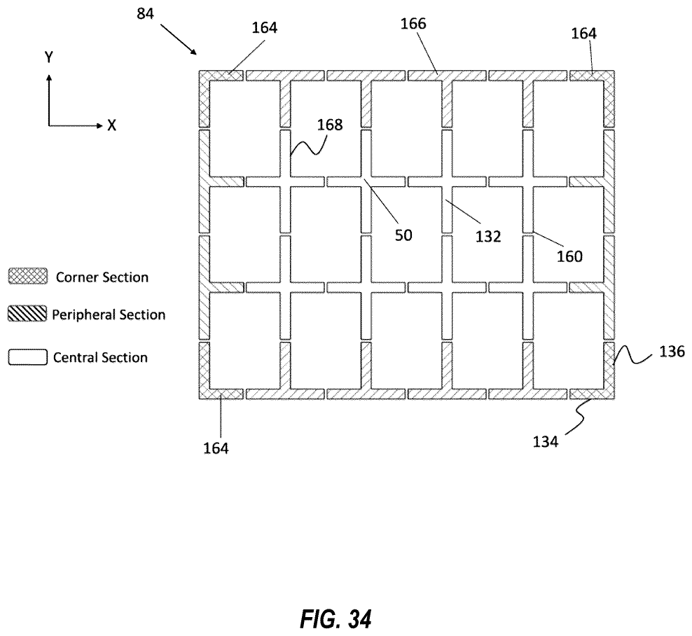

With reference to FIG. 13A, the grid framework structure 80 can be considered as a free standing rectilinear assemblage of prefabricated braced frames supporting the track systems formed from intersecting horizontal track supports and tracks, i.e. a four wall shaped framework. As a result, differently shaped track sections are needed to cover the different areas of the track support structure 156. For the purpose of explanation, the different areas of the grid structure can be termed a corner section 164, a peripheral section 166, and a central section 168. The corner section 164 of the track section provides a two way junction in the track system, the peripheral section 166 of the track section provides a three way junction in the track system and the central section 168 of the track section provides a four way junction in the track system. The different areas of the track system 84 where the track system has a rectilinear shape is shown in the sketch drawing of the pattern of the track sections in FIG. 34. The sketch of the pattern of track sections shown in FIG. 34 is not to scale and it is simply for illustration purposes. The track sections 132 at the corner section 164 of the track system 84 are shown with a different shaded area and each of the track sections 164 at the corner has two track section elements 134, 136 respectively extending in the X and Y direction of the track system 84, i.e. two branches. The track sections 132 at the peripheral section 166 of the track system 84 are shown with a different shaded area. In the particular embodiment of the present invention shown in FIG. 34, each of the track sections 166 at the periphery of the track comprises three track section elements 134, 136, i.e. three branches. In the embodiment illustrated in FIG. 32, the track sections 166 at the periphery can have two track section elements 134, 136 extending in opposite directions along the first direction and a third track section element 134, 136 extending in the second direction, or two track section elements 134, 136 extending in opposite directions along the second direction and a third track section element 134, 136 extending in the first direction. The track sections 166 at the peripheral sections are not limited to having three track section elements or branches 134, 136 and can comprise more than three track section elements depending on whether the peripheral section extends across more than one node 50 in the track system 84. The nodes 50 represent the areas of the track system 84 where the individual track sections' elements or branches 134, 136 intersect. For example, a peripheral section can comprises two track section elements extending in opposite directions along the first direction and multiple track section elements extending in the second direction for connecting to or meeting with adjacent track sections 84 in the central section of the grid structure, i.e. more than three branches.

As is clearly apparent in the schematic sketch shown in FIG. 34, a substantial portion of the track system falls within the central section of the track system where each of the track sections 132 is cross shaped having track section elements 134, 136 that branch or extend in transverse directions, i.e. first direction (X) and second direction (Y). In all of the differently shaped track sections 164, 166, 168 in the particular embodiment shown in FIG. 34, there is a one to one relationship between each of the plurality of track sections and each of the nodes 50 of the track system 84. For example, there is a one to one relationship between a track section 164 and the node 50 at the corner of the track system. Likewise, there is a one to one relationship between each of the track sections 166 and each node 50 at the periphery of the track system.

However, the present invention is not limited to there being a one to one relationship between each of the plurality of track sections and each of the nodes since a single track section can extend across more than one node in the track system. For example, the branches or track section elements 134, 136 of one or more of the track sections 132 can be sized to extend across one or more nodes of the track system. The larger sized track sections 132 would mean that fewer track sections 132 would be needed to make up the track system 84, i.e. to assemble the track system together. The distal ends 162 of one or more of the track section elements 134, 136 of adjacent track sections extend to meet in the region between the nodes of the track system 84 as this is the area of the track system where the underlying track support structure 156 are less susceptible to any vertical displacement. In all cases, each track section 164, 166, 168 is a single unitary body having portions or elements 134, 136 extending in transverse directions so as to provide a track surface or path for a load handling device to move on the track system extending in transverse directions. A single piece track section having a track surface or path extending in transverse directions greatly reduces the complexity and the components required to assemble the grid framework structure according to the present invention. Various materials can be used to fabricate the track section. These include various metals, e.g. aluminum, plastics, e.g. nylon and/or composite materials.

Whilst the use of plastic material provides advantages in terms of its mouldability to tight dimensional tolerances, one of the drawbacks of the use of plastic material is its inability to conduct static electricity accumulated on the surface of the track to ground as a result of the engagement of the wheels (which are largely formed from a non-conductive material) of the load handling device, in particular the tires of the wheels. To overcome this drawback, in a particular embodiment of the present invention, the plastic material is made conductive by the incorporation or mixing of a conductive material such that the track section is formed from a composite material. For example, conductive fillers can be mixed with the plastic material prior to molding to render the plastic material conductive. Examples of known conductive fillers include but are not limited to carbon (e.g. graphite) and metallic fillers, e.g. copper, silver, iron etc. The conductive fillers can be in particulate form or fibers. For example, conductive fillers in the range of 20% to 50% by weight can be added to the plastic material to render the plastic material conductive. Alternatively, conductors can be insert molded within the plastic material to provide a continuous conductive path in the track.

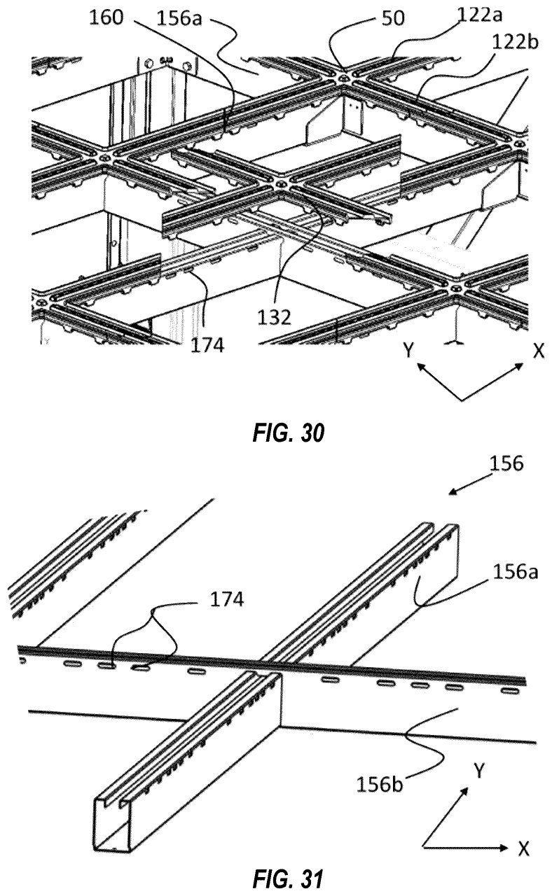

To secure the plurality of tracks to the track support structure, each of the track sections 132 can be snap fitted to the track support structure. In the particular embodiment of the present invention, the underside of the track section 132 shown in FIG. 33 comprises one or more lugs or tabs 170 that are configured to be snap fitted to the track support 156a, 156b. The one or more tabs or lugs 170 can comprise a bead or protruding edge 172 that is arranged to deflect and be received in one or more openings 174 in opposing side walls (or vertical elements) of the track support 156a, 156b in a snap fit arrangement as shown in FIGS. 30 and 31. The particular snap fit feature shown in FIGS. 30 and 31 is a cantilever snap fit. However, other forms of snap fit connections commonly known in the art for securing the track section to the track support are applicable in the present invention. Equally, other forms of securing the track section to the track support besides a snap fit joint are applicable in the present invention, e.g. the use of fasteners or an adhesive.

In addition to thermal expansion of the different components of the supporting framework structure 82 and the track support structure 156 discussed above, one or more tracks of the plurality of tracks 122a, 122b also experience thermal expansion in different temperature environments. This is particularly the case where the plurality of tracks are separately mounted to the track support structure. In the case, where the track is composed of a plastic material and the track support structure is largely composed of metal, there will be a disparity in the thermal expansion coefficients between the plurality of tracks and the underlying track support structure 156 to the extent that there will be a difference in movement between both components as a result of thermal expansion. As each of the plurality of track sections 132 comprises track section elements 134, 136 extending in substantially transverse directions, relative movement between one or more of the plurality of track section elements and the underlying track support structure are largely concentrated in the region around the track section elements 134, 136 extending from the nodes of the track sections 132. A node in a track section is the area where the track section elements in a given track section intersect. In the case, where the plurality of tracks are firmly secured to the underlying track support structure, differential movement between one or more of the plurality of tracks and the underlying track support 156a, 156b as a result of the differences in thermal expansion between the track and the track support may cause the one or more of the tracks to distort. For example, where the underlying track support thermally expands to a greater extent than the track, the forces generated as a result of thermal expansion of the track support may have a tendency to impact the connection between the track and the track support. In a worst case scenario, the difference in thermal expansion between the track and the track support may result in the connection between the tracks and the track support to fail and in a worst case scenario, lead to delamination or detachment of one or more tracks from the track support. As the plurality of track sections 132 are snap-fitted to the track support structure 156, failure of the connection between the one or more of the plurality of tracks and one or more of the underlying track supports largely occurs at the snap-fitted joints between the plurality of tracks and the track support structure.

To mitigate the relative movement between the plurality of tracks and the underlying track support structure as a result of thermal expansion, the connection between each of the track sections and the underlying track support comprises a thermal expansion joint comprising a slip or movement joint. Where the connection between each of the plurality of track sections and the underlying track support structure comprises a snap-fitting joint, the snap-fitting joint between the track section and the track support is configured such that the connection allows one or more of the track section elements to expand or contract along a substantially horizontal direction relative to the underlying track support, i.e. along the plane in which the track system lies, but is prevented from movement in a substantially vertical direction to prevent the track section from detaching from the underlying track support. To accommodate a thermal expansion joint within a snap-fitting joint, the one or more openings 174 in the opposing side walls of the track support are enlarged in or more directions so as to permit movement of the lugs or tabs 170 within the one or more openings 174 of the track support. In the particular embodiment of the present invention as shown in FIG. 31, each of the one or more openings 174 comprises a slot in the opposing side walls of the track support, wherein the slot is orientated such that the longest edge of the slot (length of the slot) extends in the direction of the longitudinal length of the underlying track support and the shortest edge (i.e. width of the slot) extends in the direction substantially perpendicular to the longitudinal length of the underlying track support. The orientation of the slot is such that the lugs or tabs 170 engaged with the openings or slots 174 permits the lugs or tabs to move longitudinally along the slots which in turn allows expansion or contraction of the track section elements 134, 136 attached thereto relative to the underlying track support. Equally, plausible is that expansion or contraction of the underlying track support as a result of thermal expansion causes the slots to move relative to the lugs or tabs 170 engaged therein. Various other means to incorporate a slip or movement joint in the connection between one or more of the plurality of tracks and the underlying track support structure as permissible in the present invention. For example, the connection between each of the plurality of tracks and the underlying track support structure can comprises one or more runners, e.g. telescopic drawer runners. Other means to provide one or more slip joints in the connection between each of the plurality of track sections, in particular the track section elements of the track sections, include replacing the one or more slots in the opposing side walls of the track support with a depression that extends along the longitudinal length of the track support and configured to cooperate with the lugs or tabs of the tracks in a slide fit arrangement. Like the one or more slots, the one or more tabs or lugs of the track sections are configured to snap fit with the depression.

To provide spacing for the thermal expansion of one or more of the plurality of track sections in the track system, the distal ends 162 of the track section elements of adjacent track sections are spaced apart. The spacing is sufficient to allow the track elements of adjacent track sections to expand on the underlying track support such that their respective distal ends 162 connect or butt-up without buckling. The spacing is also dependent on the diameter of the wheels of the robotic load handling device operable on the track system. If the spacing between the distal ends of adjacent track elements is too large in comparison to the diameter of the wheel, this has the effect of introducing a step between adjacent track section elements causing the wheels of the robotic load handling device to snag or bump the ends of the track section elements and in a worst case scenario cause the wheel to sink or fall within the gap created by the spacing between adjacent track section elements. The spacing should be sufficient to allow the wheels of the robotic load handling device to traverse across the gap created by the spacing between the distal ends 162 of adjacent track sections 132 without excessive snagging of the wheels but not too big for the wheels to sink or fall within the gap. In the particular embodiment of the present invention, the spacing between the distal ends 162 of adjacent track elements of adjacent track sections in the track system provides a gap 176 is contrast to the spacing between adjacent vertical uprights of adjacent prefabricated frames in the supporting framework structure, namely, the spacing is in the range 0.5 mm to 5 mm, preferably, between 1 mm to 3 mm, more preferably between 1.5 mm to 3 mm. The spacing between the distal ends of the track elements is largely influenced by the thermal expansion of one or more prefabricated frames of the supporting framework structure. Typically, for a wheel having a diameter of about 120 mm, the spacing can be up to 6 mm without excessive snagging or sinking of the wheels within the gap.

The track section elements of the track section is configured with a double track as shown in FIG. 32 comprising two ridges or depressions 155 running side by side along the longitudinal length of each of the track section elements 134, 136 for receiving and guiding the wheels of the robotic load handling device and a central ridge 154 running parallel to the two ridges or depressions 155. The depressions 155 either side of the central ridge 154 provide the paths for the wheels of the robotic load handling device to engage. Each track section element 134, 136 for guiding the wheels of the robotic load handing device comprises two lips 152; one at either side of the wheel. For a double track, there are two pairs of lips 152 side by side running along the longitudinal length of the track for guiding two pairs of wheels. This is to ensure that two load handling devices can pass each other in the X direction and the Y direction when running on the double track in different directions on the same track section. To allow one or more load handling devices to cross at the crossing or intersection of the track section, i.e. cross at the cross roads, which correspond to the nodes of the track system, the crossing or intersection of the tracks comprises a small island 178 as shown in FIG. 32 so as to permit the wheels to be guided in transverse directions. This is particularly the case in areas where the tracks cross or intersect, which are predominantly around the central section of the track system. The track system of the present invention is not limited to a double track and the track elements can be configured with a single track comprising a single ridge or depression formed from a pair lips either side of the track for guiding a single wheel along the track.

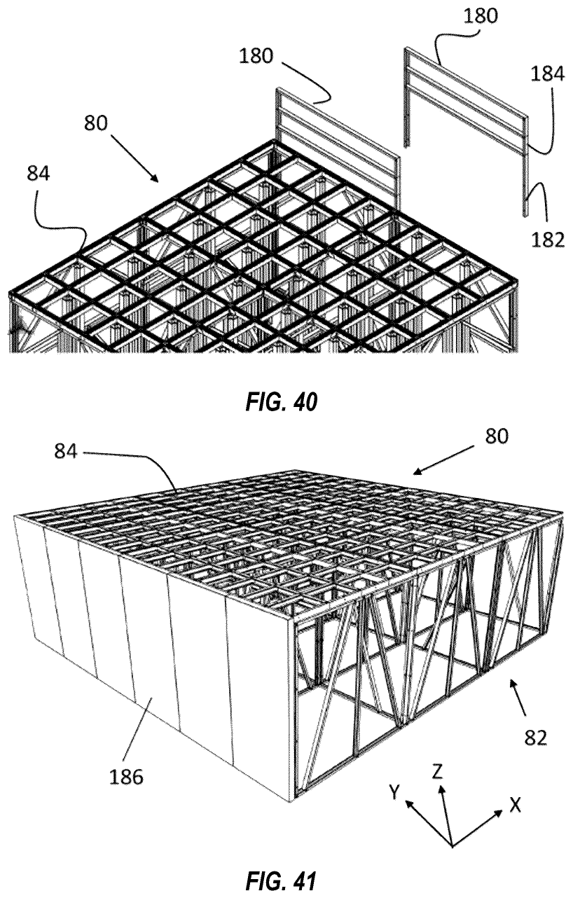

One or more crash barriers 180 can optionally surround at least a portion of the periphery of the track system 84 to prevent one or more robotic load handling devices operable on the track system from overrunning the track system. To maintain the modularity of the grid framework structure and the ability of the grid framework structure to be flat packed, the crash barrier 180 can also be modularized. The crash barrier 180 is formed as a prefabricated frame or panel comprising a lower portion 182 for mounting to the support framework structure 82 and an upper portion 184 that extends above the track system to form a barrier when mounted to the supporting framework structure. The prefabricated frame is different to the prefabricated frame for building the supporting framework structure discussed above. To differentiate from the prefabricated frames of the supporting framework structure, the prefabricated frame forming the crash barrier will be termed a crash panel. Due to the weight of the robotic load handling device which can be in excess of 100 kg and since the supporting framework structure is load bearing, the crash panel is mounted and supported by the supporting framework structure. The lower portion 182 comprises vertical members that extend downwardly for connecting to the vertical uprights of the support framework structure and the upper portion 184 comprise one or more horizontal members bracing the vertical members as shown in FIG. 40. Various fasteners known in the art can be used to secure the crash panels to the vertical uprights to the supporting framework structure. These include but are not limited to bolts, screws etc. Optionally, a bracket or clamp may be used to secure the crash panel to the supporting framework structure. A plurality of crash panels are secured around the peripheral edge of the track system such that each of the crash panels extend above the track system to form a protective enclosure or barrier surrounding the periphery of the track system.

One or more external walls of the supporting framework structure 82 can be cladded with one or more solid walled panels 186 as shown in FIG. 41 so as to encase the interior space of the supporting framework structure. The one or more solid walls 186 can be insulated providing a thermal barrier to prevent escape of heat from the interior space of the supporting framework structure 82. In the case where the contents of the storage containers are temperature sensitive such as grocery items, insulating cladding 186 encasing the exterior walls of the supporting framework structure 82 has the advantage of preventing the transfer of heat between the interior of the supporting framework structure 82 and the exterior. For example, the interior space of the supporting framework structure 82 can be the chilled zone operating within the temperature range between substantially 0° C. to substantially 5° C. or the frozen zone operating within the temperature range between substantially −25° C. to substantially 0° C., preferably between substantially −21° C. to substantially −18° C. The exterior walls of the supporting framework structure can also be cladded to improve the aesthetic appearance of the supporting framework structure.

As one or more load handling devices are operative on the track system, it is paramount that the track system lies in a substantially horizontal plane as this will affect the direction in which the storage containers or storage bins are hoisted into the correct position through a grid cell. If the level of the track system deviates from the horizontal plane, this will not only put a strain on the one or more robotic load handling devices travelling on the track system but will cause the lifting tethers to sway to one side depending on the direction of the deviation and in a worst case scenario, cause the grabber device to fail to engage with the container or storage bin below. The problem is exacerbated when the floor on which the grid framework structure is installed is uneven. One or more of the uprights of the prefabricated braced frames and/or guides can be mounted on an adjustable grid levelling mechanism (not shown) for adjusting the level of the track system. The level of the track system mounted on the uprights is adjusted by having an adjustable levelling foot at the base or lower end of the vertical uprights and/or tote guides to compensate for an uneven floor. The level of the track system is adjusted by adjusting the adjustable levelling foot at the base of one or more vertical uprights and/or tote guides in the grid framework structure and checking the level of the track system at the top of the grid framework structure each time an adjustment is made, e.g. by use of a suitable levelling measurement instrument such as a laser level commonly known in the art.

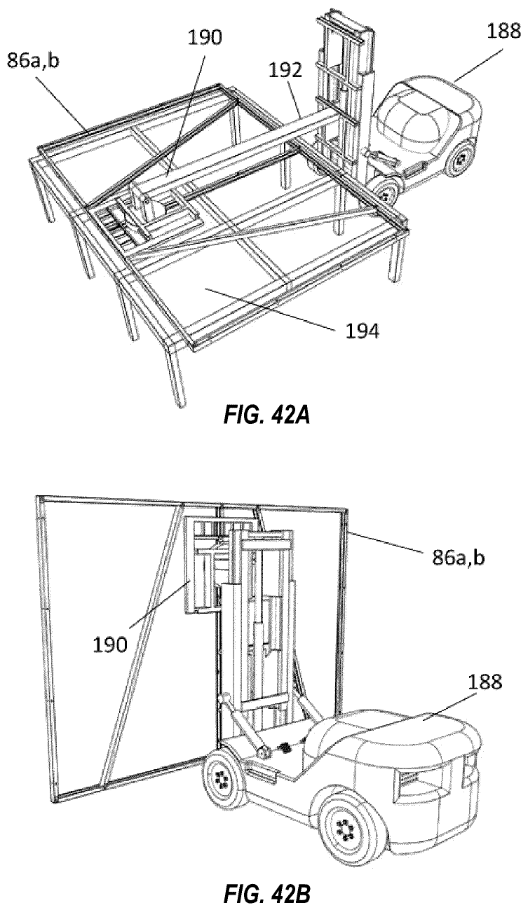

Assembly of the grid framework structure according to the present invention involves erecting a plurality of prefabricated frames into a grid pattern comprising a plurality of modular storage cells, each of the plurality of modular storage cells providing a storage space for storing multiple stacks of storage containers. The prefabricated frames can be prefabricated on site or at a remote location and transported to the site to be assembled into the supporting framework structure. For example, prefabrication can involve bracing a plurality of vertical uprights by one or more bracing members on site. Prefabrication of the frames can be done manually or automatically. A lifting device can be used to orientate and position the prefabricated frames together. The lifting device can be operated manually or automatically. FIGS. 42A-42B are an example where an AGV (automated guided vehicle) 188 comprises a tool or gimbal 190 that is specially adapted to engage with a prefabricated frame 86a,b and orientate it for assembly into the supporting framework structure 82 according to the present invention. A gimbal 190 is defined as a pivoted support that permits rotation of an object about an axis. The gimbal 190 is connected to a lifting mechanism via a lifting arm 192 as shown in FIG. 42A to enable the prefabricated frame 86a,b to be lifted in position where it can be secured to an existing prefabricated frame in the supporting framework structure. A support surface 194 mounted one legs as shown in FIG. 42A can be used to offer up the prefabricated frame to the gimbal of the lifting device. The support surface 194 can comprise a specially designed jig (not shown) to facilitate prefabrication of the frames. For example, in the case of the prefabricated braced frames, the specially designed jig can be used to properly align the plurality of uprights prior to being braced by one or more bracing members.

Once the prefabricated frame is engaged with the gimbal, the lifting mechanism is able to lift the prefabricated frame clear of the support surface 194 so as to allow the AGV to be driven to a desired location on site. The gimbal allows the prefabricated frame to be orientated for assembly onto an adjacent prefabricated panel. Multiple AGVs can be controlled by a control system so as to orchestrate assembly of a plurality of the prefabricated frames into a supporting framework structure. Connection of adjacent prefabricated frames involves using a number of fasteners commonly including but not limited to one or more bolts, welding, rivets, or adhesive. Securing the prefabricated frames together can be done manually or automatically when a prefabricated frame is offered up to one of the other prefabricated frames in the supporting framework structure.

In addition to assembling the prefabricated frames together, one or more AGVs can be used to assemble the prefabricated modular sub-frames together to form the track support structure. The individual prefabricated modular sub-frames can be secured to the modular units by one or more fasteners, e.g. bolts, rivets, welding, or adhesive. Once the track support structure 156 has been assembled together, a plurality of track sections can then be fitted to the track support structure to complete the track system of the grid framework structure. As the individual track sections comprise snap fitting features as discussed above, individual track sections can be snap fitted at the nodes of the track support structure to form the track system. The transverse sections of individual track sections help to mask any underlying imperfections to track support structure particularly at the nodes where the track supports intersect in the track support structure. In contrast to assembling the grid framework structure known in the art where individual uprights are erected first and the top ends of the uprights are interconnected together by vertical uprights extending in orthogonal directions, the prefabrication of the components of the grid framework structure prior to assembly greatly reduces the time to erect the grid framework structure. Other advantages include ensuring that the grid cells are uniformly sized throughout the track system, since there is little need for adjustments of the track supports in situ as portions of the track support structure are prefabricated prior to assembly. A specially designed jig can be used to prefabricate the modular sub-frames so as to ensure that the individual grid cells are ‘square on’ and/or correctly aligned prior to being mounted to the supporting framework structure.

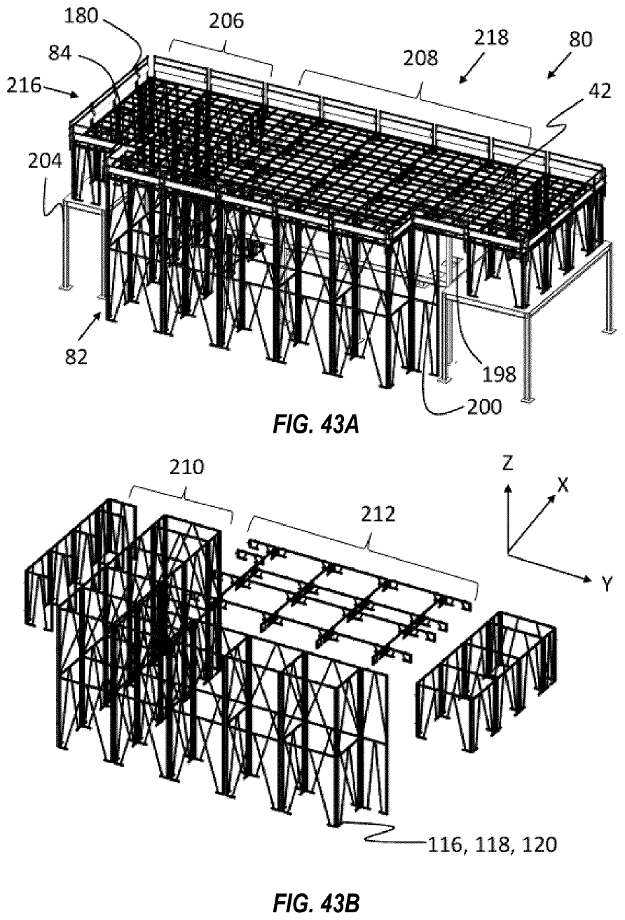

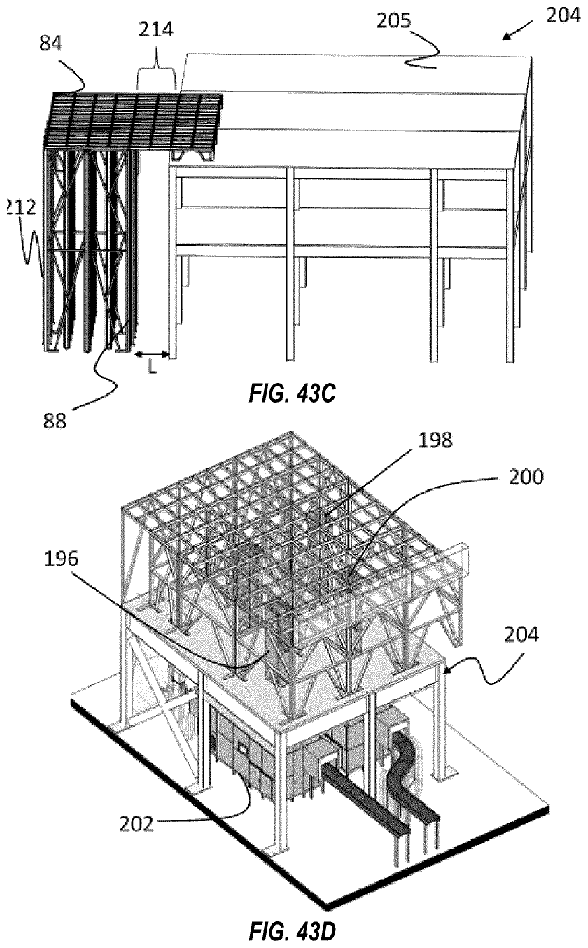

To access the contents of the storage containers, a majority of the grid columns are storage columns, i.e. grid columns where storage containers are stored in stacks. However, a grid framework structure normally has at least one grid column which is used not for storing storage containers, but which comprises a location or grid cell 42 where the load handling devices can drop off and/or pick up storage containers so that they can be transported to a second location (not shown in the prior art figures) where the storage containers can be accessed from outside of the grid or transferred out of or into the grid. Within the art, such a location or grid cell is normally referred to as a “port” and the grid column in which the port is located may be referred to as a “delivery column” 196 (see FIG. 46). The storage grids comprise two delivery columns. The first delivery column may for example comprise a dedicated drop-off port 198 where the container handling vehicles can drop off storage containers to be transported through the delivery column and further to an access station or a transfer station, and the second delivery column may comprise a dedicated pick-up port 200 where the container handling vehicles can pick up storage containers that have been transported through the delivery column from an access or a transfer station. Storage containers are fed into the access station and exit the access station via the first delivery column and the second delivery column respectively (see FIG. 43A).

Upon receipt of a customer order, a load handling device operative to move on the tracks is instructed to pick up a storage bin containing the item of the order from a stack in the grid framework structure and transport the storage bin to a pick station 202 via the delivery column whereupon the item can be retrieved from the storage bin. Typically, the load handling device transports the storage bin or container to a bin lift device that is integrated into the grid framework structure. A mechanism of the bin lift device lowers the storage bin or container to a pick station 202. At the pick station, the item is retrieved from the storage bin. Picking can done manually by hand or by a robot as taught in GB2524383 (Ocado Innovation Limited). After retrieval from the storage bin, the storage bin is transported to a second bin lift device whereupon it is lifted to grid level to a pick-up port to be retrieved by a load handling device and transported back into its location within the grid framework structure.

In order for a load handling device to drop off or pick up storage containers to and from the pick station 202, a separate area is provided adjacent the storage columns to accommodate the access station. Typically, the separate area is provided by incorporating a mezzanine 204 supported by vertical beams in amongst adjacent grid framework structures. The mezzanine provides a separate area to accommodate one or more service stations such as one or more pick stations. Typically, the separate area is a tunnel with a grid framework structure either side of a tunnel. The track system from adjacent grid framework structures extends across the top of the mezzanine to connect to a track system either side of the mezzanine 204 such that the track system lies in a substantially horizontal plane. One or more delivery and/or pick-up ports are assigned to one or more grid cells of the track system extending across the mezzanine so that a load handling device operative on the track system is able to drop off or pick up a storage container from the pick station below. As a result of the track system extending across the mezzanine, the supporting framework structure 212 at the top of the mezzanine tends to be shallower than the supporting framework structure 210 either side of the mezzanine, i.e. can only accommodate one or two layers of containers in a stack. Typically, the mezzanine is a continuous structure extending across the length of the track system 84 supported by vertical beams. The vertical beams supporting the mezzanine butt up against the grid framework structure either side of the mezzanine. In addition to one or more pick stations 202, the separate area created by the mezzanine can also accommodate various other stations including but not limited to a charge station for charging the rechargeable battery powering the load handling devices on the grid, and a service station to carry out routine maintenance of the load handling device. However, the problem with a continuous structure is that there is little flexibility to extend the mezzanine and the surrounding grid framework structure without the need to replace the mezzanine. Typically, the mezzanine is initially erected as a continuous structure and the grid framework structure is subsequently assembled around the mezzanine. The shape and footprint of the grid framework structure is largely influenced by the shape and footprint of the mezzanine. As the shape or footprint of the mezzanine is fixed, the process of assembling the grid framework structure around the mezzanine does not lend itself kindly to having the flexibility to expand the storage capacity of the grid framework structure as this will result in the need to re-design the mezzanine to accommodate the additional storage columns.

In contrast to the continuous structure, the mezzanine 204 according to the present invention can adopt a modular construction as shown in FIGS. 43A-D. The modularity of the mezzanine 204 enable the mezzanine to be assembled in sections 205 as shown in FIG. 43C to cater for the increasing service requirements of the grid framework structure 80. Thus, as the footprint of the grid framework structure increases providing increased storage capacity, the mezzanine 204 can be built up in separate sections 205 alongside the grid framework structure. In the particular embodiment of the present invention shown in FIG. 43C, the mezzanine is built up from separate, discrete sections 205 removing the need to size the mezzanine prior to assembling the grid framework structure. As the grid framework structure of the present invention is modular, the mezzanine can easily interface with the grid framework structure and can be built alongside assembling of the grid framework structure. The modularity of the mezzanine mean that different size and shapes of the grid framework structure can be assembled to interface with the mezzanine.

Assembly of the supporting framework structure involve assembling a plurality of discrete modular blocks or units, namely the first, second and third type modular units 116, 118, 120 to interface with a plurality of modular units extending across the mezzanine (see FIG. 43B). As shown in FIG. 43B, the supporting framework structure comprises a first region 210 and a second region 212. The first region 210 of the supporting framework structure surrounds the mezzanine 204 and the second region 212 of the supporting framework structure extends across the mezzanine 204. As shown in FIG. 43B, the first region of the supporting framework structure is at a different height to the second region 212 of the supporting framework structure extending across the mezzanine 204 such that the track system extending across the first and second regions of the supporting framework structure lies in a substantially horizontal plane. As a result, the modular units making up the first region 210 of the supporting framework has a different height to the modular units making up the second region 212 of the supporting framework structure so as to accommodate the height of the mezzanine. FIG. 43D is an isometric view of the second region of the supporting framework structure supported by the mezzanine according to the present invention. Also shown in FIG. 43D is the delivery columns 196 extending from the track system above the mezzanine to one or more pick stations 202 below the mezzanine. Each of the storage columns above the mezzanine has a capacity to storage up to two storage containers high. To put this into perspective, a typical storage container has a height in the range 350 mm to 400 mm.

In the example shown in FIGS. 43A-43B, the first region 210 of the supporting framework structure 210 has a storage capacity to store a plurality of stacks of storage containers, wherein each stack of storage containers can hold up to twenty one storage containers high. Likewise, the second region of the supporting framework structure 212 has a storage capacity to store a plurality of stacks of storage containers, wherein each stack of storage container can hold up to two storage containers high. The modular nature of the mezzanine 204 discussed above is able to adapt to different size and shapes of the supporting framework structure. For example as shown in FIGS. 43A-43B, the storage capacity of the grid framework structure can be increased simply by connecting additional modular units to the existing grid framework structure. The modular nature of the mezzanine would mean that the mezzanine can be assembled alongside the additional modular units of the supporting framework structure.

In addition to having first and second regions of the supporting framework structure, the track system extending across the supporting framework structure comprise a first region 206 and a second region 208, the first region 206 of the track system extends across the first region 210 of the supporting framework structure and the second region 208 of the track system extends across the second region 212 of the supporting framework structure. The first region 210 of the track system can interface with the second region 212 of the track system by one or more slip or movement joints discussed above. The one or more slip joints interfacing between the first and second regions of the track system enable the first region 210 of the supporting framework structure to move independently of the second region 212 of the supporting framework structure. For example, during a seismic event, ground movement will result in the supporting framework structure to oscillate. As the first region 210 of the supporting framework structure is taller than the second region 212, the first region of the supporting framework structure will oscillate more that the second region during ground movement. Without any independent movement between the first and second regions of the supporting framework structure, there is the risk that the first region of the supporting framework structure can exert excessive force on the second region of the supporting framework structure. In a worst case scenario, the force may be too excessive to cause structural damage to the supporting framework structure. The one or more slip joints interposed between the first region 206 and second region 208 of the track system enable the first region of the supporting framework structure to move independently of the second region of the supporting framework structure.

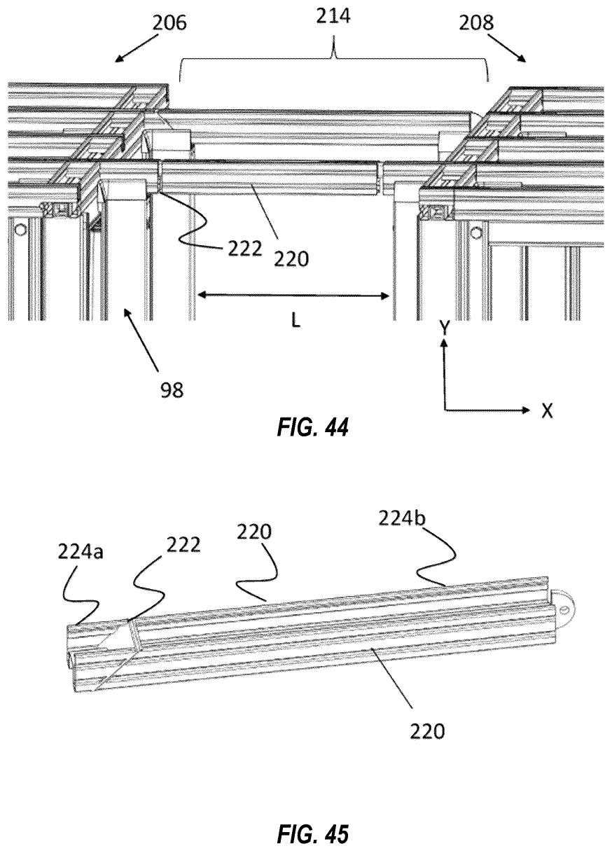

To incorporate the one or more slip joints between the first and second regions of the track system, the interconnections of the plurality of track supports at the interface between the first and second regions of the track system comprises the one or more slip joints. In the particular embodiment of the present invention, an interface zone 214 comprising a plurality of interfacing track supports bridges the first and second region of the track system (see FIG. 43C). The interfacing track supports connects the first and second regions of the track system by one or more slip or movement joints. The one or more slip or movement joints can be the same slip or movement joints discussed above at the interface between modular storage cells. The interfacing track supports bridging the first and second regions of the track system can be seen in FIG. 44 and comprises a plurality of bridging elements 220 that extend in the first direction or second direction across the interface zone 214. Each of the plurality of bridging elements is configured to accept a single track element extending across the bridging element to enable a load handling device to move between the first and second regions of the track system. As with the track elements discussed above with reference to FIG. 30, the single track element can be mounted to the bridging element by a snap-fit joint.

Alternatively or in addition to the one or more slip joints interfacing the first region and the second region of the track system, the interface between the first and second regions of the track system can comprise one or more mechanical fuses that is configured to break or shear under an applied load greater than or equal to a predetermined load, said predetermined load being lower than the load for breaking the interconnections at the intersections of the plurality of track supports. This is to allow the first region of the track system to separate from the second region of the track system when the applied load exceeds the predetermined load. One or more mechanical fuses 222 connects the bridging elements 220 to the first 206 and the second regions 208 of the track system. As there is a separation between the first and second regions of the supporting framework structure, disconnection of the track system at the interface zone, separates the grid framework structure around the mezzanine from the grid framework structure extending across the mezzanine. For the purpose of definition of the present invention, the grid framework structure comprising the first region of the track system 206 and the first region 210 of the supporting framework structure is termed a first region of the grid framework structure 216. Likewise, the grid framework structure comprising the second region 208 of the track system and the second region 212 of the supporting framework structure is termed a second region of the grid framework structure 218. When excessive load is applied to the mechanical fuse, e.g. during a seismic event, the first region of the grid framework structure 216 is configured to break away from the second region of the grid framework structure 218 so that they can each move independently.

To enable the first region 210 of the grid framework structure to move independently of the second region 212 of the grid framework structure, there is also a separation, L, between the first and second regions of the supporting framework structure bridged by the interface zone 214 of the track system. The separation can be one or more grid cells of the track system. The vertical members 88 adjacent the mezzanine 204 are spaced apart from the mezzanine so that movement of the vertical members 88 in the first region of the supporting framework structure does not have an impact on the movement of the mezzanine 204. The only connection between the first region of the supporting framework structure and the second region of the supporting framework structure is via the interface zone or region 214 of the track system, more specifically, the connection of the plurality of track supports in the interface zone 214.

The one or more mechanical fuses can be incorporated into the one or more slip joints bridging the first and second regions of the track system. For example with reference to the slip joint shown in FIG. 24C, the pin 146f receivable in the opening 157 in the track support can be arranged to break or shear when the applied load in the lateral direction exceeds the predetermined load. Alternatively, each of the plurality of bridging elements are connected to respective track supports in the first and second regions of the track system by one or more bolts having a break zone that is configured to shear when the predetermined load is applied. Typically, during a seismic event, the predetermined load has a load path in the horizontal plane. Ground movement as a result of the seismic event may result in the grid framework structure oscillating in both the X and Y direction in the horizontal plane. To cater for movement of the grid framework structure in both the X and Y direction, the mechanical fuse 222 can comprise mutually opposed sliding faces as shown in FIG. 45. The mutually opposed sliding faces is configured to slide relative to each other when the applied load exceeds the predetermined load causing the first region of the grid framework structure to separate from the second region of the grid framework structure. The coefficient of friction of the mutually opposed sliding faces is such that the sliding faces slide relative to each other when the applied load exceeds the predetermined load. In an extreme case, the sliding faces separate or “pop-up” when the applied forces exceed the predetermined force. For the mechanical fuse 222 to separate when the applied load exceeds the predetermined load, in both examples discussed above, the bridging element 220 comprises a first portion 224a and a second portion 224b connected together by one or more slip joints mechanical fuses.

Various materials can be used in the fabrication of the components used in the prefabricated frames, prefabricated modular sub-frames and/or the track sections. These include metals, e.g. stainless steel, galvanized steel, aluminum, plastics, or a fiber composite material.

What is claimed is:

1. A grid framework structure for supporting one or more robotic load handling devices operative on the grid framework structure, the grid framework structure comprising:
a supporting framework structure comprising a plurality of prefabricated frames arranged in a three-dimensional grid pattern comprising a plurality of modular storage cells for storage of a plurality of stacks of containers such that adjacent modular storage cells share a common prefabricated frame, each of the plurality of prefabricated frames lying in a vertical plane and comprising a plurality of vertical members braced by a bracing member; and
a track system for guiding movement of the one or more robotic load handling devices on the grid framework structure, the track system being mounted to the supporting framework structure and comprising a plurality of tracks arranged in a grid pattern comprising a plurality of grid cells extending across the plurality of modular storage cells such that each of the plurality of modular storage cells supports a sub-group of two or more grid cells of the track system,
wherein the track system further comprises a track support structure comprising a plurality of track supports arranged in a grid pattern corresponding to the grid pattern of the track system, the plurality of track supports being interconnected at intersections of the plurality of track supports in the grid pattern, the track support structure being sub-divided into a plurality of modular sub-frames such that each of the plurality of modular sub-frames comprises the sub-group of two or more grid cells of the track system, and
wherein the intersections of the plurality of track supports at an interface between the adjacent modular storage cells comprise one or more slip joints such that adjacent modular sub-frames are moveable relative to each other along a substantially horizontal plane via the one or more slip joints.

2. The grid framework structure of claim 1, wherein the one or more slip joints comprises:
a first set of slip joints at an interface between the adjacent modular storage cells in a first direction such that the adjacent modular sub-frames are moveable relative to each other along the substantially horizontal plane in the first direction; and
a second set of slip joints at an interface between the adjacent modular storage cells in a second direction such that adjacent modular sub-frames are moveable relative to each other along the substantially horizontal plane in the second direction,
wherein the second direction is substantially perpendicular to the first direction.

3. The grid framework structure of claim 2, wherein the supporting framework structure is arranged such that one or more vertical members of adjacent prefabricated frames are connected together by one or more fasteners at an interface between adjacent modular storage cells.

4. The grid framework structure of claim 3, wherein one or more spacers are disposed between the vertical members of adjacent prefabricated frames at the interface between adjacent modular storage cells.

5. The grid framework structure of claim 4, wherein each of the one or more spacers comprises a first spacing member and a second spacing member, the first spacing member being configured to space adjacent vertical members connected in the first direction by a first spacing and the second spacing member being configured to space adjacent vertical members connected in the second direction by a second spacing.

6. The grid framework structure of claim 5, wherein the first spacing is different to the second spacing.

7. The grid framework structure of claim 4, wherein the one or more spacers comprises a plurality of spacers distributed along a longitudinal length of the adjacent vertical members at the interface between the adjacent modular storage cells.

8. The grid framework structure of claim 1, wherein the plurality of prefabricated frames are arranged to form a first type modular unit and a second type modular unit, the second type modular unit having an interface portion that is configured to interface with the first type modular unit to form at least a portion of the supporting framework structure comprising at least two modular storage cells sharing at least one common prefabricated frame at the interface between adjacent modular storage cells.

9. The grid framework structure of claim 8, wherein the first type modular unit is a closed sided modular unit and the second type modular unit is an open sided modular unit having an open side along one side of the second type modular unit such that the open side of the second type modular unit is configured to be closed by sharing the common prefabricated frame with the first type modular unit.

10. The grid framework structure of claim 9, wherein the first type modular unit comprises four prefabricated frames arranged to form a closed-sided structure and the second type modular unit comprises three prefabricated frames arranged to form a substantially U-shaped structure, and the substantially U-shaped structure of the second type modular unit is closed by sharing the common prefabricated frame with any closed sided structure of the first type modular unit.

11. The grid framework structure of claim 10, wherein the plurality of modular sub-frames of the track support structure comprises a first type modular sub-frame and a second type modular sub-frame, the first type modular sub-frame being a closed sided sub-frame and the second type modular sub-frame being an open sided sub-frame, the first type modular sub-frame being configured to be mounted to the first type modular unit and the second type modular sub-frame being configured to be mounted to the second type modular unit such that the open side sub-frame of the second type modular sub-frame is closed by a side of the first type modular sub-frame at the interface between adjacent modular sub-frames comprising the one or more slip joints.

12. The grid framework structure of claim 11, wherein the plurality of prefabricated frames are arranged to form a third type modular unit, said third type modular unit comprising at least two interface portions that are configured to interface with the first type modular unit, the second type modular unit, or the third type modular unit, or any combination thereof, to form at least four modular storage cells.

13. The grid framework structure of claim 12, wherein the third type modular unit is an open sided modular unit along two sides of the modular unit such that the open sided modular unit along the two sides of the modular unit is configured to be closed by sharing two common prefabricated frames with the first and/or second type modular units between adjacent modular storage cells.

14. The grid framework structure of claim 12, wherein the plurality of modular sub-frames of the track support structure further comprises a third type modular sub-frame, the third type modular sub-frame being an open sided sub-frame along two sides of the sub-frame and being configured to be mounted to the third type modular unit such that the open sided sub-frame of the third type modular sub-frame along the two sides of the sub-frame is configured to be closed by a respective side of the first type modular sub-frame and/or second type modular sub-frame between adjacent modular storage cells comprising the one or more slip joints.

15. The grid framework structure of claim 1, wherein each of the plurality of modular storage cells comprises a plurality of tote guides extending substantially vertically between the track system and a floor, the plurality of tote guides being arranged in a pattern for accommodating a stack of storage containers between the plurality of tote guides and to guide a storage container through a respective grid cells of the track system.

16. The grid framework structure of claim 1, wherein the plurality of vertical members of each of the plurality of prefabricated frames are braced by one or more horizontal and/or diagonal bracing members.

17. The grid framework structure of claim 1, wherein the plurality of tracks comprises a plurality of modular track sections, each modular track section of the plurality of modular track sections comprising substantially perpendicular track section elements so as to provide a track surface extending in perpendicular directions.

18. The grid framework structure of claim 17, wherein each of the plurality of modular track sections is formed as a single unitary body.

19. A storage and retrieval system comprising:
a grid framework structure, comprising:
a supporting framework structure comprising a plurality of prefabricated frames arranged in a three-dimensional grid pattern comprising a plurality of modular storage cells for storage of a plurality of stacks of containers such that adjacent modular storage cells share a common prefabricated frame, each of the plurality of prefabricated frames lying in a vertical plane and comprising a plurality of vertical members braced by a bracing member; and
a track system for guiding movement of the one or more robotic load handling devices on the grid framework structure, the track system being mounted to the supporting framework structure and comprising a plurality of tracks arranged in a grid pattern comprising a plurality of grid cells extending across the plurality of modular storage cells such that each of the plurality of modular storage cells supports a sub-group of two or more grid cells of the track system,
wherein the track system further comprises a track support structure comprising a plurality of track supports arranged in a grid pattern corresponding to the grid pattern of the track system, the plurality of track supports being interconnected at intersections of the plurality of track supports in the grid pattern, the track support structure being sub-divided into a plurality of modular sub-frames such that each of the plurality of modular sub-frames comprises the sub-group of two or more grid cells of the track system, and
wherein the intersections of the plurality of track supports at an interface between the adjacent modular storage cells comprise one or more slip joints such that adjacent modular sub-frames are moveable relative to each other along a substantially horizontal plane via the one or more slip joints,
a plurality of stacks of containers arranged in storage columns located below the track system, wherein each storage column is located vertically below a grid cell; and
a plurality of load handling devices for lifting and moving containers stacked in the plurality of stacks, the plurality of load handling devices being remotely operated to move laterally on the track system above the storage columns to access the containers through the grid cells, each respective load handling device of the plurality of load handling devices comprising:
a wheel assembly for guiding the respective load handling device on the track system;
a container-receiving space located above the track system; and
a lifting device arranged to lift a single container from a stack into the container-receiving space.

20. A method of assembling a grid framework, comprising:
assembling the plurality of prefabricated frames in a grid pattern to form a supporting framework structure comprising a plurality of modular storage cells such that adjacent modular storage cells share a common prefabricated frame; and
mounting the plurality of modular sub-frames in a substantially vertical direction to the supporting framework structure such that an interface between adjacent modular sub-frames are interconnected by the one or more slip joints,
wherein the grid framework structure comprises:
a supporting framework structure comprising a plurality of prefabricated frames arranged in a three-dimensional grid pattern comprising a plurality of modular storage cells for storage of a plurality of stacks of containers such that adjacent modular storage cells share a common prefabricated frame, each of the plurality of prefabricated frames lying in a vertical plane and comprising a plurality of vertical members braced by a bracing member; and
a track system for guiding movement of the one or more robotic load handling devices on the grid framework structure, the track system being mounted to the supporting framework structure and comprising a plurality of tracks arranged in a grid pattern comprising a plurality of grid cells extending across the plurality of modular storage cells such that each of the plurality of modular storage cells supports a sub-group of two or more grid cells of the track system,
wherein the track system further comprises a track support structure comprising a plurality of track supports arranged in a grid pattern corresponding to the grid pattern of the track system, the plurality of track supports being interconnected at intersections of the plurality of track supports in the grid pattern, the track support structure being sub-divided into a plurality of modular sub-frames such that each of the plurality of modular sub-frames comprises the sub-group of two or more grid cells of the track system, and
wherein the intersections of the plurality of track supports at an interface between the adjacent modular storage cells comprise one or more slip joints such that adjacent modular sub-frames are moveable relative to each other along a substantially horizontal plane via the one or more slip joints.
